(19) United States
(12) Patent Application Publication
(10) Pub. No.: US 2016/0112262 A1
(43) Pub. Date: Apr. 21, 2016

(54) INSTALLATION AND CONFIGURATION OF CONNECTED DEVICES

(71) Applicant: Weaved, Inc., Palo Alto, CA (US)

(72) Inventors: Michael W. Johnson, Petaluma, CA (US); Ryo Koyama, Palo Alto, CA (US); Michael J.S. Smith, Palo Alto, CA (US)

(21) Appl. No.: 14/517,843

(22) Filed: Oct. 18, 2014

(51) Int. Cl. H04L 12/24; G06F 9/54

(52) U.S. Cl. CPC H04L 41/0816; G06F 9/547

(57) ABSTRACT

A method, system, and computer program product for managing Internet-connected devices.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This disclosure relates to the field of managing internet-connected devices and more particularly to techniques for installation and configuration of connected devices. Embodiments of the present disclosure generally relate to improvements to computing devices and, more specifically, to efficient use of CPUs in various devices.

### BACKGROUND

Many sorts of devices can be connected via the Internet. However, applications pertaining to certain types of connected devices rely on characteristics of the connected network that can be set up during the course of installation and configuration. Legacy installation and configuration fails to account for the specifics of certain connected devices, and in some cases, legacy installation and configuration relies on pre-existing network component configurations that may not fully serve the needs of the aforementioned connected devices. Further, techniques are needed to address the problem of deployment and ongoing management of internet connected devices. None of the aforementioned legacy approaches achieve the capabilities of the herein-disclosed techniques for installation and configuration of connected devices. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for installation and configuration of connected devices. The claimed embodiments address the problem of deployment and ongoing management of internet connected devices. More specifically, some claims are directed to approaches for configuring devices, connections, and severs to provide specific services, which claims advance the technical fields for addressing the problem of deployment and ongoing management of internet connected devices, as well as advancing peripheral technical fields. Some claims improve the functioning of multiple systems within the disclosed environments.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

So that the features of various embodiments of the present disclosure can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the various embodiments of the disclosure, for the embodiment(s) may admit to other effective embodiments. The following detailed description makes reference to the accompanying drawings that are now briefly described.

The drawings described below are for illustration purposes only. The drawings are not intended to limit the scope of the present disclosure. This patent or application file contains at least one drawing executed in color. Copies of this patent or patent application publication with color drawings will be provided by the Office upon request and payment of fees.

One or more of the various embodiments of the disclosure are susceptible to various modifications, combinations, and alternative forms, various embodiments thereof are shown by way of example in the drawings and will herein be described in detail. It should be understood, however, that the accompanying drawings and detailed description are not intended to limit the embodiment(s) to the particular form disclosed, but on the contrary, the intention is to cover all modifications, combinations, equivalents and alternatives falling within the spirit and scope of the various embodiments of the present disclosure as defined by the relevant claims.

FIG. 1 exemplifies an environment for supporting connections and servers as used in the installation and configuration of connected devices, according to one embodiment.

FIG. 2 depicts a project setup user interface as used in the installation and configuration of connected devices, according to one embodiment.

FIG. 3 depicts a project creation user interface as used in the installation and configuration of connected devices, according to one embodiment.

FIG. 4 depicts a project download user interface as used in the installation and configuration of connected devices, according to one embodiment.

FIG. 5 depicts a core navigation user interface as used in the installation and configuration of connected devices, according to one embodiment.

FIG. 6 depicts a daemon service installation user interface as used in the installation and configuration of connected devices, according to one embodiment.

FIG. 7 depicts a device authorization user interface as used in the installation and configuration of connected devices, according to one embodiment.

FIG. 8 depicts a script access user interface as used in the installation and configuration of connected devices, according to one embodiment.

FIG. 9 depicts a daemon startup user interface as used in the installation and configuration of connected devices, according to one embodiment.

FIG. 10 depicts a connected device registration user interface as used in the installation and configuration of connected devices, according to one embodiment.

FIG. 11 depicts a project listing user interface as used in the installation and configuration of connected devices, according to one embodiment.

FIG. 12 depicts a startup page user interface as used in the installation and configuration of connected devices, according to one embodiment.

FIG. 13 depicts a display terminal status page as used in the installation and configuration of connected devices, according to one embodiment.

FIG. 14 depicts a display terminal upgrade prompt user interface as used in the installation and configuration of connected devices, according to one embodiment.

FIG. 15 depicts a display terminal upgrade status user interface as used in the installation and configuration of connected devices, according to one embodiment.

FIG. 16 depicts a display terminal device error user interface as used in the installation and configuration of connected devices, according to one embodiment.

FIG. 17 depicts a display terminal option setup user interface as used in the installation and configuration of connected devices, according to one embodiment.

FIG. 18 depicts a display terminal information display user interface as used in the installation and configuration of connected devices, according to one embodiment.

FIG. 19 depicts a display terminal global configuration user interface as used in the installation and configuration of connected devices, according to one embodiment.

FIG. 20 depicts a display terminal device options user interface as used in the installation and configuration of connected devices, according to one embodiment.

FIG. 21 depicts a display terminal guest access setup user interface as used in the installation and configuration of connected devices, according to one embodiment.

FIG. 22 depicts a display terminal confirmation user interface as used in the installation and configuration of connected devices, according to one embodiment.

FIG. 23 depicts a display terminal account creation user interface as used in the installation and configuration of connected devices, according to one embodiment.

FIG. 24 depicts a display terminal browser-oriented user interface as used in the installation and configuration of connected devices, according to one embodiment.

FIG. 25 depicts a display terminal device-specific browser rendering user interface as used in the installation and configuration of connected devices, according to one embodiment.

FIG. 26 depicts a display terminal port-addressable device-specific browser-oriented user interface as used in the installation and configuration of connected devices, according to one embodiment.

FIG. 27 depicts a display terminal account setup interview user interface as used in the installation and configuration of connected devices, according to one embodiment.

FIG. 28 depicts a display terminal device-specific signal configuration user interface as used in the installation and configuration of connected devices, according to one embodiment.

FIG. 29 depicts a display terminal instance-specific signal configuration user interface as used in the installation and configuration of connected devices, according to one embodiment.

FIG. 30 depicts a display terminal signal configuration editor interface as used in the installation and configuration of connected devices, according to one embodiment.

FIG. 31 depicts a display terminal device enumeration user interface as used in the installation and configuration of connected devices, according to one embodiment.

FIG. 32 depicts a display terminal device timeout status user interface as used in the installation and configuration of connected devices, according to one embodiment.

FIG. 33 depicts a display terminal device limit status user interface as used in the installation and configuration of connected devices, according to one embodiment.

FIG. 34 depicts a display terminal peer-to-peer status user interface as used in the installation and configuration of connected devices, according to one embodiment.

FIG. 35 presents an image of a connected device as used in the installation and configuration of connected devices, according to one embodiment.

FIG. 36 depicts a process flow from initial download through status check performed after installation and configuration of connected devices, according to one embodiment.

FIG. 37 is a block diagram of an instance of a computer system suitable for implementing certain embodiments of the present disclosure, according to one embodiment.

FIG. 38A is a diagram illustrating a mobile terminal.

FIG. 38B depicts an interconnection of components in a mobile terminal.

### DETAILED DESCRIPTION

### Glossary

In this description a device refers to a mobile device, electronic system, machine, and/or any type of apparatus, system, that may be mobile, fixed, wearable, portable, integrated, cloud-based, distributed and/or any combination of these and which may be formed, manufactured, operated, etc. in any fashion, or manner in any location(s). It should be understood, however, that one or more of the embodiments described herein and/or in one or more specifications incorporated by reference may be applied to any device(s) or similar object(s) e.g., consumer devices, phones, phone systems, cell phones, cellular phones, mobile phone, smart phone, internet phones, wireless phones, personal digital assistants (PDAs), remote communication devices, wireless devices, music players, video players, media players, multimedia players, video recorders, VCRs, DVRs, book readers, voice recorders, voice controlled systems, voice controllers, cameras, social interaction devices, radios, TVs, watches, personal communication devices, electronic wallets, electronic currency, smart cards, smart credit cards, electronic money, electronic coins, electronic tokens, smart jewelry, electronic passports, electronic identification systems, biometric sensors, biometric systems, biometric devices, smart pens, smart rings, personal computers, tablets, laptop computers, scanners, printers, computers, web servers, media servers, multimedia servers, file servers, datacenter servers, database servers, database appliances, cloud servers, cloud devices, cloud appliances, embedded systems, embedded devices, electronic glasses, electronic goggles, electronic screens, displays, wearable displays, projectors, picture frames, touch screens, computer appliances, kitchen appliances, home appliances, home theater systems, audio systems, home control appliances, home control systems, irrigation systems, sprinkler systems, garage door systems, garage door controls, remote controls, remote control systems, thermostats, heating systems, air conditioning systems, ventilation systems, climate control systems, climate monitoring systems, industrial control systems, transportation systems and controls, industrial process and control systems, industrial controller systems, machine-to-machine systems, aviation systems, locomotive systems, power control systems, power controllers, lighting control, lights, lighting systems, solar system controllers, solar panels, vehicle and other engines, engine controllers, motors, motor controllers, navigation controls, navigation systems, navigation displays, sensors, sensor systems, transducers, transducer systems, computer input devices, device controllers, touchpads, mouse, pointer, joystick, keyboards, game controllers, haptic devices, game consoles, game boxes, network devices, routers, switches, TiVO, AppleTV, GoogleTV, internet TV boxes, internet systems, internet devices, set-top boxes, cable boxes, modems, cable modems, PCs, tablets, media boxes, streaming devices, entertainment centers, entertainment systems, aircraft entertainment systems, hotel entertainment systems, car and vehicle entertainment systems, GPS devices, GPS systems, automobile and other motor vehicle systems, truck systems, vehicle control systems, vehicle sensors, aircraft systems, automation systems, home automation systems, industrial automation systems, reservation systems, check-in terminals, ticket collection systems, admission systems, payment devices, payment systems, banking machines, cash points, ATMs, vending machines, vending systems, point of sale devices, coin-operated devices, token operated devices, gas (petrol) pumps, ticket machines, toll systems, barcode scanners, credit card scanners, travel token systems, travel card systems, RFID devices, electronic labels, electronic tags, tracking systems, electronic stickers, electronic price tags, near field communication (NFC) devices, wireless operated devices, wireless receivers, wireless transmitters, sensor devices, motes, sales terminals, checkout terminals, electronic toys, toy systems, gaming systems, information appliances, information and other kiosks, sales displays, sales devices, electronic menus, coupon systems, shop displays, street displays, electronic advertising systems, traffic control systems, traffic signs, parking systems, parking garage devices, elevators and elevator systems, building systems, mailboxes, electronic signs, video cameras, security systems, surveillance systems, electronic locks, electronic keys, electronic key fobs, access devices, access controls, electronic actuators, safety systems, smoke detectors, fire control systems, fire detection systems, locking devices, electronic safes, electronic doors, music devices, storage devices, back-up devices, USB keys, portable disks, exercise machines, sports equipment, medical devices, medical systems, personal medical devices, wearable medical devices, portable medical devices, mobile medical devices, blood pressure sensors, heart rate monitors, blood sugar monitors, vital sign monitors, ultrasound devices, medical imagers, drug delivery systems, drug monitoring systems, patient monitoring systems, medical records systems, industrial monitoring systems, robots, robotic devices, home robots, industrial robots, electric tools, power tools, construction equipment, electronic jewelry, wearable devices, wearable electronic devices, wearable cameras, wearable video cameras, wearable systems, electronic dispensing systems, handheld computing devices, handheld electronic devices, electronic clothing, combinations of these and/or any other devices, multi-function devices, multi-purpose devices, combination devices, cooperating devices, and the like, etc.

The devices may support (e.g., include, comprise, contain, implement, execute, be part of, be operable to execute, display, source, provide, store, etc.) one or more applications and/or functions e.g., search applications, contacts and/or friends applications, social interaction applications, social media applications, messaging applications, telephone applications, video conferencing applications, e-mail applications, voicemail applications, communications applications, voice recognition applications, instant messaging (IM) applications, texting applications, blog and/or blogging applications, photographic applications (e.g., catalog, management, upload, editing, etc.), shopping, advertising, sales, purchasing, selling, vending, ticketing, payment, digital camera applications, digital video camera applications, web browsing and browser applications, digital music player applications, digital video player applications, cloud applications, office productivity applications, database applications, cataloging applications, inventory control, medical applications, electronic book and newspaper applications, travel applications, dictionary and other reference work applications, language translation, spreadsheet applications, word processing applications, presentation applications, business applications, finance applications, accounting applications, publishing applications, web authoring applications, multimedia editing, computer-aided design (CAD), manufacturing applications, home automation and control, backup and/or storage applications, help and/or manuals, banking applications, stock trading applications, calendar applications, voice driven applications, map applications, consumer entertainment applications, games, other applications and/or combinations of these and/or multiple instances (e.g., versions, copies, etc.) of these and/or other applications, and the like, etc.

The devices may include (e.g., comprise, be capable of including, have features to include, have attachments, communicate with, be linked to, be coupled with, operable to be coupled with, be connected to, be operable to connect to, etc.) one or more devices (e.g., there may be a hierarchy of devices, nested devices, etc.). The devices may operate, function, run, etc. as separate components, working in cooperation, as a cooperative hive, as a confederation of devices, as a federation, as a collection of devices, as a cluster, as a multi-function device, with sockets, ports, connectivity, etc. for extra, additional, add-on, optional, etc. devices and/or components, attached devices (e.g., direct attach, network attached, remote attach, cloud attach, add on, plug in, etc.), upgrade components, helper devices, acceleration devices, support devices, engines, expansion devices and/or modules, combinations of these and/or other components, hardware, software, firmware, devices, and the like, etc.

The devices may have (e.g., comprise, include, execute, perform, capable of being programmed to perform, etc.) one or more device functions (e.g., telephone, video conferencing, e-mail, instant messaging, blogging, digital photography, digital video, web browsing, digital music playing, social interaction, shopping, searching, banking, combinations of these and/or other functions, and the like, etc.). Instructions, help, guides, manuals, procedures, algorithms, processes, methods, techniques, etc. for performing and/or helping to perform, etc. the device functions, etc. may be included in a computer readable storage medium, computer readable memory medium, or other computer program product configured for execution, for example, by one or more processors.

The devices may include one or more processors (e.g., central processing units (CPUs), multicore CPUs, homogeneous CPUs, heterogeneous CPUs, graphics processing units (GPUs), computing arrays, CPU arrays, microprocessors, controllers, microcontrollers, engines, accelerators, compute arrays, programmable logic, DSP, combinations of these and the like, etc.). Devices and/or processors, etc. may include, contain, comprise, etc. one or more operating systems (OSs). Processors may use one or more machine or system architectures (e.g., ARM, Intel, x86, hybrids, emulators, other architectures, combinations of these, and the like, etc.).

Processor architectures may use one or more privilege levels. For example, the x86 architecture may include four hardware resource privilege levels or rings. The OS kernel, for example, may run in privilege level 0 or ring 0 with complete control over the machine or system. In the Linux OS, for example, ring 0 may be kernel space, and user mode may run in ring 3.

A multi-core processor (multicore processor, multicore CPU, etc.) may be a single computing component (e.g., a single chip, a single logical component, a single physical component, a single package, an integrated circuit, a multi-chip package, combinations of these and the like, etc.). A multicore processor may include (e.g., comprise, contain, etc.) two or more central processing units, etc. called cores. The cores may be independent, relatively independent and/or connected, coupled, integrated, logically connected, etc. in any way. The cores, for example, may be the units that read and execute program instructions. The instructions may be ordinary CPU instructions such as add, move data, and branch, but the multiple cores may run multiple instructions at the same time, increasing overall speed, for example, for programs amenable to parallel computing. Manufacturers may typically integrate the cores onto a single integrated circuit die (known as a chip multiprocessor or CMP), or onto multiple dies in a single chip package, but any implementation, construction, assembly, manufacture, packaging method and/or process, etc. is possible.

The devices may use one or more virtualization methods. In computing, virtualization refers to the act of creating (e.g., simulating, emulating, etc.) a virtual (rather than actual) version of something, including but not limited to a virtual computer hardware platform, operating system (OS), storage device, computer network resources and the like.

For example, a hypervisor or virtual machine monitor (VMM) may be a virtualization method and may allow (e.g., permit, implement, etc.) hardware virtualization. A hypervisor may run (e.g., execute, operate, control, etc.) one or more operating systems (e.g., guest OSs, etc.) simultaneously (e.g., concurrently, at the same time, at nearly the same time, in a time multiplexed fashion, etc.), and each may run on its own virtual machine (VM) on a host machine and/or host hardware (e.g., device, combination of devices, combinations of devices with other computer(s), etc.). A hypervisor, for example, may run at a higher level than a supervisor.

Multiple instances of OSs may share virtualized hardware resources. A hypervisor, for example, may present a virtual platform, architecture, design, etc. to a guest OS and may monitor the execution of one or more guest OSs. A Type 1 hypervisor (also type I, native, or bare metal hypervisor, etc.) may run directly on the host hardware to control the hardware and monitor guest OSs. A guest OS thus may run at a level above (e.g., logically above, etc.) a hypervisor. Examples of Type 1 hypervisors may include VMware ESXi, Citrix XenServer, Microsoft Hyper-V, etc. A Type 2 hypervisor (also type II, or hosted hypervisor) may run within a conventional OS (e.g., Linux, Windows, Apple iOS, etc.). A Type 2 hypervisor may run at a second level (e.g., logical level, etc.) above the hardware. Guest OSs may run at a third level above a Type 2 hypervisor. Examples of Type 2 hypervisors may include VMware Server, Linux KVM, VirtualBox, etc. A hypervisor thus may run one or more other hypervisors with their associated VMs. In some cases, virtualization and nested virtualization may be part of an OS. For example, Microsoft Windows 7 may run Windows XP in a VM. For example, the IBM turtles project, part of the Linux KVM hypervisor, may run multiple hypervisors (e.g., KVM and VMware, etc.) and operating systems (e.g., Linux and Windows, etc.). The term embedded hypervisor may refer to a form of hypervisor that may allow, for example, one or more applications to run above the embedded hypervisor without an OS.

The term hardware virtualization may refer to virtualization of machines, devices, computers, operating systems, combinations of these, etc. that may hide the physical aspects of a computer system and instead present (e.g., show, manifest, demonstrate, etc.) an abstract system (e.g., view, aspect, appearance, etc.). For example, x86 hardware virtualization may allow one or more OSs to share x86 processor resources in a secure, protected, safe, etc. manner. Initial versions of x86 hardware virtualization were implemented using software techniques to overcome the lack of processor virtualization support. Manufacturers (e.g., Intel, AMD, etc.) later added (e.g., in later generations, etc.) processor virtualization support to x86 processors, thus simplifying later versions of x86 virtualization software, etc. Continued addition of hardware virtualization features to x86 and other (e.g., ARM) processors has resulted in continued improvements (e.g., in speed, in performance, etc.) of hardware virtualization. Other virtualization methods, such as memory virtualization, I/O virtualization (IOV), etc. may be performed by a chipset, integrated with a CPU, and/or by other hardware components, etc. For example, an input/output memory management unit (IOMMU) may enable guest VMs to access peripheral devices (e.g., network adapters, graphics cards, storage controllers, etc.) e.g., using DMA, interrupt remapping, etc. For example, PCI-SIG IOV may use a set of general (e.g., non-x86 specific) PCI Express (PCI-E) based native hardware I/O virtualization techniques. For example, one such technique may be address translation services (ATSs) that may support native IOV across PCI-E using address translation. For example, single root IOV (SR-IOV) may support native IOV in single root complex PCI-E topologies. For example, multi-root IOV (MR-IOV) may support native IOV by expanding SR-IOV to provide multiple root complexes that may, for example, share a common PCI-E hierarchy. In SR-IOV, for example, a host VMM may configure supported devices to create and allocate virtual shadows of configuration spaces (e.g., shadow devices, etc.) so that VM guests may, for example, configure, access, etc. one or more shadow device resources.

The devices (e.g., device software, device firmware, device applications, OSs, combinations of these, etc.) may use one or more programs (e.g., source code, programming languages, binary code, machine code, applications, apps, functions, etc.). The programs, etc. may use (e.g., require, employ, etc.) one or more code translation techniques (e.g., process, algorithms, etc.) to translate from one form of code to another form of code e.g., to translate from source code (e.g., readable text, abstract representations, high-level representations, graphical representations, etc.) to machine code (e.g., machine language, executable code, binary code, native code, low-level representations, etc.). For example, a compiler may translate (e.g., compile, transform, etc.) source code into object code (e.g., compiled code, etc.). For example, a linker may translate object code into machine code (e.g., linked code, loadable code, etc.). Machine code may be executed by a CPU, etc. at runtime. Computer programming languages (e.g., high-level programming languages, source code, abstract representations, etc.) may be interpreted or compiled. Interpreted code may be translated (e.g., interpreted, by an interpreter, etc.), for example, to machine code during execution (e.g., at runtime, continuously, etc.). Compiled code may be translated (compiled, by a compiler, etc.), for example, to machine code once (e.g., statically, at one time, etc.) before execution. An interpreter may be classified into one or more of the following types: type 1 interpreters may, for example, execute source code directly; type 2 interpreters may, for example, compile or translate source code into an intermediate representation (e.g., intermediate code, intermediate language, temporary form, etc.) and may execute the intermediate code; type 3 interpreters may execute stored precompiled code generated by a compiler that may, for example, be part of the interpreter. For example, languages such as Lisp, etc. may use a type 1 interpreter; languages such as Perl, Python, etc. may use a type 2 interpreter; languages such as Pascal, Java, etc. may use a type 3 interpreter. Some languages, such as Smalltalk, BASIC, etc. may, for example, combine facets, features, properties, etc. of interpreters of type 2 and interpreters of type 3. There may not always, for example, be a clear distinction between interpreters and compilers. For example, interpreters may also perform some translation. For example, some programming languages may be both compiled and interpreted or may include features of both. For example, a compiler may translate source code into an intermediate form (e.g., bytecode, portable code, p-code, intermediate code, etc.), that may then be passed to an interpreter. The terms interpreted language or compiled language applied to describing, classifying, etc. a programming language (e.g., C++ is a compiled programming language, etc.) may thus refer to an example (e.g., canonical, accepted, standard, theoretical, etc.) implementation of a programming language that may use an interpreter, compiler, etc. Thus a high-level computer programming language, for example, may be an abstract, ideal, theoretical, etc. representation that may be independent of a particular, specific, fixed, etc. implementation (e.g., independent of a compiled, interpreted version, etc.).

The devices (e.g., device software, device firmware, device applications, OSs, etc.) may use one or more alternative code forms, representations, etc. For example, a device may use bytecode that may be executed by an interpreter or that may be compiled. Bytecode may take any form. Bytecode, for example, may be based on (e.g., be similar to, use, etc.) hardware instructions and/or use hardware instructions in machine code. Bytecode design (e.g., format, architecture, syntax, appearance, semantics, etc.) may be based on a machine architecture (e.g., virtual stack machine, virtual register machine, etc.). Parts, portions, etc. of bytecode may be stored in files (e.g., modules, similar to object modules, etc.). Parts, portions, modules, etc. of bytecode may be dynamically loaded during execution. Intermediate code (e.g., bytecode, etc.) may be used to simplify and/or improve the performance, etc. of interpretation. Bytecode may be used, for example, in order to reduce hardware dependence, OS dependence, or other dependencies, etc. by allowing the same bytecode to run on different platforms (e.g., architectures, etc.). Bytecode may be directly executed on a VM (e.g., using an interpreter, etc.). Bytecode may be translated (e.g., compiled, etc.) to machine code, for example to improve performance, etc. Bytecode may include compact numeric codes, constants, references, numeric addresses, etc. that may encode the result of translation, parsing, semantic analysis, etc. of the types, scopes, nesting depths, etc. of program objects, constructs, structures, etc. The use of bytecode may, for example, allow improved performance over the direct interpretation of source code. Bytecode may be executed, for example, by parsing and executing bytecode instructions one instruction at a time. A bytecode interpreter may be portable (e.g., independent of device, machine architecture, computer system, computing platform, etc.).

The devices (e.g., device applications, OSs, etc.) may use one or more VMs. For example, a Java virtual machine (JVM) may use Java bytecode as intermediate code. Java bytecode may correspond, for example, to the instruction set of a stack-oriented architecture. For example, Oracle's JVM is called HotSpot. Examples of clean-room Java implementations may include Kaffe, IBM J9, and Dalvik. A software library (library) may be a collection of related object code. A class may be a unit of code. The Java Classloader may be part of the Java runtime environment (JRE) that may, for example, dynamically load Java classes into the JVM. Java libraries may be packaged in Jar files. Libraries may include objects of different types. One type of object in a Jar file may be a Java class. The class loader may locate libraries, read library contents, and load classes included within the libraries. Loading may, for example, be performed on demand, when the class is required by a program. Java may make use of external libraries (e.g., libraries written and provided by a third party, etc.). When a JVM is started, one or more of the following class loaders may be used: (1) bootstrap class loader; (2) extensions class loader; or (3) system class loader. The bootstrap class loader, which may be part of the core JVM, for example, may be written in native code and may load the core Java libraries. The extensions class loader may, for example, load code in the extensions directories. The system class loader may, for example, load code on the java.class.path stored in the system CLASSPATH variable. By default, all user classes may, for example, be loaded by the default system class loader that may be replaced by a user-defined ClassLoader. The Java class library may be a set of dynamically loadable libraries that Java applications may call at runtime. Because the Java platform may be independent of any OS, the Java platform may provide a set of standard class libraries that may, for example, include reusable functions commonly found in an OS. The Java class library may be almost entirely written in Java except, for example, for some parts that may need direct access to hardware, OS functions, etc. (e.g., for I/O, graphics, etc.). The Java classes that may provide access to these functions may, for example, use native interface wrappers, code fragments, etc. to access the API of the OS. Almost all of the Java class library may, for example, be stored in a Java archive file rt.jar, which may be provided with JRE and JDK distributions, for example.

The devices (e.g., device applications, OSs, etc.) may use one or more alternative code translation methods. For example, some code translation systems (e.g., dynamic translators, just-in-time compilers, etc.) may translate bytecode into machine language (e.g., native code, etc.) on demand, as required, etc. at runtime. Thus, for example, source code may be compiled and stored as machine independent code. The machine independent code may be linked at runtime and may, for example, be executed by an interpreter, compiler for JIT systems, etc. This type of translation, for example, may reduce portability, but may not reduce the portability of the bytecode itself. For example, programs may be stored in bytecode that may then be compiled using a JIT compiler that may translate bytecode to machine code. This may add a delay before a program runs and may, for example, improve execution speed relative to the direct interpretation of source code. Translation may, for example, be performed in one or more phases. For example, a first phase may compile source code to bytecode, and a second phase may translate the bytecode to a VM. There may be different VMs for different languages, representations, etc. (e.g., for Java, Python, PHP, Forth, Tcl, etc.). For example, Dalvik bytecode designed for the Android platform, for example, may be executed by the Dalvik VM. For example, the Dalvik VM may use special representations (e.g., DEX, etc.) for storing applications. For example, the Dalvik VM may use its own instruction set (e.g., based on a register-based architecture rather than stack-based architecture, etc.) rather than standard JVM bytecode, etc. Other implementations may be used. For example, the implementation of Perl, Ruby, etc. may use an abstract syntax tree (AST) representation that may be derived from the source code. For example, ActionScript (an object-oriented language that may be a superset of JavaScript, a scripting language) may execute in an ActionScript virtual machine (AVM) that may be part of Flash Player and Adobe Integrated Runtime (AIR). ActionScript code, for example, may be transformed into bytecode by a compiler. ActionScript compilers may be used, for example, in Adobe Flash Professional and in Adobe Flash Builder and may be available as part of the Adobe Flex SDK. A JVM may contain both and interpreter and JIT compiler and switch from interpretation to compilation for frequently executed code. One form of JIT compiler may, for example, represent a hybrid approach between interpreted and compiled code, and translation may occur continuously (e.g., as with interpreted code), but caching of translated code may be used e.g., to increase speed, performance, etc. JIT compilation may also offer advantages over static compiled code, e.g., the use late-bound data types, the ability to use and enforce security constraints, etc. JIT compilation may, for example, combine bytecode compilation and dynamic compilation. JIT compilation may, for example, convert code at runtime prior to executing it natively e.g., by converting bytecode into native machine code. Several runtime environments, (e.g., Microsoft .NET Framework, some implementations of Java, etc.) may, for example, use, employ, depend on, etc. JIT compilers. This specification may avoid the use of the term native machine code to avoid confusion with the terms machine code and native code.

The devices (e.g., device applications, OSs, etc.) may use one or more methods of emulation, simulation, etc. For example, binary translation may refer to the emulation of a first instruction set by a second instruction set (e.g., using code translation). For example, instructions may be translated from a source instruction set to a target instruction set. In some cases, such as instruction set simulation, the target instruction set may be the same as the source instruction set, and may, for example, provide testing features, debugging features, instruction trace, conditional breakpoints, hot spot detection, etc. Binary translation may be further divided into static binary translation and dynamic binary translation. Static binary translation may, for example, convert the code of an executable file to code that may run on a target architecture without, for example, having to run the code first. In dynamic binary translation, for example, the code may be run before conversion. In some cases conversion may not be direct since not all the code may be discoverable (e.g., reachable, etc.) by the translator. For example, parts of executable code may only be reached through indirect branches, with values, state, etc. needed for translation that may be known only at runtime. Dynamic binary translation may parse (e.g., process, read, etc.) a short sequence of code, may translate that code, and may cache the result of the translation. Other code may be translated as the code is discovered and/or when it is possible to be discovered. Branch instructions may point to already translated code and/or saved and/or cached (e.g., using memorization, etc.). Dynamic binary translation may differ from emulation and may eliminate the loop formed by the emulator reading, decoding, executing, etc. Binary translation may, for example, add a potential disadvantage of requiring additional translation overhead. The additional translation overhead may be reduced, ameliorated, etc. as translated code is repeated, executed multiple times, etc. For example, dynamic translators (e.g., Sun/Oracle HotSpot, etc.) may use dynamic recompilation, etc. to monitor translated code and aggressively (e.g., continuously, repeatedly, in an optimized fashion, etc.) optimize code that may be frequently executed, repeatedly executed, etc. This and other optimization techniques may be similar to that of a JIT compiler, and such compilers may be viewed as performing dynamic translation from a virtual instruction set (e.g., using bytecode, etc.) to a physical instruction set.

The term virtualization may refer to the creation (e.g., generation, design, etc.) of a virtual version (e.g., abstract version, apparent version, appearance of, illusion rather than actual, non-tangible object, etc.) of something (e.g., an object, tangible object, etc.) that may be real (e.g., tangible, non-abstract, physical, actual, etc.). For example, virtualization may apply to a device, mobile device, computer system, machine, server, hardware platform, platform, PC, tablet, operating system (OS), storage device, network resource, software, firmware, combinations of these and/or other objects, etc. For example, a VM may provide, present, etc. a virtual version of a real machine and may run (e.g., execute, etc.) a host OS, other software, etc. A VMM may be software (e.g., monitor, controller, supervisor, etc.) that may allow one or more VMs to run (e.g., be multiplexed, etc.) on one real machine. A hypervisor may be similar to a VMM. A hypervisor, for example, may be higher in functional hierarchy (e.g., logically, etc.) than a supervisor and may, for example, manage multiple supervisors (e.g., kernels, etc.). A domain (also logical domain, etc.) may run in (e.g., execute on, be loaded to, be joined with, etc.) a VM. The relationship between VMs and domains, for example, may be similar to that between programs and processes (or threads, etc.) in an OS. A VM may be a persistent (e.g., non-volatile, stored, permanent, etc.) entity that may reside (e.g., be stored, etc.) on disk and/or other storage, loaded into memory, etc. (e.g., and be analogous to a program, application, software, etc.). Each domain may have a domain identifier (also domain ID) that may be a unique identifier for a domain, and may be analogous (e.g., equivalent, etc.), for example, to a process ID in an OS. The term live migration may be a technique that may move a running (e.g., executing, live, operational, functional, etc.) VM to another physical host (e.g., machine, system, device, etc.) without stopping (e.g., halting, terminating, etc.) the VM and/or stopping any services, processes, threads, etc. that may be running on the VM.

Different types of hardware virtualization may include:
1. Full virtualization: Complete or almost complete simulation of actual hardware to allow software, which may comprise a guest operating system, to run unmodified. A VM may be (e.g., appear to be, etc.) identical (e.g., equivalent to, etc.) to the underlying hardware in full virtualization.
2. Partial virtualization: Some but not all of the target environment may be simulated. Some guest programs, therefore, may need modifications to run in this type of virtual environment.
3. Paravirtualization: A hardware environment is not necessarily simulated; however, the guest programs may be executed in their own isolated domains, as if they are running on a separate system. Guest programs may need to be specifically modified to run in this type of environment. A VM may differ (e.g., in appearance, in functionality, in behavior, etc.) from the underlying (e.g., native, real, etc.) hardware in paravirtualization.

There may be other differences between these different types of hardware virtualization environments. Full virtualization may not require modifications (e.g., changes, alterations, etc.) to the host OS and may abstract (e.g., virtualize, hide, obscure, etc.) underlying hardware. Paravirtualization may also require modifications to the host OS in order to run in a VM. In full virtualization, for example, privileged instructions and/or other system operations, etc. may be handled by the hypervisor with other instructions running on native hardware. In paravirtualization, for example, code may be modified e.g., at compile-time, runtime, etc. For example, in paravirtualization privileged instructions may be removed, modified, etc. and, for example, replaced with calls to a hypervisor e.g., using APIs, hypercalls, etc. For example, Xen may be an example of an OS that may use paravirtualization, but may preserve binary compatibility for user-space applications, etc.

Virtualization may be applied to an entire OS and/or parts of an OS. For example, a kernel may be a main (e.g., basic, essential, key, etc.) software component of an OS. A kernel may form a bridge (e.g., link, coupling, layer, conduit, etc.) between applications (e.g., software, programs, etc.) and underlying hardware, firmware, software, etc. A kernel may, for example, manage, control, etc. one or more (including all) system resources e.g., CPUs, processors, I/O devices, interrupt controllers, timers, etc. A kernel may, for example, provide a low-level abstraction layer for the system resources that applications may control, manage, etc. A kernel running, for example, at the highest hardware privilege level may make system resources available to user-space applications through inter-process communication (IPC) mechanisms, system calls, etc. A microkernel, for example, may be a smaller (e.g., smaller than a kernel, etc.) OS software component. In a microkernel the majority of the kernel code may be implemented, for example, in a set of kernel servers (also just servers) that may communicate through a small kernel, using a small amount of code running in system (e.g., kernel) space and the majority of code in user space. A microkernel may, for example, comprise a simple (e.g., relative to a kernel, etc.) abstraction over (e.g., logically above, etc.) underlying hardware, with a set of primitives, system calls, other code, etc. that may implement basic (e.g., minimal, key, etc.) OS services (e.g., memory management, multitasking, IPC, etc.). Other OS services, (e.g., networking, storage drivers, high-level functions, etc.) may be implemented, for example, in one or more kernel servers. An exokernel may, for example, be similar to a microkernel but may provide a more hardware-like interface e.g., more direct interface, etc. For example, an exokernel may be similar to a paravirtualizing VMM (e.g., Xen, etc.), but an exokernel may be designed as a distinct and separate OS structure rather than to run multiple conventional OSs. A nanokernel may, for example, delegate (e.g., assign, etc.) virtually all services (e.g., including interrupt controllers, timers, etc.), for example, to device drivers. The term operating system-level virtualization (also OS virtualization, container, virtual private server (VPS), virtual environment (VE), jail, etc.) may refer to a server virtualization technique. In OS virtualization, for example, the kernel of an OS may allow (e.g., permit, enable, implement, etc.) one or more isolated user-space instances or containers. For example, a container may appear to be a real server from the view of a user. For example, a container may be based on standard Linux chroot techniques. In addition to isolation, a kernel may control (e.g., limit, stop, regulate, manage, prevent, etc.) interaction between containers.

Virtualization may be applied to one or more hardware components. For example, VMs may include one or more virtual components. The hardware components and/or virtual components may be inside (e.g., included within, part of, etc.) or outside (e.g., connected to, external to, etc.) a CPU, and may be part of or include parts of a memory system and/or subsystem, or may be any part or parts of a system, device, or may be any combinations of such parts and the like, etc. A memory page (also virtual page, or just page) may, for example, be a contiguous block of virtual memory of fixed-length that may be the smallest unit used for (e.g., granularity of, etc.) memory allocation performed by the OS e.g., for a program, etc. A page table may be a data structure, hardware component, etc. used, for example, by a virtual memory system in an OS to store the mapping from virtual addresses to physical addresses. A memory management unit (MMU) may, for example, store a cache of memory mappings from the OS page table in a translation lookaside buffer (TLB). A shadow page table may be a component that is used, for example, by a technique to abstract memory layout from a VM OS. For example, one or more shadow page tables may be used in a VMM to provide an abstraction of (e.g., an appearance of, a view of, etc.) contiguous physical memory. A CPU may include one or more CPU components, circuit, blocks, etc. that may include one or more of the following, but not limited to the following: caches, TLBs, MMUs, page tables, etc. at one or more levels (e.g., L1, L2, L3, etc.). A CPU may include one or more shadow copies of one or more CPU components, etc. One or more shadow page tables may be used, for example, during live migration. One or more virtual devices may include one or more physical system hardware components (e.g., CPU, memory, I/O devices, etc.) that may be virtualized (e.g., abstracted, etc.) by, for example, a hypervisor and presented to one or more domains. In this description the term virtual device, for example, may also apply to virtualization of a device (and/or part(s), portion(s) of a device, etc.) such as a mobile phone or other mobile device, electronic system, appliance, etc. A virtual device may, for example, also apply to (e.g., correspond to, represent, be equivalent to, etc.) virtualization of a collection, set, group, etc. of devices and/or other hardware components, etc.

Virtualization may be applied to I/O hardware, one or more I/O devices (e.g., storage devices, cameras, graphics cards, input devices, printers, network interface cards, etc.), I/O device resources, etc. For example, an IOMMU may be a MMU that connects one or more I/O devices on one or more I/O buses to the memory system. The IOMMU may, for example, map (e.g., translate, etc.) I/O device virtual addresses (e.g., device addresses, I/O addresses, etc.) to physical addresses. The IOMMU may also include memory protection (e.g., preventing and/or controlling unauthorized access to I/O devices, I/O device resources, etc.), one or more memory protection tables, etc. The IOMMU may, for example, also allow (e.g., control, manage, etc.) direct memory access (DMA) and allow (e.g., enable, etc.) one or more VMs, etc. to access DMA hardware.

Virtualization may be applied to software (e.g., applications, programs, etc.). For example, the term application virtualization may refer to techniques that may provide one or more application features. For example, application virtualization may isolate (e.g., protect, separate, divide, insulate, etc.) applications from the underlying OS and/or from other applications. Application virtualization may, for example, enable (e.g., allow, permit, etc.) applications to be copied (e.g., streamed, transferred, pulled, pushed, sent, distributed, etc.) from a source (e.g., centralized location, control center, datacenter server, cloud server, home PC, manufacturer, distributor, licensor, etc.) to one or more target devices (e.g., user devices, mobile devices, clients, etc.). For example, application virtualization may allow (e.g., permit, enable, etc.) the creation of an isolated (e.g., a protected, a safe, an insulated, etc.) environment on a target device. A virtualized application may not necessarily be installed in a conventional (e.g., usual, normal, etc.) manner. For example, a virtualized application (e.g., files, configuration, settings, etc.) may be copied (e.g., streamed, distributed, etc.) to a target (e.g., destination, etc.) device rather than being installed, etc. The execution of a virtualized application at runtime may, for example, be controlled by an application virtualization layer. A virtualized application may, for example, appear to interface directly with the OS, but may actually interface with the virtualization environment. For example, the virtualization environment may proxy (e.g., intercept, forward, manage, control, etc.) one or more (including all) OS requests. The term application streaming may refer, for example, to virtualized application techniques that may use pieces (e.g., parts, portions, etc.) of one or more applications (e.g., code, data, settings, etc.) that may be copied (e.g., streamed, transferred, downloaded, uploaded, moved, pushed, pulled, etc.) to a target device. A software collection (e.g., set, distribution, distro, bundle, package, etc.) may, for example, be a set of software components built, assembled, configured, and ready for use, execution, installation, etc. Applications may be streamed, for example, as one or more collections. Application streaming may, for example, be performed on demand (e.g., as required, etc.) instead of copying or installing an entire application before startup. In some cases a streamed application may, for example, require the installation of a lightweight application on a target device. A streamed application and/or application collections may, for example, be delivered using one or more networking protocols (e.g., HTTP, HTTPS, CIFS, SMB, RTSP, etc.). The term desktop virtualization (also virtual desktop infrastructure (VDI), etc.) may refer, for example, to an application that may be hosted in a VM (or blade PC, appliance, etc.) and that may also include an OS. VDI techniques may, for example, include control of (e.g., management infrastructure for, automated creation of, etc.) one or more virtual desktops. The term session virtualization may refer, for example, to techniques that may use application streaming to deliver applications to one or more hosting servers (e.g., in a remote datacenter, cloud server, cloud service, etc.). The application may then, for example, execute on the hosting server(s). A user may then, for example, connect to (e.g., login, access, etc.) the application, hosting server(s), etc. The user and/or user device may, for example, send input (e.g., mouse-click, keystroke, mouse or other pointer location, audio, video, location, sensor data, control data, combinations of these and/or other data, information, user input, etc.) to the application e.g., on the hosting server(s), etc. The hosting server(s) may, for example, respond by sending output (e.g., screen updates, text, video, audio, signals, code, data, information, etc.) to the user device. A sandbox may, for example, isolate (e.g., insulate, separate, divide, etc.) one or more applications, programs, software, etc. For example, an OS may place an application (e.g., code, preferences, configuration, data, etc.) in a sandbox (e.g., at install time, at boot, or any time). A sandbox may, for example, include controls that may limit the application access (e.g., to files, preferences, network, hardware, firmware, other applications, etc.). As part of the sandbox process, technique, etc. an OS may, for example, install one or more applications in one or more separate sandbox directories (e.g., repositories, storage locations, etc.) that may store the application, application data, configuration data, settings, preferences, files, and/or other information, etc.

Devices may, for example, be protected from accidental faults (e.g., programming errors, bugs, data corruption, hardware faults, network faults, link faults, etc.) or malicious (e.g., deliberate, etc.) attacks (e.g., virus, malware, denial of service attacks, root kits, etc.) by various security, safety, protection mechanisms, etc. For example, CPUs, etc. may include one or more protection rings (or just rings, also hierarchical protection domains, domains, privilege levels, etc.). A protection ring may, for example, include one or more hierarchical levels (e.g., logical layers, etc.) of privilege (e.g., access rights, permissions, gating, etc.). For example, an OS may run (e.g., execute, operate, etc.) in a protection ring. Different protection rings may provide different levels of access (e.g., for programs, applications, etc.) to resources (e.g., hardware, memory, etc.). Rings may be arranged in a hierarchy ranging from the most privileged ring (e.g., most trusted ring, highest ring, inner ring, etc.) to the least privileged ring (e.g., least trusted ring, lowest ring, outer ring, etc.). For example, ring 0 may be a ring that may interact most directly with the real hardware (e.g., CPU, memory, I/O devices, etc.). For example, in a machine without virtualization, ring 0 may contain the OS, kernel, etc.; ring 1 and ring 2 may contain device drivers, etc.; ring 3 may contain user applications, programs, etc. For example, ring 1 may correspond to kernel space (e.g., kernel mode, master mode, supervisor mode, privileged mode, supervisor state, etc.). For example, ring 3 may correspond to user space (e.g., user mode, user state, slave mode, problem state, etc.). There is no fundamental restriction to the use of rings and, in general, any ring may correspond to any type of space, etc.

One or more gates (e.g., hardware gates, controls, call instructions, other hardware and/or software techniques, etc.) may be logically located (e.g., placed, situated, etc.) between rings to control (e.g., gate, secure, manage, etc.) communication, access, resources, transition, etc. between rings e.g., gate the access of an outer ring to resources of an inner ring, etc. For example, there may be gates or call instructions that may transfer control (e.g., may transition, exchange, etc.) to defined entry points in lower-level rings. For example, gating communication or transitions between rings may prevent programs in a first ring from misusing resources of programs in a second ring. For example, software running in ring 3 may be gated from controlling hardware that may only be controlled by device drivers running in ring 1. For example, software running in ring 3 may be required to request access to network resources that may be gated to software running in ring 1.

One or more coupled devices may form a collection, federation, confederation, assembly, set, group, cluster, etc. of devices. A collection of devices may perform operations, processing, computation, functions, etc. in a distributed fashion, manner, etc. In a collection, etc. of devices that may perform distributed processing, it may be important to control the order of execution, how updates are made to files and/or databases, and/or other aspects of collective computation, etc. One or more models, frameworks, etc. may describe, define, etc. the use of operations, etc. and may use a set of definitions, rules, syntax, semantics, etc. using the concepts of transactions, tasks, composable tasks, noncomposable tasks, etc.

For example, a bank account transfer operation (e.g., a type of transaction, etc.) might be decomposed (e.g., broken, separated, etc.) into the following steps: withdraw funds from a first account one and deposit funds into a second account.

The transfer operation may be atomic. For example, if either step one fails or step two fails (or a computer crashes between step one and step two, etc.) the entire transfer operation should fail. There should be no possibility (e.g., state, etc.) that the funds are withdrawn from the first account but not deposited into the second account.

The transfer operation may be consistent. For example, after the transfer operation succeeds, any other subsequent transaction should see the results of the transfer operation.

The transfer operation may be isolated. For example, if another transaction tries to simultaneously perform an operation on either the first or second accounts, what they do to those accounts should not affect the outcome of the transfer option.

The transfer operation may be durable. For example, after the transfer operation succeeds, if a computer should fail, etc., there may be a record that the transfer took place.

The terms tasks, transactions, composable, noncomposable, etc. may have different meanings in different contexts (e.g., with different uses, in different applications, etc.). One set of frameworks (e.g., systems, applications, etc.) that may be used, for example, for transaction processing, database processing, etc. may be languages (e.g., computer languages, programming languages, etc.) such as structured transaction definition language (STDL), structured query language (SQL), etc.

For example, a transaction may be a set of operations, actions, etc. to files, databases, etc. that must take place as a set, group, etc. For example, operations may include read, write, add, delete, etc. All the operations in the set must complete or all operations may be reversed. Reversing the effects of a set of operations may roll back the transaction. If the transaction completes, the transaction may be committed. After a transaction is committed, the results of the set of operations may be available to other transactions.

For example, a task may be a procedure that may control execution flow, delimit or demarcate transactions, handle exceptions, and may call procedures to perform, for example, processing functions, computation, access files, access databases (e.g., processing procedures) or obtain input, provide output (e.g., presentation procedures).

For example, a composable task may execute within a transaction. For example, a noncomposable task may demarcate (e.g., delimit, set the boundaries for, etc.) the beginning and end of a transaction. A composable task may execute within a transaction started by a noncomposable task. Therefore, the composable task may always be part of another task's work. Calling a composable task may be similar to calling a processing procedure, e.g., based on a call and return model. Execution of the calling task may continue only when the called task completes. Control may pass to the called task (possibly with parameters, etc.) and then control may return to the calling task. The composable task may always be part of another task's transaction. A noncomposable task may call a composable task and both tasks may be located on different devices. In this case, their transaction may be a distributed transaction. There may be no logical distinction between a distributed and nondistributed transaction.

Transactions may compose. For example, the process of composition may take separate transactions and add them together to create a larger single transaction. A composable system, for example, may be a system whose component parts do not interfere with each other.

For example, a distributed car reservation system may access remote databases by calling composable tasks in remote task servers. For example, a reservation task at a rental site may call a task at the central site to store customer data in the central site rental database. The reservation task may call another task at the central site to store reservation data in the central site rental database and the history database.

The use of composable tasks may enable a library of common functions to be implemented as tasks. For example, applications may require similar processing steps, operations, etc. to be performed at multiple stages, points, etc. For example, applications may require one or more tasks to perform the same processing function. Using a library, for example, common functions may be called from multiple points within a task or from different tasks.

A uniform resource locator (URL) is a uniform resource identifier (URI) that specifies where a known resource is available and the mechanism for retrieving it. A URL comprises the following: the scheme name (also called protocol, e.g., http, https, etc.), a colon (“:”), a domain name (or IP address), a port number, and the path of the resource to be fetched. The syntax of a URL is scheme://domain:port/path.

HTTP is the hypertext transfer protocol.

HTTPS is the hypertext transfer protocol secure (HTTPS) and is a combination of the HTTP with the SSL/TLS protocol to provide encrypted communication and secure identification.

A session is a sequence of network request-response transactions.

An IP address is a binary number assigned to a device on an IP network (e.g., 172.16.254.1) and can be formatted as a 32-bit dot-decimal notation (e.g., for IPv4) or in a notation to represent 128-bits, such as “2001:db8:0:1234:0:567:8:1” (e.g., for IPv6).

A domain name comprises one or more concatenated labels delimited by dots (periods), e.g., “en.wikipedia.org”. The domain name “en.wikipedia.org” includes labels “en” (the leaf domain), “wikipedia” (the second-level domain), and “org” (the top-level domain).

A hostname is a domain name that has at least one IP address. A hostname is used to identify a device (e.g., in an IP network, on the World Wide Web, in an e-mail header, etc.). Note that all hostnames are domain names, but not all domain names are hostnames. For example, both en.wikipedia.org and wikipedia.org are hostnames if they both have IP addresses assigned to them. The domain name xyz.wikipedia.org is not a hostname if it does not have an IP address, but aa.xyz.wikipedia.org is a hostname if it does have an IP address.

A domain name comprises one or more parts, the labels that are concatenated, being delimited by dots such as “example.com”. Such a concatenated domain name represents a hierarchy. The right-most label conveys the top-level domain; for example, the domain name www.example.com belongs to the top-level domain corn. The hierarchy of domains descends from the right to the left label in the name; each label to the left specifies a subdivision, or subdomain of the domain to the right. For example, the label example specifies a node example.com as a subdomain of the corn domain, and www is a label to create www.example.com, a subdomain of example.com.

The DHCP is the dynamic host configuration protocol (described in RFC 1531 and RFC 2131) and is an automatic configuration protocol for IP networks. When a DHCP-configured device (DHCP client) connects to a network, the DHCP client sends a broadcast query requesting an IP address from a DHCP server that maintains a pool of IP addresses. The DHCP server assigns the DHCP client an IP address and lease (the length of time the IP address is valid).

A media access control address (MAC address, also Ethernet hardware address (EHA), hardware address, physical address) is a unique identifier (e.g., 00-B0-D0-86-BB-F7) assigned to a network interface (e.g., address of a network interface card (NIC), etc.) for communications on a physical network (e.g., Ethernet).

A trusted path (and thus trusted user, and/or trusted device, etc.) is a mechanism that provides confidence that a user is communicating with what the user intended to communicate with, ensuring that attackers cannot intercept or modify the information being communicated.

A proxy server (also proxy) is a server that acts as an intermediary (e.g., gateway, go-between, helper, relay, etc.) for requests from clients seeking resources from other servers. A client connects to the proxy server, requesting a service (e.g., file, connection, web page, or other resource, etc.) available from a different server, the origin server. The proxy server provides the resource by connecting to the origin server and requesting the service on behalf of the client. A proxy server may alter the client request or the server response.

A forward proxy located in an internal network receives requests from users inside an internal network and forwards the requests to the Internet outside the internal network. A forward proxy typically acts a gateway for a client browser (e.g., user, client, etc.) on an internal network and sends HTTP requests on behalf of the client browser to the Internet. The forward proxy protects the internal network by hiding the client IP address by using the forward proxy IP address. The external HTTP server on the Internet sees requests originating from the forward proxy rather than the client.

A reverse proxy (also origin-side proxy, server-side proxy) located in an internal network receives requests from Internet users outside the internal network and forwards the requests to origin servers in the internal network. Users connect to the reverse proxy and may not be aware of the internal network. A reverse proxy on an internal network typically acts as a gateway to an HTTP server on the internal network by acting as the final IP address for requests from clients that are outside the internal network. A firewall is typically used with the reverse proxy to ensure that only the reverse proxy can access the HTTP servers behind the reverse proxy. The external client sees the reverse proxy as the HTTP server.

An open proxy forwards requests to and from anywhere on the Internet.

In network computing, the term demilitarized zone (DMZ, also perimeter network), is used to describe a network (e.g., physical network, logical subnetwork, etc.) exposed to a larger untrusted network (e.g., Internet, cloud, etc.). A DMZ may, for example, expose external services (e.g., of an organization, company, device, etc.). One function of a DMZ is to add an additional layer of security to a local area network (LAN). In the event of an external attack, the attacker only has access to resources (e.g., equipment, server(s), router(s), etc.) in the DMZ.

In the HTTP protocol a redirect is a response (containing header, status code, message body, etc.) to a request (e.g., GET, etc.) that directs a client (e.g., browser, etc.) to go to another location (e.g., site, URL, etc.)

A localhost (as described, for example, in RFC 2606) is the hostname given to the address of the loopback interface (also virtual loopback interface, loopback network interface, loopback device, network loopback), referring to “this computer”. For example, directing a browser on a computer running an HTTP server to a loopback address (e.g., http://localhost, http://127.0.0.1, etc.) may display the website of the computer (assuming a web server is running on the computer and is properly configured). Using a loopback address allows connection to any locally hosted network service (e.g., computer game server, or other inter-process communications, etc.).

The localhost hostname corresponds to an IPv4 address in the 127.0.0.0/8 net block i.e., 127.0.0.1 (for IPv4, see RFC 3330) or ::1 (for IPv6, see RFC 3513). The most common IP address for the loopback interface is 127.0.0.1 for IPv4, but any address in the range 127.0.0.0 to 127.255.255.255 maps to the loopback device. The routing table of an operating system (OS) may contain an entry so that traffic (e.g., packet, network traffic, IP datagram, etc.) with destination IP address set to a loopback address (the loopback destination address) is routed internally to the loopback interface. In the TCP/IP stack of an OS the loopback interface is typically contained in software (and not connected to any network hardware).

An Internet socket (also network socket or just socket) is an endpoint of a bidirectional inter-process communication (IPC) flow across a network (e.g., IP-based computer network such as the Internet, etc.). The term socket is also used for the API for the TCP/IP protocol stack. Sockets provide the mechanism to deliver incoming data packets to a process (e.g., application, program, application process, thread, etc.), based on a combination of local (also source) IP address, local port number, remote (also destination) IP address, and remote port number. Each socket is mapped by the OS to a process. A socket address is the combination of an IP address and a port number.

Communication between server and client (which are types of endpoints) may use a socket. Communicating local and remote sockets are socket pairs. A socket pair is described by a unique 4-tuple (e.g., four numbers, four sets of numbers, etc.) of source IP address, destination IP address, source port number, destination port number, (e.g., local and remote socket addresses). For TCP, each socket pair is assigned a unique socket number. For UDP, each local socket address is assigned a unique socket number.

A computer program may be described using one or more function calls (e.g., macros, subroutines, routines, processes, etc.) written as function_name( ), where function_name is the name of the function. The process (e.g., a computer program, etc.) by which a local server establishes a TCP socket may include (but is not limited to) the following steps and functions:
1. socket( ) creates a new local socket.
2. bind( ) associates (e.g., binds, links, ties, etc.) the local socket with a local socket address i.e., a local port number and IP address (the socket and port are thus bound to a software application running on the server).
3. listen( ) causes a bound local socket to enter the listen state.

A remote client then establishes connections with the following steps:
1. socket( ) creates a new remote socket.
2. connect( ) assigns a free local port number to the remote socket and attempts to establishes a new connection with the local server.

The local server then establishes the new connection with the following step:
1. accept( ) accepts the request to create a new connection from the remote client.

Client and server may now communicate using send( ) and receive( ).

An abstraction of the architecture of the World Wide Web is representational state transfer (REST). The REST architectural style was developed by the W3C Technical Architecture Group (TAG) in parallel with HTTP 1.1, based on the existing design of HTTP 1.0 The World Wide Web represents the largest implementation of a system conforming to the REST architectural style. A REST architectural style may consist of a set of constraints applied to components, connectors, and data elements, e.g., within a distributed hypermedia system. REST ignores the details of component implementation and protocol syntax in order to focus on the roles of components, the constraints upon their interaction with other components, and their interpretation of significant data elements. REST may be used to describe desired web architecture, to identify existing problems, to compare alternative solutions, and to ensure that protocol extensions do not violate the core constraints of the web. The REST architectural style may also be applied to the development of web services as an alternative to other distributed-computing specifications such as SOAP.

The REST architectural style describes six constraints: (1) Uniform Interface. The uniform interface constraint defines the interface between clients and servers. It simplifies and decouples the architecture, which enables each part to evolve independently. The uniform interface that any REST services must provide is fundamental to its design. The four principles of the uniform interface are: (1.1) Resource-Based. Individual resources are identified in requests using URIs as resource identifiers. The resources themselves are conceptually separate from the representations that are returned to the client. For example, the server does not send its database, but rather, some HTML, XML or JSON that represents some database records expressed, for instance, in Finnish and encoded in UTF-8, depending on the details of the request and the server implementation.

### Manipulation of Resources Through Representations.

When a client holds a representation of a resource, including any metadata attached, it has enough information to modify or delete the resource on the server, provided it has permission to do so. (1.3) Self-descriptive Messages. Each message includes enough information to describe how to process the message. For example, which parser to invoke may be specified by an Internet media type (previously known as a MIME type). Responses also explicitly indicate their cache-ability. (1.4) Hypermedia as the Engine of Application State (HATEOAS). Clients deliver state via body contents, query-string parameters, request headers and the requested URI (the resource name). Services deliver state to clients via body content, response codes, and response headers. This is technically referred to as hypermedia (or hyperlinks within hypertext). HATEOAS also means that, where necessary, links are contained in the returned body (or headers) to supply the URI for retrieval of the object itself or related objects. (2) Stateless. The necessary state to handle the request is contained within the request itself, whether as part of the URI, query-string parameters, body, or headers. The URI uniquely identifies the resource and the body contains the state (or state change) of that resource. Then, after the server completes processing, the appropriate state, or the piece(s) of state that matter, are communicated back to the client via headers, status and response body. A container provides the concept of “session” that maintains state across multiple HTTP requests. In REST, the client must include all information for the server to fulfill the request, resending state as necessary if that state must span multiple requests. Statelessness enables greater scalability since the server does not have to maintain, update, or communicate that session state. Additionally, load balancers do not have to deal with session affinity for stateless systems. State, or application state, is that which the server cares about to fulfill a request—data necessary for the current session or request. A resource, or resource state, is the data that defines the resource representation—the data stored in the database, for instance. Application state may be data that could vary by client, and per request. Resource state, on the other hand, is constant across every client who requests it. (3) Cacheable. Clients may cache responses. Responses must therefore, implicitly or explicitly, define themselves as cacheable, or not, to prevent clients reusing stale or inappropriate data in response to further requests. Well-managed caching partially or completely eliminates some client—server interactions, further improving scalability and performance. (4) Client-Server. The uniform interface separates clients from servers. This separation of concerns means that, for example, clients are not concerned with data storage, which remains internal to each server, so that the portability of client code is improved. Servers are not concerned with the user interface or user state, so that servers can be simpler and more scalable. Servers and clients may also be replaced and developed independently, as long as the interface is not altered. (5) Layered System. A client cannot ordinarily tell whether it is connected directly to the end server, or to an intermediary along the way. Intermediary servers may improve system scalability by enabling load-balancing and by providing shared caches. Layers may also enforce security policies. (6) Code on Demand (optional). Servers are able to temporarily extend or customize the functionality of a client by transferring logic to the client that it can then execute. Examples of this may include compiled components such as Java applets and client-side scripts such as JavaScript. Complying with these constraints, and thus conforming to the REST architectural style, will enable any kind of distributed hypermedia system to have desirable emergent properties such as performance, scalability, simplicity, modifiability, visibility, portability and reliability. The only optional constraint of REST architecture is code on demand. If a service violates any other constraint, it cannot strictly be referred to as RESTful.

In computer programming, an application programming interface (API) specifies how software components should interact with each other. In addition to accessing databases or computer hardware such as hard disk drives or video cards, an API may be used to simplify the programming of graphical user interface components. An API may be provided in the form of a library that includes specifications for routines, data structures, object classes, and variables. In other cases, notably for SOAP and REST services, an API may be provided as a specification of remote calls exposed to the API consumers. An API specification may take many forms, including an international standard such as POSIX, vendor documentation such as the Microsoft Windows API, or the libraries of a programming language, e.g., Standard Template Library in C++ or Java API. Web APIs may also be a component of the web fabric. An API may differ from an application binary interface (ABI) in that an API may be source code based while an ABI may be a binary interface. For instance POSIX may be an API, while the Linux standard base may be an ABI.

### Overview

Some embodiments of the present disclosure address the problem of deployment and ongoing management of internet connected devices and some embodiments are directed to approaches for configuring devices, connections, and severs to provide specific services. More particularly, disclosed herein and in the accompanying figures are exemplary environments, methods, and systems for installation and configuration of connected devices.

### Conventions and Use of Terms

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. The articles “a” and “an” as used in this application and the appended claims should generally be construed to mean “one or more” unless specified otherwise or is clear from the context to be directed to a singular form.

If any definitions (e.g., figure reference signs, specialized terms, examples, data, information, definitions, conventions, glossary, etc.) from any related material (e.g., parent application, other related application, material incorporated by reference, material cited, extrinsic reference, etc.) conflict with this application (e.g., abstract, description, summary, claims, etc.) for any purpose (e.g., prosecution, claim support, claim interpretation, claim construction, etc.), then the definitions in this application shall apply.

This section may include terms and definitions that may be applicable to all embodiments described in this specification and/or described in specifications incorporated by reference. Terms that may be special to the field of the various embodiments of the disclosure or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization and/or use of other conventions, styles, formats, etc. by itself, should not be construed as somehow limiting such terms beyond any given definition and/or to any specific embodiments disclosed herein, etc.

### Use of Equivalents

The terminology used herein is for the purpose of describing particular embodiments only and is not intended to be limiting of the invention. As used herein, the singular forms (e.g., a, an, the, etc.) are intended to include the plural forms as well, unless the context clearly indicates otherwise.

The terms comprises and/or comprising, when used in this specification, specify the presence of stated features, integers, steps, operations, elements, and/or components, but do not preclude the presence or addition of one or more other features, integers, steps, operations, elements, components, and/or groups thereof.

In the following description and claims, the terms include and comprise, along with their derivatives, may be used, and are intended to be treated as synonyms for each other.

In the following description and claims, the terms coupled and connected, along with their derivatives, may be used. It should be understood that these terms are not necessarily intended as synonyms for each other. For example, connected may be used to indicate that two or more elements (e.g., circuits, components, logical blocks, hardware, software, firmware, processes, computer programs, etc.) are in direct physical, logical, and/or electrical contact with each other. Further, coupled may be used to indicate that that two or more elements are in direct or indirect physical, electrical and/or logical contact. For example, coupled may be used to indicate that that two or more elements are not in direct contact with each other, but the two or more elements still cooperate or interact with each other.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terms that are explained, described, defined, etc. here and other related terms in the fields of systems design may have different meanings depending, for example, on their use, context, etc. For example, task may carry a generic or general meaning encompassing, for example, the notion of work to be done, etc. or may have a very specific meaning particular to a computer language construct (e.g., in STDL or similar). For example, the term transaction may be used in a very general sense or as a very specific term in a computer program or computer language, etc. Where confusion may arise over these and other related terms, further clarification may be given at their point of use herein.

Reference is now made in detail to certain embodiments. The disclosed embodiments are not intended to be limiting of the claims.

### Descriptions of Exemplary Embodiments

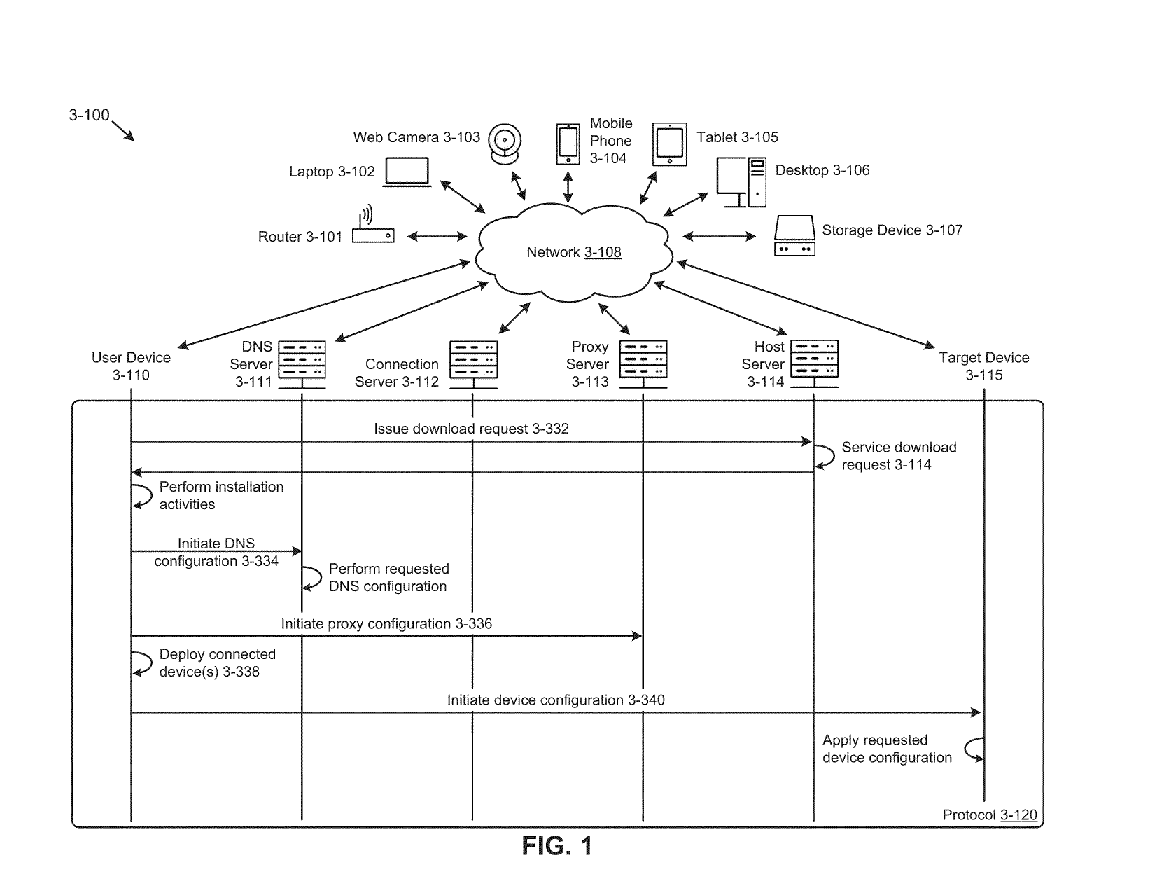

FIG. 1 exemplifies an environment 3-100 for supporting connections and servers as used in the installation and configuration of connected devices. As an option, one or more instances of environment 3-100 or any aspect thereof may be implemented in the context of the architecture and functionality of the embodiments described herein. Also, the environment 3-100 or any aspect thereof may be implemented in any desired environment.

For example, environment 3-100 may contain one or more of the following items, or one or more combinations, networks, collections, federations, groupings, etc. of one or more of the following items, devices, servers, systems, etc. (but not limited to the following): laptop 3-102 (or other computing device, etc.); web camera 3-103 (or other device, system, monitor, sensor, actuator and/or any other similar device, system including any Internet-of-Things (IoT), device, system and the like, etc.); mobile phone 3-104 (or any other mobile device, watch, device, system and the like, etc.); tablet 3-105 or similar computing device; desktop 3-106 (or PC, or any other similar system, computing device, combination of devices, and the like, etc.); storage device 3-107 (or storage system, cloud back-up, removable storage, mobile storage device, combinations of these, networks of these, router 3-101 and/or any other types of network equipment and/or storage service, storage devices, collections or combinations of these and the like, etc.); network 3-108 or any collection, combination, etc. of networks including but not limited to wireless, wired, serial, high-speed, optical, buses, serial and/or parallel connections of these, and the like, etc; user device 3-110 including any type of computing device, virtual device, and the like; domain name service server auch as DNS server 3-111 or any similar proxy server, relay, server, etc. that performs a service, mapping, network functions, relay service, combinations of these and the like, etc; connection server 3-112 or any server, computing device, cloud service, and the like that may perform one or more connection, service, relay, brokering, hand-off, subscription, logging, authentication and/or similar functions, services and the like; proxy server 3-113 or any other server, compute device, cloud service, etc. that may perform proxy functions, firewall, communication setup, protocol translation, address mapping, and/or similar functions and the like; host server 3-114 or any other server, cloud services, combinations of servers, datacenter, etc. that may perform, provide, supply, etc. one or more services, offerings, advertisements, subscriptions, media content, web content, user services, device services, database functions, payment systems, combinations of these and/or any other similar functions and the like; target device 3-115 or any computing device, network device, embedded system, machine, IoT device, sensor, actuator, combinations, collections, networks of these and other similar systems, functions and the like; protocol 3-120 or any collection of protocols, networking protocols, networking standards, bus protocols, bus standards that may be used, for example, to allow communication between one or more elements, devices, servers, systems, etc. in the environment 3-100. Note that in one embodiment, one of more of the elements, devices, servers, etc. shown may be combined, merged, joined, etc. in any way.

In one embodiment, one or more services may be provided to allow one or more devices or elements to be connected as shown in environment 3-100 to communicate to/with each other. In one embodiment, communication between two devices, etc. may occur via a third device. In one embodiment, communication may occur directly between two devices, etc. In one embodiment, communication between two devices, etc. may occur via any number of other devices, networks, protocols, etc. In one embodiment, communication between two devices may be set up using one first configuration and then switched to a second configuration. For example, in one embodiment, communication between two devices of a first device and a second device may be initially set up using a third device, server, etc. as a relay; the relay may then act to broker, set up, etc. a direct communication line between the first device and the second device. Any method of communication setup may be used. For example, any protocol (e.g., TCP, IP, wireless, wired, encrypted, layered, nested, tunneled, etc. and/or any combination of these and the like, etc.) may be used. Any number of communication links may be setup, reconfigured, adjusted, modified, etc. For example an initial setup of a first communication link between two devices may be modified to a second setup of a second communication link and then may be modified to a third setup of a third communication link. Links may be adjusted, modified, setup, torn down, established, re-established, maintained, controlled, transformed, and/or otherwise altered, etc. in response to network performance, resource availability, subscription models, bandwidth, network traffic, network traffic types, communication quality, and/or any other metric, measure, property, etc. of the devices, servers, networks and/or any other similar component, device, server, service, combinations of these and the like, etc.

In one embodiment, for example, a service may be provided to allow the connection of two or more devices. In one embodiment, for example, a service may be provided to allow a user to connect to a remote web camera, etc. In one embodiment, for example, a framework, kit, software development kit (SDK), and/or other similar components, etc. may be provided to developers, programmers, companies, OEMs, and the like in order to develop, program, construct, deploy, sell, distribute, etc. one or more elements, components, aspects, etc. of a service that allows the connection of devices. In one embodiment, for example, a service may be offered that allows users to connect to one or more devices in the IoT.

The shown protocol 3-120 exemplifies one possible traversal through messages and any corresponding activities responsive to the messages. The shown protocol commences when a user, at a user device, initiates a download of a kit via a download request (see, e.g., message 3-332) which causes a host server 3-114 to service the download request, and return a kit to the requestor. The kit may itself perform some installation activities (e.g., unpacking) and may autonomously complete installation and open for user interaction. Such a user may interact with any of the herein-disclosed user interfaces, and may, for example initiate configuration of a DNS server (see, e.g., message 3-334). In some settings a proxy is used, and a user may interact with any of the herein-disclosed user interfaces to initiate configuration of a proxy server (see, e.g., message 3-336). In some situations, the foregoing configuration (or more or less) may be sufficient to provide connection services for devices in the IoT. Devices can be deployed (see, e.g., operation 3-338) and such devices can be configured (see, e.g., message 3-340). In some situations services provided by a DNS server and/or a proxy server are used for device deployment and configuration.

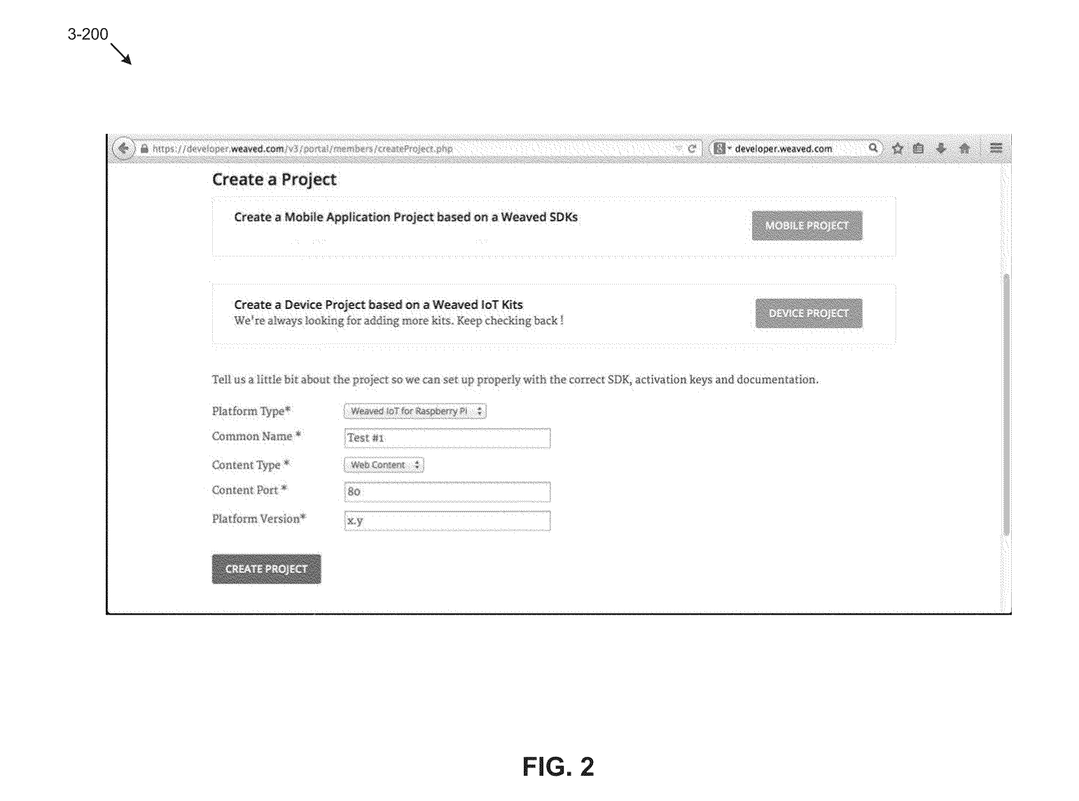

FIG. 2 depicts a project setup user interface 3-200 as used in the installation and configuration of connected devices. As an option, one or more instances of project setup user interface 3-200 or any aspect thereof may be implemented in the context of the architecture and functionality of the embodiments described herein. Also, the project setup user interface 3-200 or any aspect thereof may be implemented in any desired environment.

In one embodiment, a project setup user interface 3-200 may represent a page of a website that allows developers, etc. to create a service, etc. that allows connections between devices. In one embodiment, for example, the developer may create a project that is used to allow communication, connection, etc. to a particular type of device. In one embodiment, for example, the project may allow communication, etc. to a Raspberry Pi, a particular type of embedded system compute device or platform. Any type of device, platform, etc. may be used. For example, a project may be based on any type of embedded system using or based on, etc. any SoC, ASIC, CPU, microcontroller, FPGA, microprocessor, combinations of these and the like. In one embodiment, for example, the creation of a project, as shown in FIG. 2, may allow the creation of software, code, software environments, configuration files, database entries, user accounts, passwords, keys, secret keys, public keys, user IDs, device codes, device IDs, authorization codes, subscription information, other keys and codes etc, install scripts, binary files, combinations of these, etc. that may allow communication by a developer, user, etc. from any mobile device, laptop, desktop, server, etc. to the Raspberry Pi (or any other similar device, etc.). In one embodiment, for example, communication may be of any form. In one embodiment, for example, communication may use any type, form, mode, etc. of content. In one embodiment, for example, content may be web content, e.g., HTML served using http or https. In one embodiment, for example, communication may use any network port, e.g., port 80 for web content, etc. In one embodiment, for example, any number of types, forms, modes, ports, contents, etc. may be used. In one embodiment, for example, each combination of content and/or port may correspond to a service. Any number type, form, mode of services may be used. In one embodiment, for example, a remote secure login service may be provided using SSH.

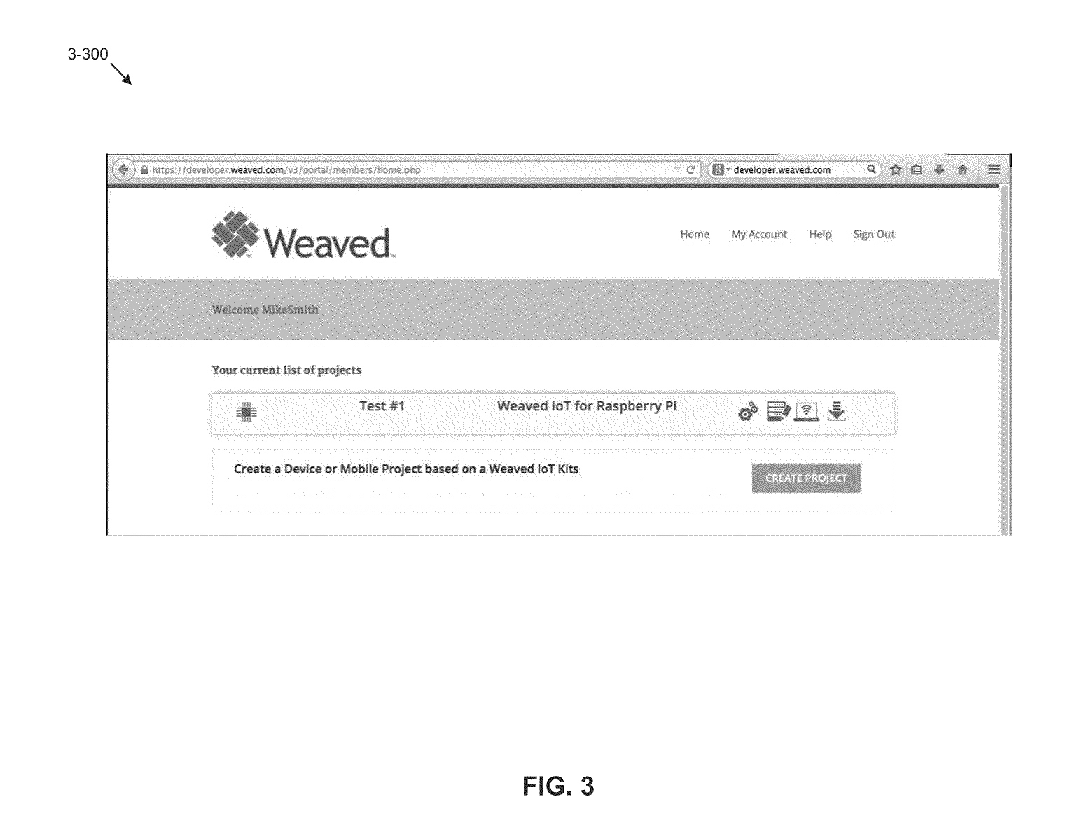

FIG. 3 depicts a project creation user interface 3-300 as used in the installation and configuration of connected devices, in one embodiment. As an option, one or more instances of project creation user interface 3-300 or any aspect thereof may be implemented in the context of the architecture and functionality of the embodiments described herein. Also, the project creation user interface 3-300 or any aspect thereof may be implemented in any desired environment.

In one embodiment, a project creation user interface 3-300 presents to a developer a list of current projects, their platform types and/or any other property, aspect, interface, content, etc.

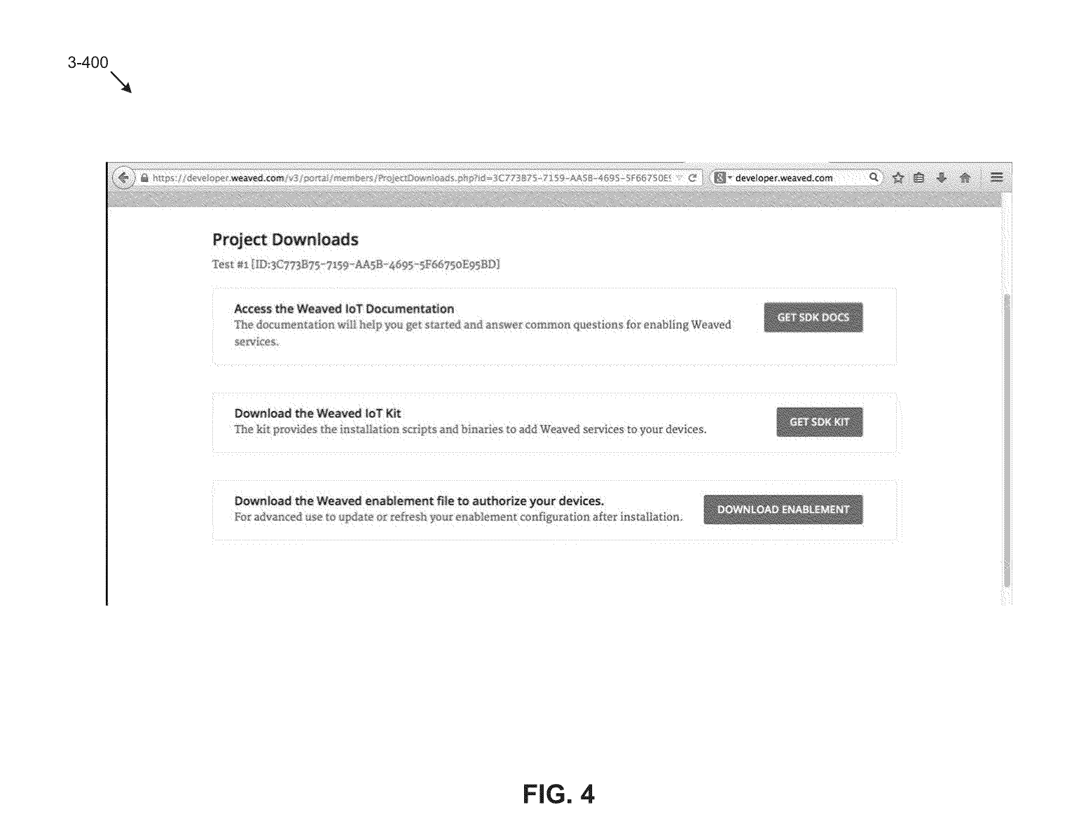

FIG. 4 depicts a project download user interface 3-400 as used in the installation and configuration of connected devices, in one embodiment. As an option, one or more instances of project download user interface 3-400 or any aspect thereof may be implemented in the context of the architecture and functionality of the embodiments described herein. Also, the project download user interface 3-400 or any aspect thereof may be implemented in any desired environment.

In one embodiment, for example, a developer may be presented a list of options to download specific kits, collections, assemblies, directories, etc. of one or more software packages, etc. One embodiment, for example, may present to a developer a list of packages that may perform a specific service, e.g., provide remote secure login to a platform, device, etc. from a user's mobile device. One embodiment, for example, a screen such as the project download user interface 3-400 may present to a developer a list of actions that may be performed on a project, including but not limited to, account maintenance, authorization of devices, setup of configuration files, enablement of connections, database access, and/or any other similar function, etc.

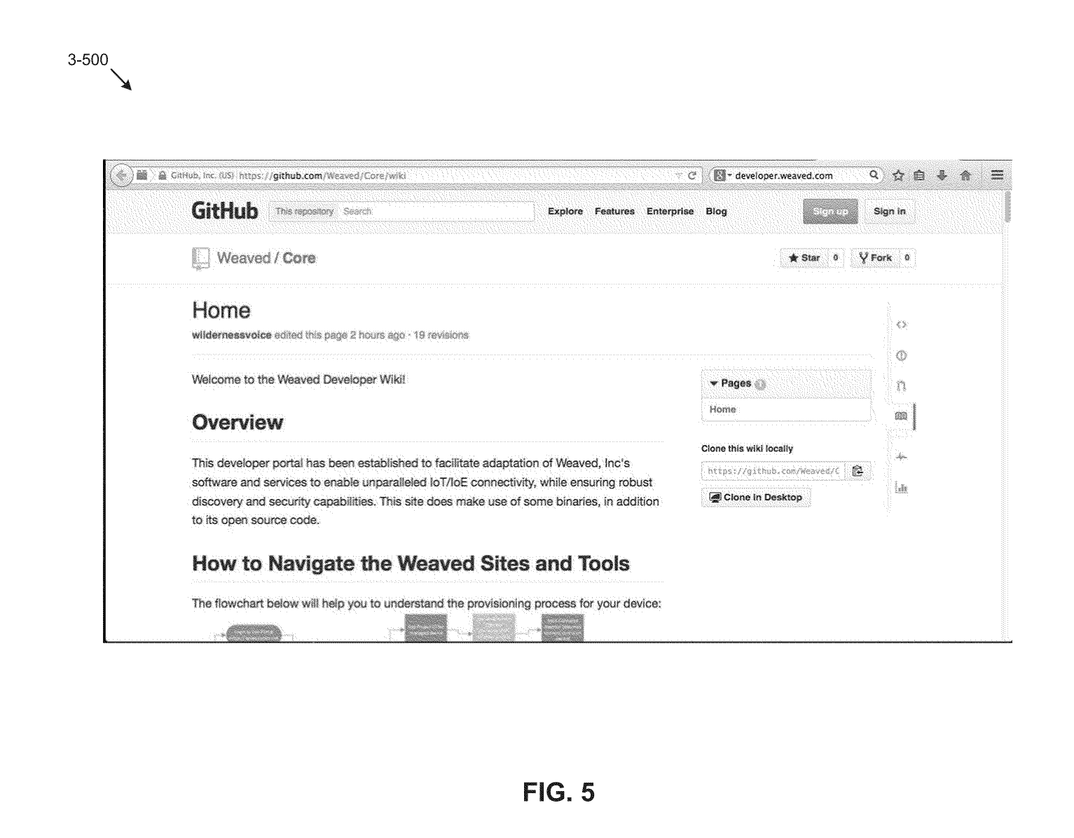

FIG. 5 depicts a core navigation user interface 3-500 as used in the installation and configuration of connected devices, in one embodiment. As an option, one or more instances of core navigation user interface 3-500 or any aspect thereof may be implemented in the context of the architecture and functionality of the embodiments described herein. Also, the core navigation user interface 3-500 or any aspect thereof may be implemented in any desired environment.

In one embodiment, for example, a developer may be presented a list of software packages, help files, installation directions, expected results, error codes, and the like in order to facilitate the development process. One embodiment, for example, may represent a web page hosted by the company supplying the device software, device services, etc. One embodiment, for example, may represent a web page hosted by a third-party, e.g., software repository (e.g., GitHub, etc.).

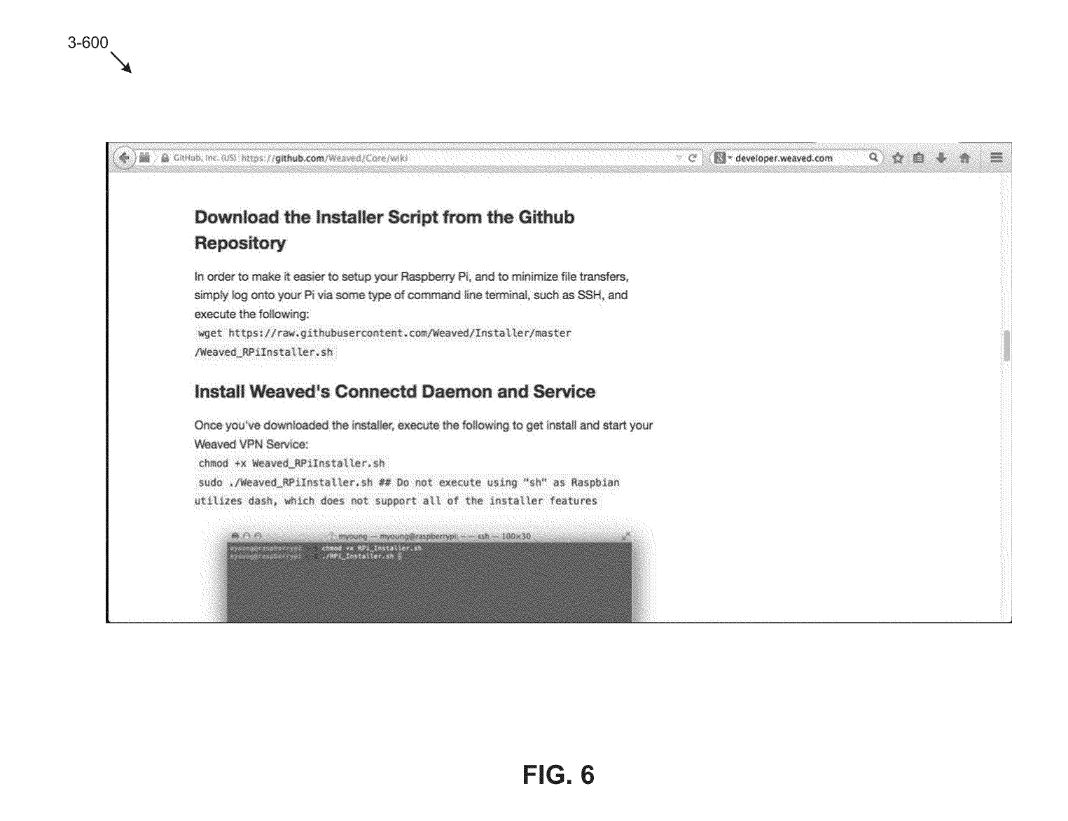

FIG. 6 depicts a daemon service installation user interface 3-600 as used in the installation and configuration of connected devices, in one embodiment. As an option, one or more instances of daemon service installation user interface 3-600 or any aspect thereof may be implemented in the context of the architecture and functionality of the embodiments described herein. Also, the daemon service installation user interface 3-600 or any aspect thereof may be implemented in any desired environment.

In one embodiment, for example, a developer may be presented the sequence of instructions, code, commands, etc. that may be needed to install, create, update, modify, etc. one or more services on a device. One embodiment, for example, the daemon service installation user interface 3-600 may convey to a developer the sequence of instructions needed to install a secure remote login service on the device.

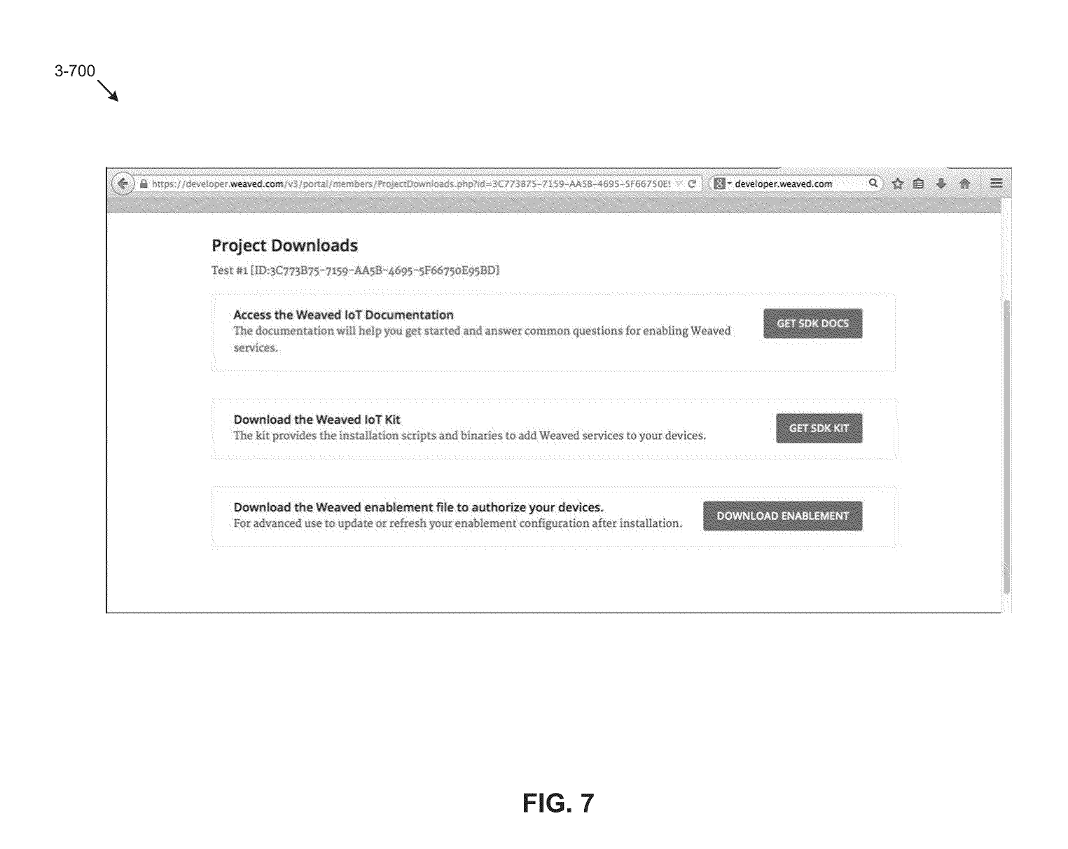

FIG. 7 depicts a device authorization user interface 3-700 as used in the installation and configuration of connected devices, in one embodiment. As an option, one or more instances of device authorization user interface 3-700 or any aspect thereof may be implemented in the context of the architecture and functionality of the embodiments described herein. Also, the device authorization user interface 3-700 or any aspect thereof may be implemented in any desired environment.

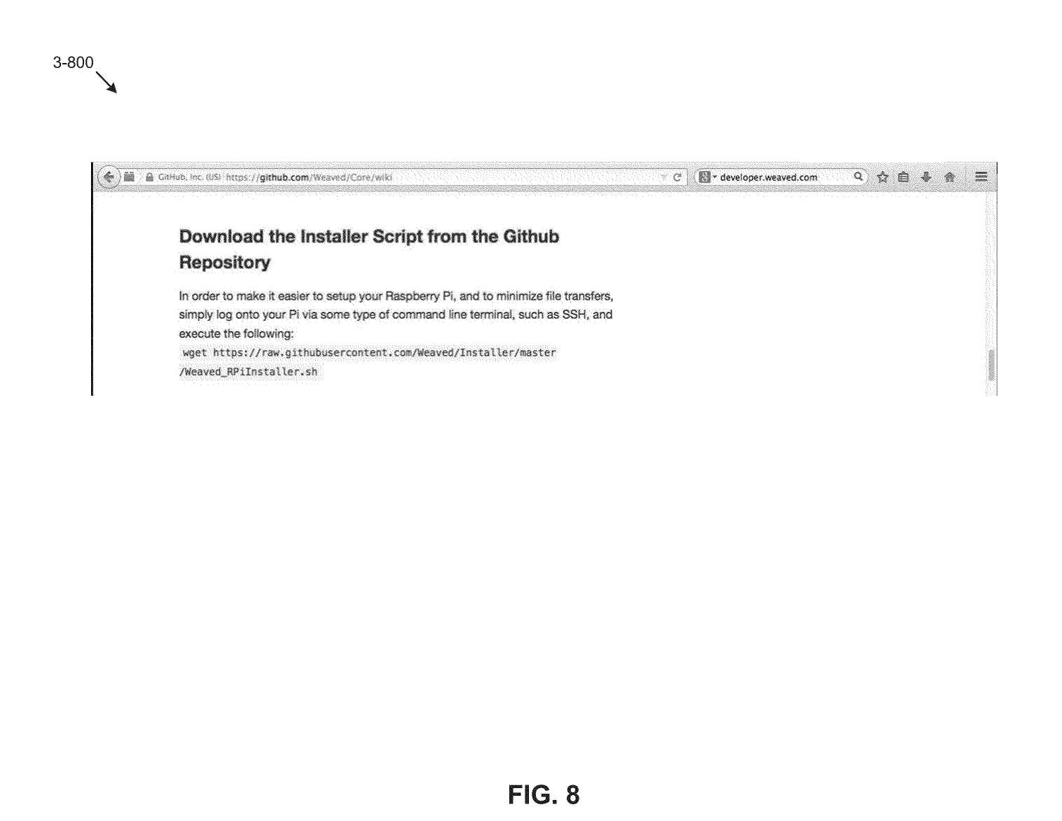

FIG. 8 depicts a script access user interface 3-800 as used in the installation and configuration of connected devices, in one embodiment. As an option, one or more instances of script access user interface 3-800 or any aspect thereof may be implemented in the context of the architecture and functionality of the embodiments described herein. Also, the script access user interface 3-800 or any aspect thereof may be implemented in any desired environment.

In one embodiment, for example, as in the script access user interface 3-800 presented to a developer might include the sequence of instructions, code, commands, etc. that the developer may use to enter into a terminal program (e.g., SSH, etc.) on the device. In one embodiment, for example, these instructions may download code, software packages, compile commands, make files, install scripts and the like, etc. from one or more software repositories. One embodiment, for example, may convey to a developer the sequence of instructions, code, commands, etc. that the developer may execute on a Raspberry Pi or other similar platform, device, etc.

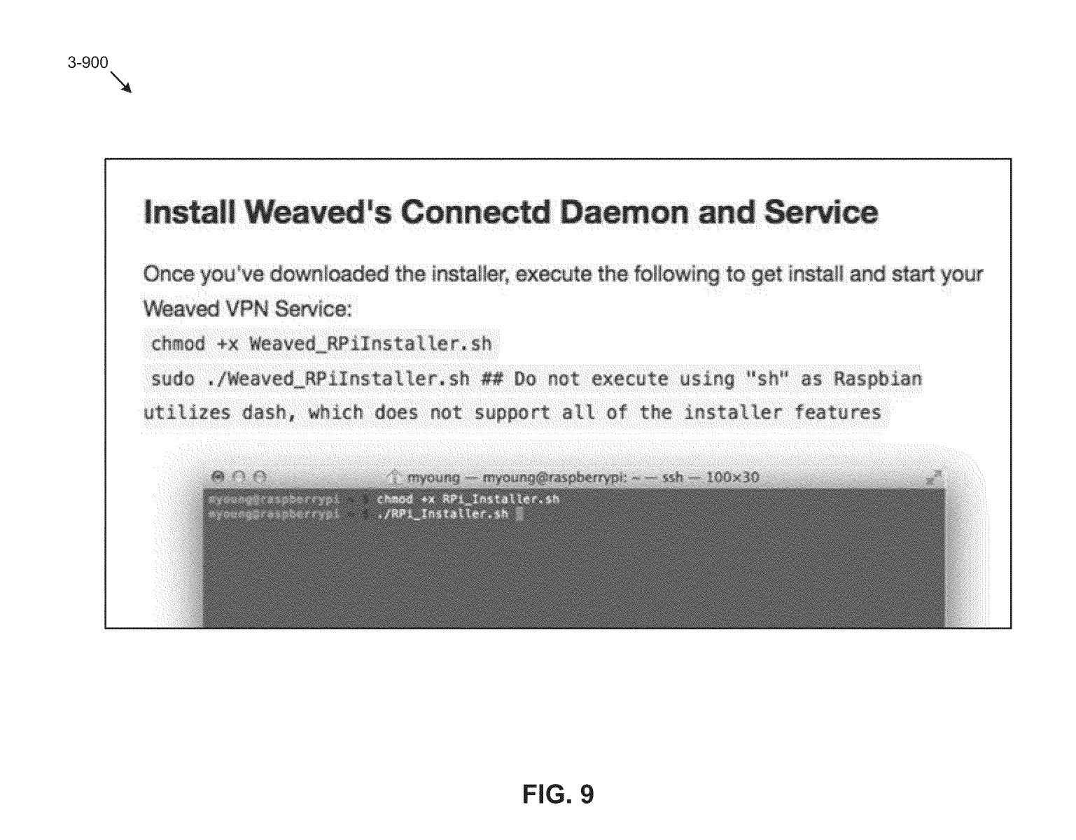

FIG. 9 depicts a daemon startup user interface 3-900 as used in the installation and configuration of connected devices, in one embodiment. As an option, one or more instances of daemon startup user interface 3-900 or any aspect thereof may be implemented in the context of the architecture and functionality of the embodiments described herein. Also, the daemon startup user interface 3-900 or any aspect thereof may be implemented in any desired environment.

In one embodiment, for example, a developer may be presented the instructions, commands, etc. needed to create, start, maintain, modify, execute, etc. one or more pieces, parts, collections, of software, programs, daemons, startup scripts, and the like. One embodiment may convey the instructions to start a daemon on a Raspberry Pi or other similar platform. One embodiment, for example, may convey instructions to start a daemon that may be used to monitor, initiate, control, setup, tear down, authorize, etc. one or more communication links, connections, services, etc. to and/or between one or more devices, etc.

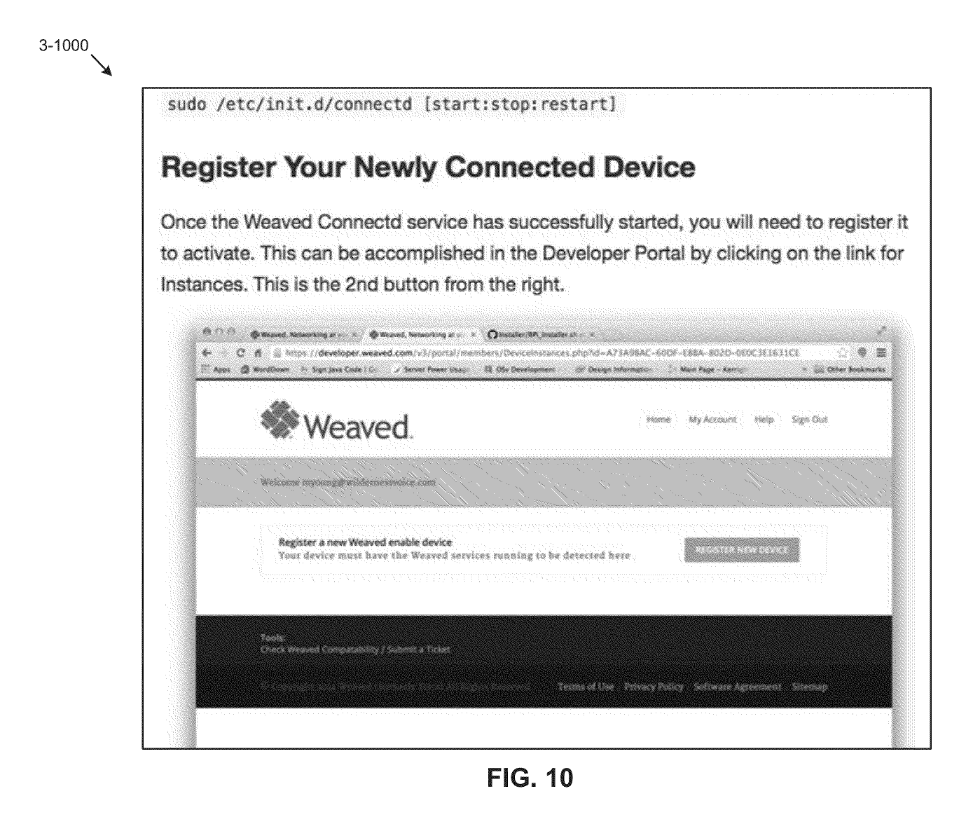

FIG. 10 depicts a connected device registration user interface 3-1000 as used in the installation and configuration of connected devices, in one embodiment. As an option, one or more instances of connected device registration user interface 3-1000 or any aspect thereof may be implemented in the context of the architecture and functionality of the embodiments described herein. Also, the connected device registration user interface 3-1000 or any aspect thereof may be implemented in any desired environment.

In one embodiment, for example, a developer may be presented with the option to register a device, platform, etc. One embodiment, for example, the connected device registration user interface 3-1000 may be part of a flow that allows a developer to provision, enable, register, etc. a device, platform, etc.

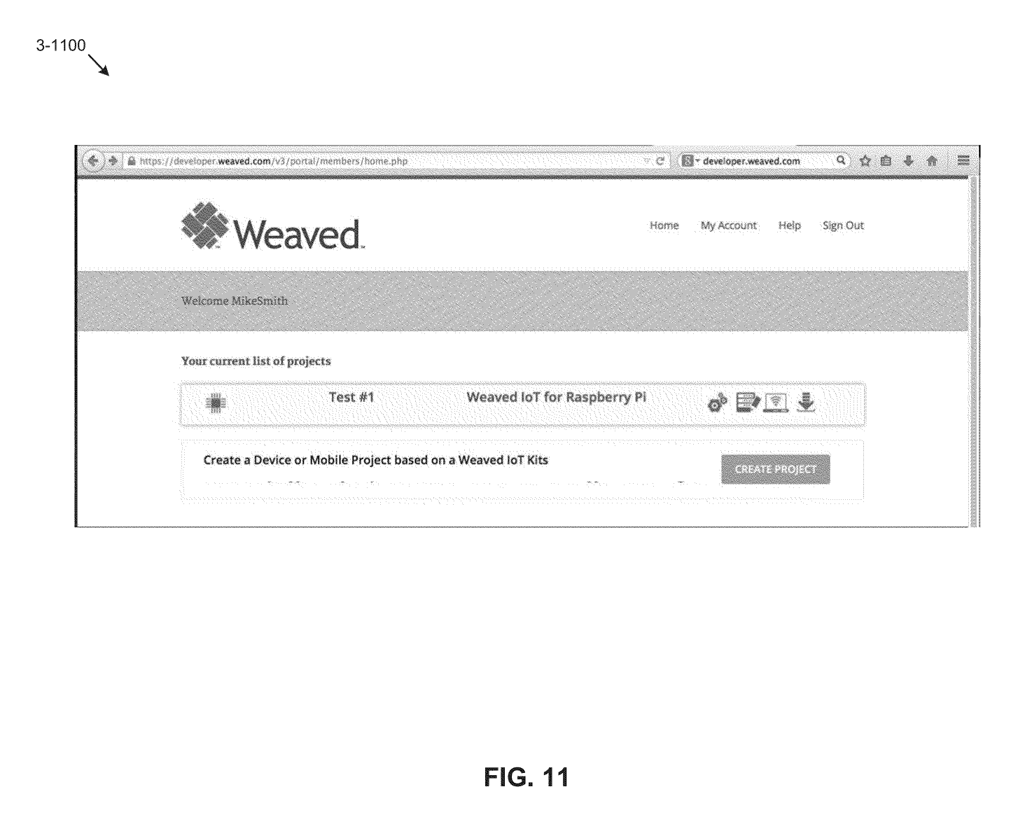

FIG. 11 depicts a project listing user interface 3-1100 as used in the installation and configuration of connected devices, in one embodiment. As an option, one or more instances of project listing user interface 3-1100 or any aspect thereof may be implemented in the context of the architecture and functionality of the embodiments described herein. Also, the project listing user interface 3-1100 or any aspect thereof may be implemented in any desired environment.

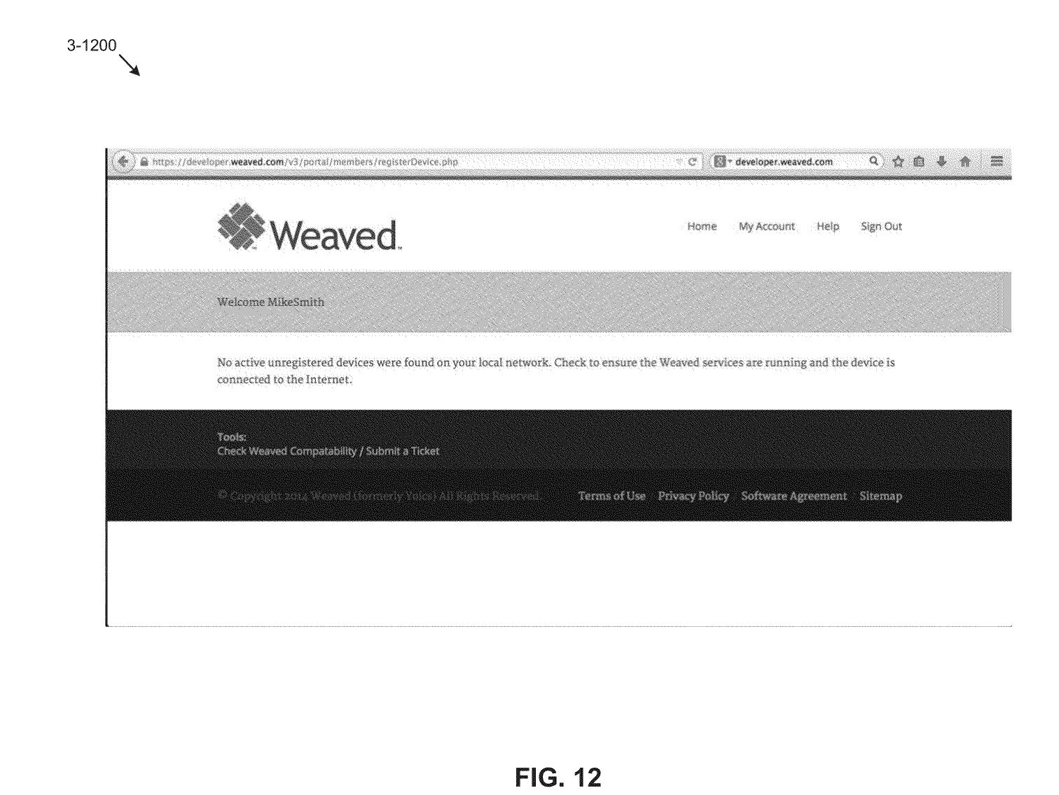

FIG. 12 depicts a startup page user interface 3-1200 as used in the installation and configuration of connected devices, in one embodiment. As an option, one or more instances of startup page user interface 3-1200 or any aspect thereof may be implemented in the context of the architecture and functionality of the embodiments described herein. Also, the startup page user interface 3-1200 or any aspect thereof may be implemented in any desired environment.

In one embodiment, for example, a developer may be presented with the option of the number of registered devices, active devices, or devices in some other state that are visible, known, attached, etc. to a network. One embodiment, for example, may convey to a developer the number of devices, their state, and/or any other property, information, etc. One embodiment, for example, a page such as startup page user interface 3-1200, may convey to a developer the number and status of devices on a local network. One embodiment, for example, may convey to a developer the number, type, and status of devices that are connected to a network with the same base IP address, etc.

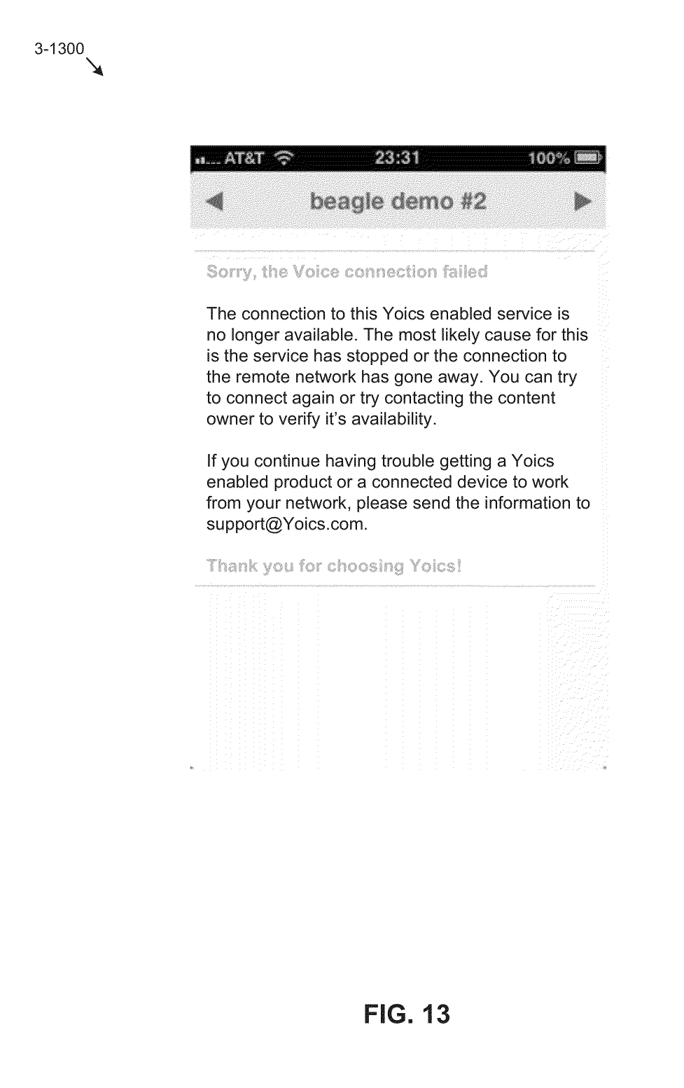

FIG. 13 depicts a display terminal status page 3-1300 as used in the installation and configuration of connected devices, in one embodiment. As an option, one or more instances of display terminal status page 3-1300 or any aspect thereof may be implemented in the context of the architecture and functionality of the embodiments described herein. Also, the display terminal status page 3-1300 or any aspect thereof may be implemented in any desired environment.

In one embodiment, for example, may be a screen that is part of an application that may run on a user device. One embodiment, for example, may be one screen of an iPhone app that may allow a user, developer, etc. to connect to one or more devices, platforms, etc. One embodiment, for example, may convey to a developer, etc. that a connection to a device, etc. has failed, been rejected, torn down, disconnected, etc. Of course, any status information, update, connection details, communication link errors, etc. may be shown.

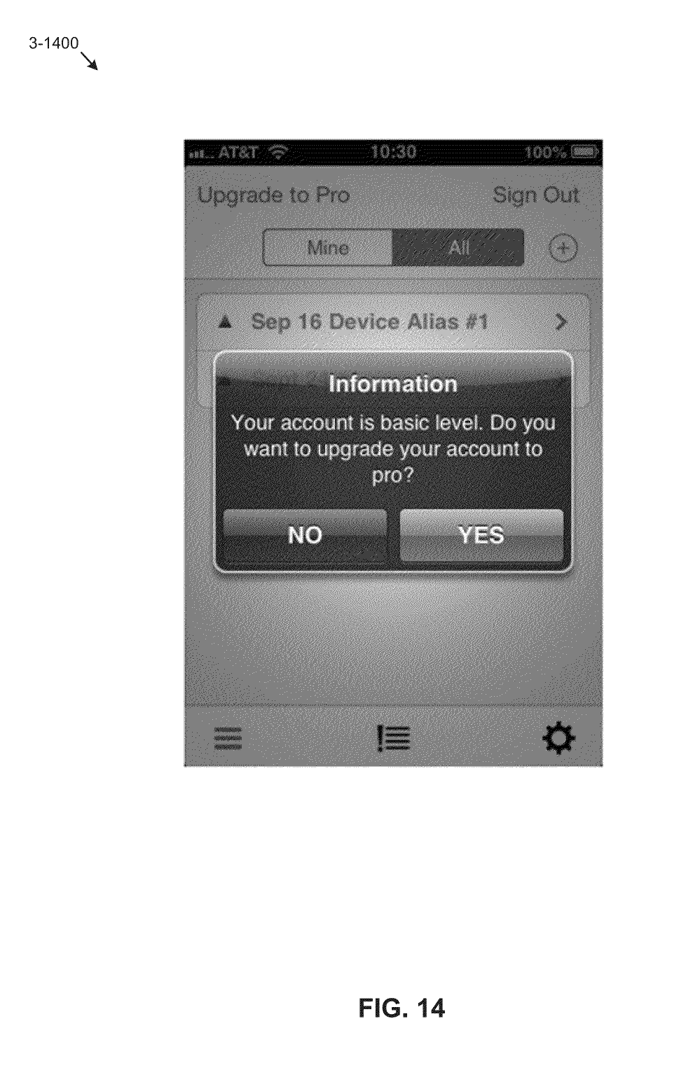

FIG. 14 depicts a display terminal upgrade prompt user interface 3-1400 as used in the installation and configuration of connected devices, in one embodiment. As an option, one or more instances of display terminal upgrade prompt user interface 3-1400 or any aspect thereof may be implemented in the context of the architecture and functionality of the embodiments described herein. Also, the display terminal upgrade prompt user interface 3-1400 or any aspect thereof may be implemented in any desired environment.

In one embodiment, for example, may be one screen of an iPhone app that may allow a user, developer, etc. to connect to one or more devices, platforms, etc. One embodiment, for example, may provide an interface, etc. that may allow the user, developer, etc. to upgrade and/or otherwise modify, change, alter, etc. one or more parameters, aspects, features, etc. of an account, subscription, service level, and the like.

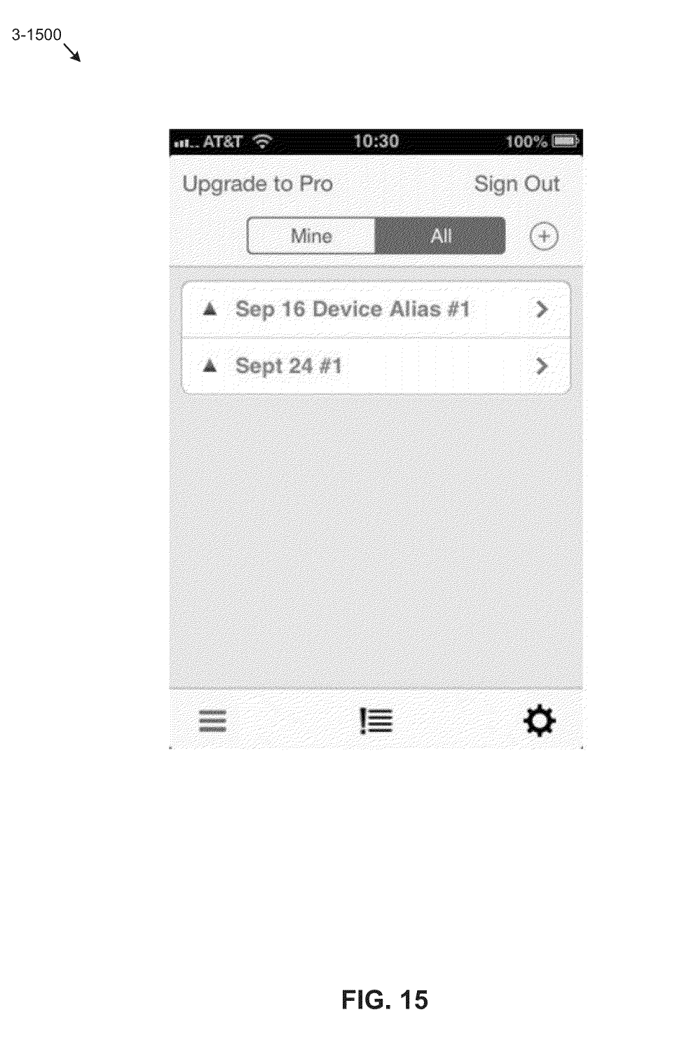

FIG. 15 depicts a display terminal upgrade status user interface 3-1500 as used in the installation and configuration of connected devices, in one embodiment. As an option, one or more instances of display terminal upgrade status user interface 3-1500 or any aspect thereof may be implemented in the context of the architecture and functionality of the embodiments described herein. Also, the display terminal upgrade status user interface 3-1500 or any aspect thereof may be implemented in any desired environment.

In one embodiment, for example, display terminal upgrade status user interface 3-1500 may be one screen of an iPhone app that may allow a user, developer, etc. to connect to one or more devices, platforms, etc. One embodiment, for example, may provide an interface, etc. that details the devices, platforms, etc. that are available for connection, etc. Of course, any number, type, form, kind, etc. of various options, features, aspects of control, maintenance, configuration, etc. related to devices, connections, etc. may be provided. One embodiment, for example, may be one screen of an iPhone app that may allow a user, developer, etc. to connect to one or more devices, platforms, etc. One embodiment, for example, may provide an interface, etc. that shows the status of each user, developer, etc. device. One embodiment, for example, may be one screen of an iPhone app that may allow a user, developer, etc. to connect to one or more devices, platforms, etc. One embodiment, for example, may show the name of a device that is available next to a circle, while a triangle may represent a device that if offline or otherwise unavailable for connection, etc. Of course any type of information, status, state, etc. may be provided.

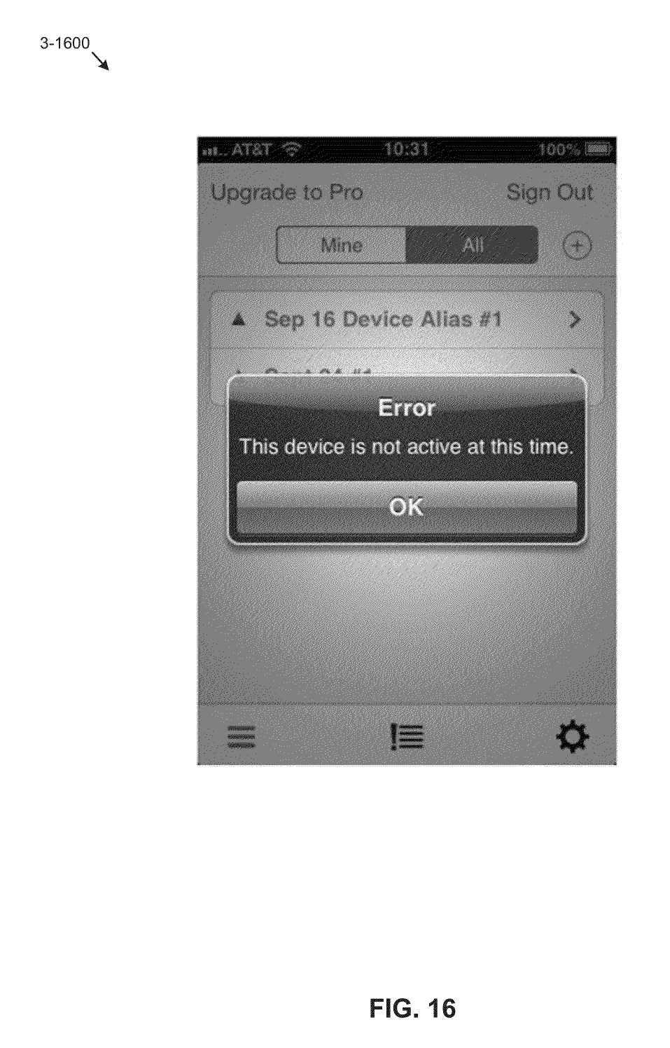

FIG. 16 depicts a display terminal device error user interface 3-1600 as used in the installation and configuration of connected devices, in one embodiment. As an option, one or more instances of display terminal device error user interface 3-1600 or any aspect thereof may be implemented in the context of the architecture and functionality of the embodiments described herein. Also, the display terminal device error user interface 3-1600 or any aspect thereof may be implemented in any desired environment.

In one embodiment, for example, as in the a display terminal device error user interface 3-1600, may be presented on one screen of an iPhone app that may allow a user, developer, etc. to connect to one or more devices, platforms, etc. One embodiment, for example, may provide an interface, etc. that informs the user, developer, etc. of the status and/or other information, properties, aspects, etc. of remote devices, etc. One embodiment, for example, may provide an interface, etc.

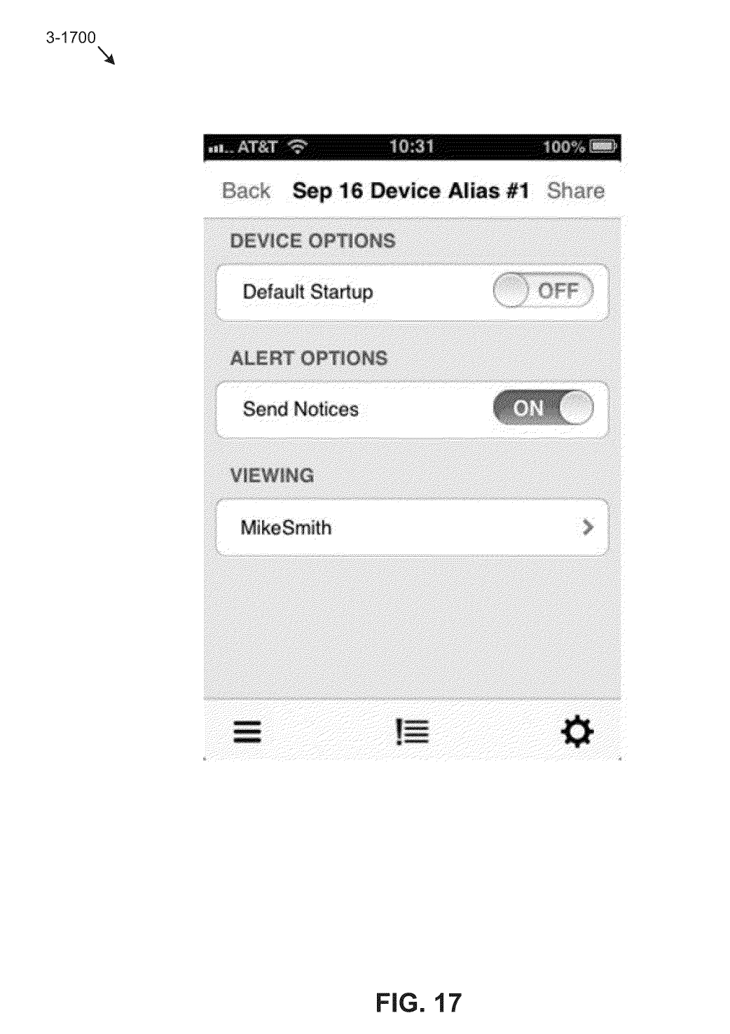

FIG. 17 depicts a display terminal option setup user interface 3-1700 as used in the installation and configuration of connected devices, in one embodiment. As an option, one or more instances of display terminal option setup user interface 3-1700 or any aspect thereof may be implemented in the context of the architecture and functionality of the embodiments described herein. Also, the display terminal option setup user interface 3-1700 or any aspect thereof may be implemented in any desired environment.

In one embodiment, for example, an instance of a display terminal option setup user interface 3-1700 may be one screen of an iPhone app that may allow a user, developer, etc. to connect to one or more devices, platforms, etc. One embodiment, for example, may provide an interface, etc. to configure and/or otherwise modify, alter, change, etc. one or more parameters, features, options, alerts, notices, notification methods, startup options, preferences, sharing, combinations of these and/or other information and the like. One embodiment, for example, may provide an interface, etc. that is specific to a single device, but need not be. One embodiment, for example, may provide an interface, etc. to share a device between other users, etc.

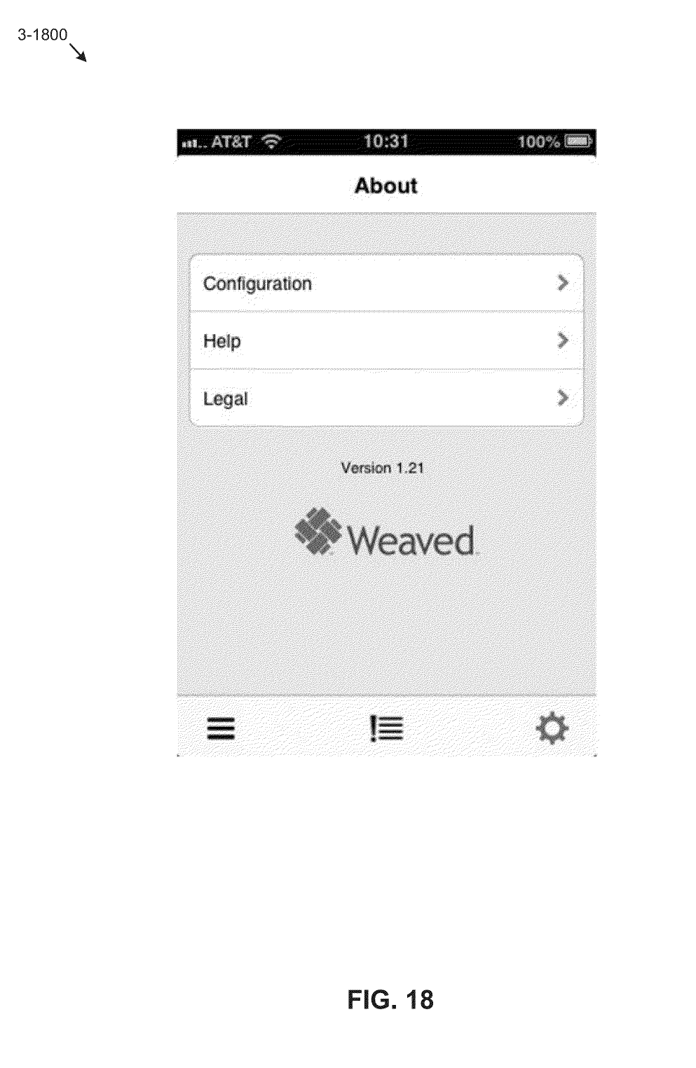

FIG. 18 depicts a display terminal information display user interface 3-1800 as used in the installation and configuration of connected devices, in one embodiment. As an option, one or more instances of display terminal information display user interface 3-1800 or any aspect thereof may be implemented in the context of the architecture and functionality of the embodiments described herein. Also, the display terminal information display user interface 3-1800 or any aspect thereof may be implemented in any desired environment.

In one embodiment, for example, may be one screen of an iPhone app that may allow a user, developer, etc. to connect to one or more devices, platforms, etc. One embodiment, for example, may provide an interface, etc. to provide, view, present, navigate to, list, etc. information about the app, version, date, OEM, configuration (at the app level, etc.), help, legal notices, etc.

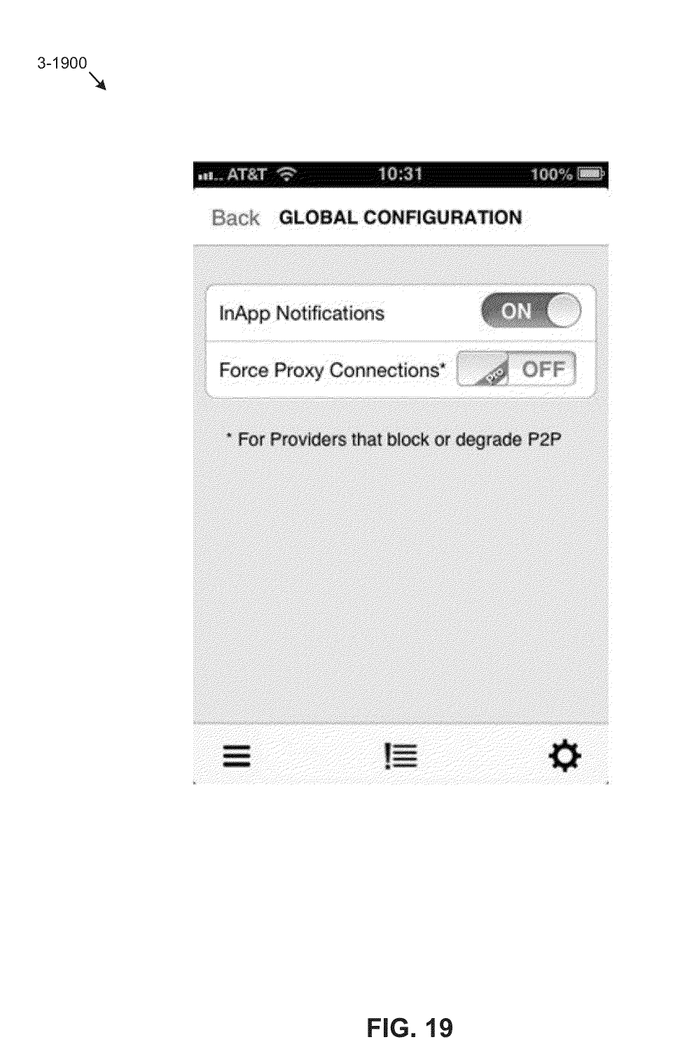

FIG. 19 depicts a display terminal global configuration user interface 3-1900 as used in the installation and configuration of connected devices, in one embodiment. As an option, one or more instances of display terminal global configuration user interface 3-1900 or any aspect thereof may be implemented in the context of the architecture and functionality of the embodiments described herein. Also, the display terminal global configuration user interface 3-1900 or any aspect thereof may be implemented in any desired environment.

In one embodiment, for example, a display terminal global configuration user interface 3-1900 may be presented on one screen of an iPhone app that may allow a user, developer, etc. to connect to one or more devices, platforms, etc. One embodiment, for example, may provide an interface, etc. to view global or other configuration parameters. One embodiment, for example, may provide an interface, etc. to control one or more aspects of the communication and/or connection links, networks, couplings, etc. between users and/or one or more devices. One embodiment, for example, may provide an interface, etc. to control, modify, alter, etc. one or more aspects of the app behavior, device behavior and/or any other similar aspect of services, service functions, alerts, notifications, etc. One embodiment, for example, may provide an interface, etc. that may determine when, how, etc. notifications are sent and/or how they are presented, viewed, displayed, etc. (e.g., if notifications are allowed while the user is working in another application, e.g., email, etc.). One embodiment, for example, may provide an interface, etc. to control, modify, alter, etc. how connections are established. One embodiment, for example, may provide an interface, etc. to force a relay mode of connection rather than a direct connection between devices, etc. Of course any type, form, mode of connection links, communication links, etc. may be controlled. Of course any sequence of connections, types of connections, number of connections, startup sequence, hand-off, brokering of connections, relay operation, combinations of these and/or any other aspect, status, feature, parameter, configuration, function, flow, sequence, etc. of the behavior, etc. of communication and/or connections may be so controlled.

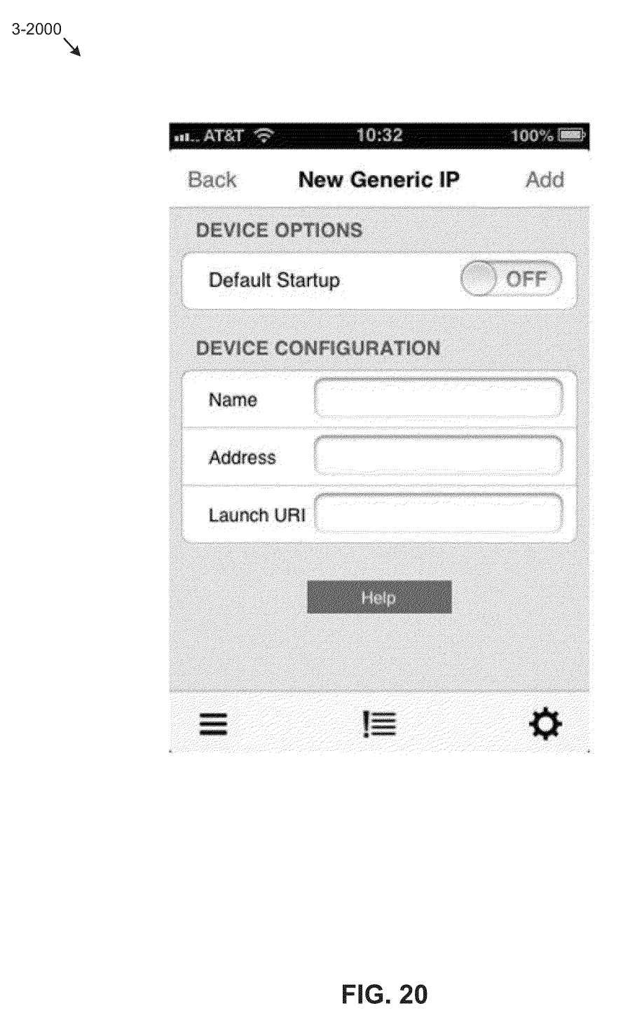

FIG. 20 depicts a display terminal device options user interface 3-2000 as used in the installation and configuration of connected devices, in one embodiment. As an option, one or more instances of display terminal device options user interface 3-2000 or any aspect thereof may be implemented in the context of the architecture and functionality of the embodiments described herein. Also, the display terminal device options user interface 3-2000 or any aspect thereof may be implemented in any desired environment.

In one embodiment, for example, display terminal device options user interface 3-2000 may be one screen of an iPhone app that may allow a user, developer, etc. to connect to one or more devices, platforms, etc. One embodiment, for example, may provide an interface, etc. to control startup behavior, configure devices, etc. Of course any controls, fields, parameters, etc. may be displayed and enabled for change, alteration, entry, configuration, modification, etc.

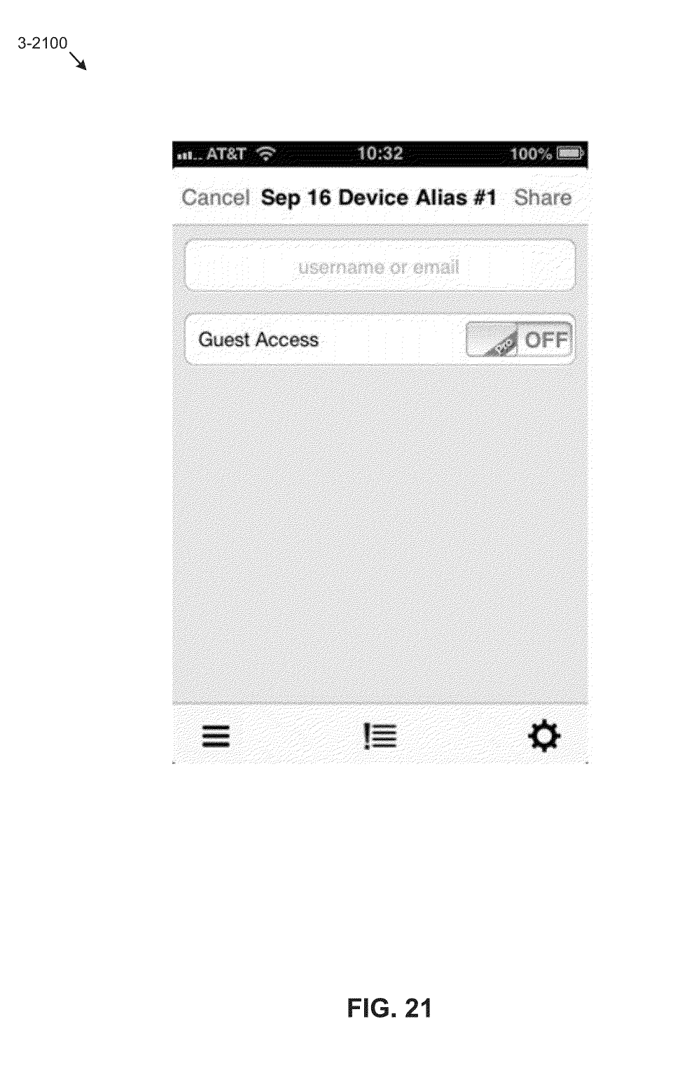

FIG. 21 depicts a display terminal guest access setup user interface 3-2100 as used in the installation and configuration of connected devices, in one embodiment. As an option, one or more instances of display terminal guest access setup user interface 3-2100 or any aspect thereof may be implemented in the context of the architecture and functionality of the embodiments described herein. Also, the display terminal guest access setup user interface 3-2100 or any aspect thereof may be implemented in any desired environment.

In one embodiment, for example, display terminal guest access setup user interface 3-2100 may be one screen of an iPhone app that may allow a user, developer, etc. to connect to one or more devices, platforms, etc. One embodiment, for example, may provide an interface, etc. to allow a user, developer, etc. to share a device with another user. One embodiment, for example, may provide an interface, etc. to provide the username, email address, or other identification, etc. of another use with which to share one or more devices. Other options may of course be provided including but not limited to guest access control, group access and/or access, control, etc. based on any other form of group, directory, location, ownership, etc.

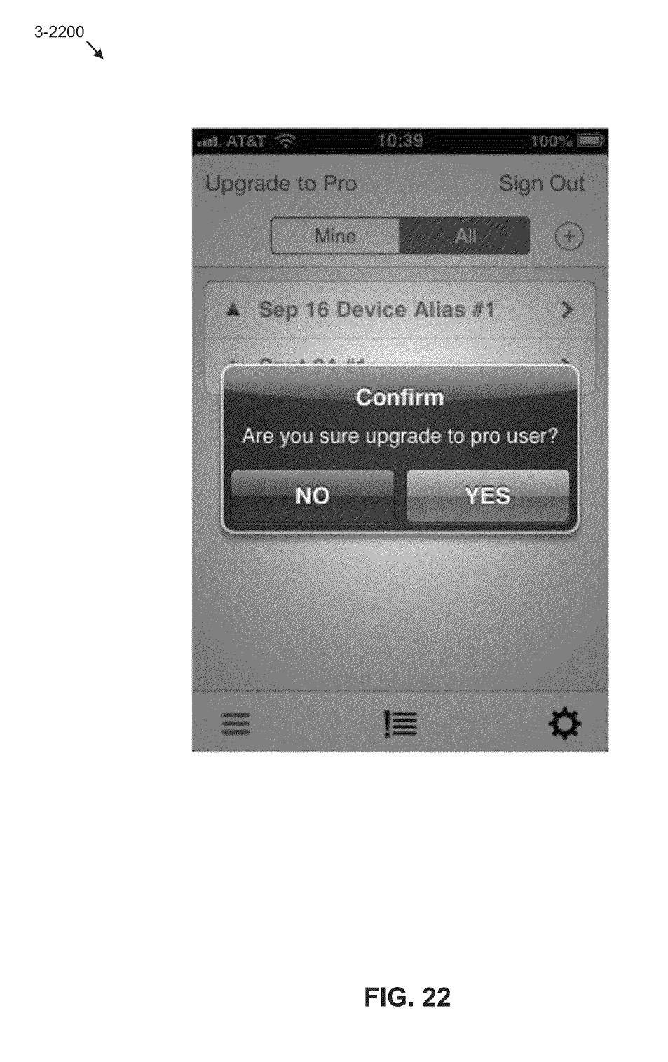

FIG. 22 depicts a display terminal confirmation user interface 3-2200 as used in the installation and configuration of connected devices, in one embodiment. As an option, one or more instances of display terminal confirmation user interface 3-2200 or any aspect thereof may be implemented in the context of the architecture and functionality of the embodiments described herein. Also, the display terminal confirmation user interface 3-2200 or any aspect thereof may be implemented in any desired environment.

In one embodiment, for example, display terminal confirmation user interface 3-2200 may be one screen of an iPhone app that may allow a user, developer, etc. to connect to one or more devices, platforms, etc. One embodiment, for example, may provide an interface, etc. to allow the user of an iPhone app to upgrade and/or otherwise modify, control, configure, etc. one or more aspects of an account, subscription service and the like.

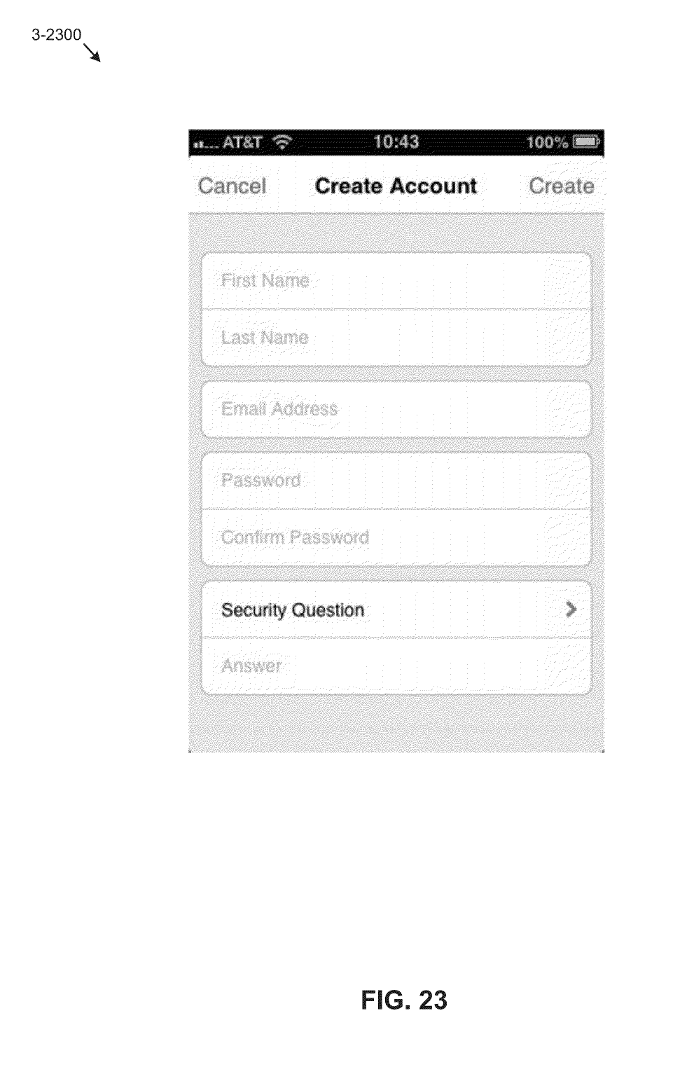

FIG. 23 depicts a display terminal account creation user interface 3-2300 as used in the installation and configuration of connected devices, in one embodiment. As an option, one or more instances of display terminal account creation user interface 3-2300 or any aspect thereof may be implemented in the context of the architecture and functionality of the embodiments described herein. Also, the display terminal account creation user interface 3-2300 or any aspect thereof may be implemented in any desired environment.

In one embodiment, for example, display terminal account creation user interface 3-2300 may be one screen of an iPhone app that may allow a user, developer, etc. to connect to one or more devices, platforms, etc. One embodiment, for example, may provide an interface, etc. to create an account using personal details and/or any other information, etc. One embodiment, for example, may provide an interface, etc. to create one or more accounts that allow, permit, control, etc, access to one or more services between the user and various devices, platforms, etc.

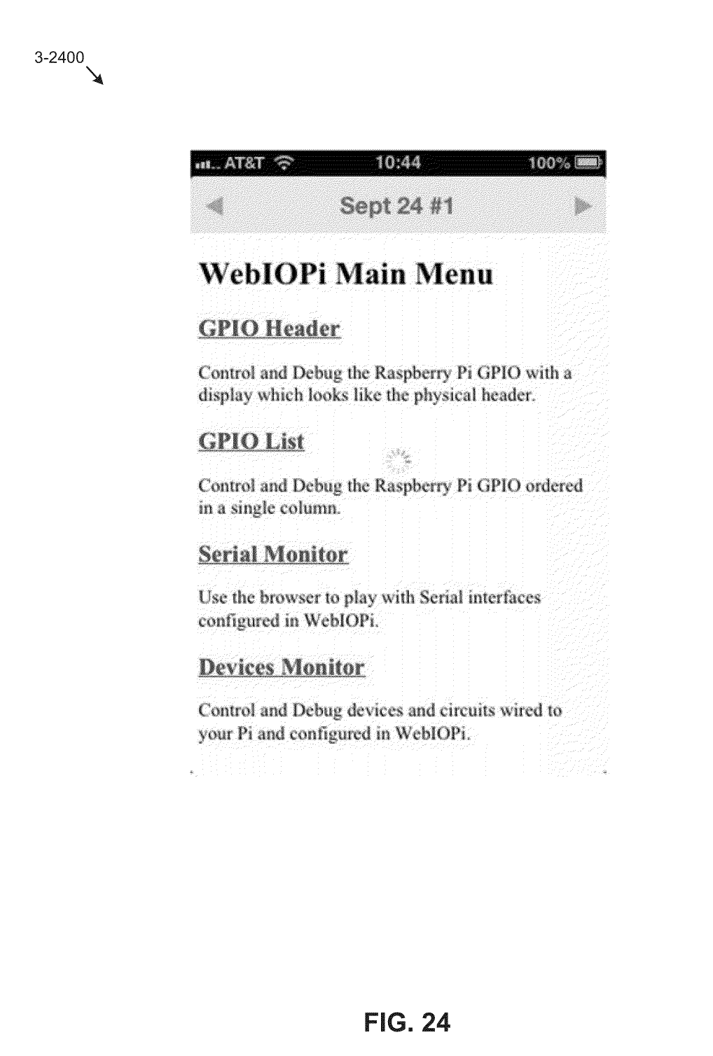

FIG. 24 depicts a display terminal browser-oriented user interface 3-2400 as used in the installation and configuration of connected devices, in one embodiment. As an option, one or more instances of display terminal browser-oriented user interface 3-2400 or any aspect thereof may be implemented in the context of the architecture and functionality of the embodiments described herein. Also, the display terminal browser-oriented user interface 3-2400 or any aspect thereof may be implemented in any desired environment.

In one embodiment, a display terminal browser-oriented user interface 3-2400 for example, may be one screen of an iPhone app that may allow a user, developer, etc. to connect to one or more devices, platforms, etc. One embodiment, for example, may provide an interface, etc. to remotely control a device, platform, etc. One embodiment, for example, may provide an interface, etc. to a program, software such as WebIOPi. WebIOpi is a publicly-available software package (developed and written by Eric Ptak) that normally allows control of a Raspberry Pi from a web interface running on the Raspberry Pi. Normally WebIOPi would be accessed, viewed, etc. locally using the Raspberry Pi. One embodiment, for example, may provide an interface, etc. to WebIOPi that allows a user, developer, etc. to use WebIOPi to control a Raspberry Pi remotely. For example, the screen shown may be displayed remotely on a user's iPhone.

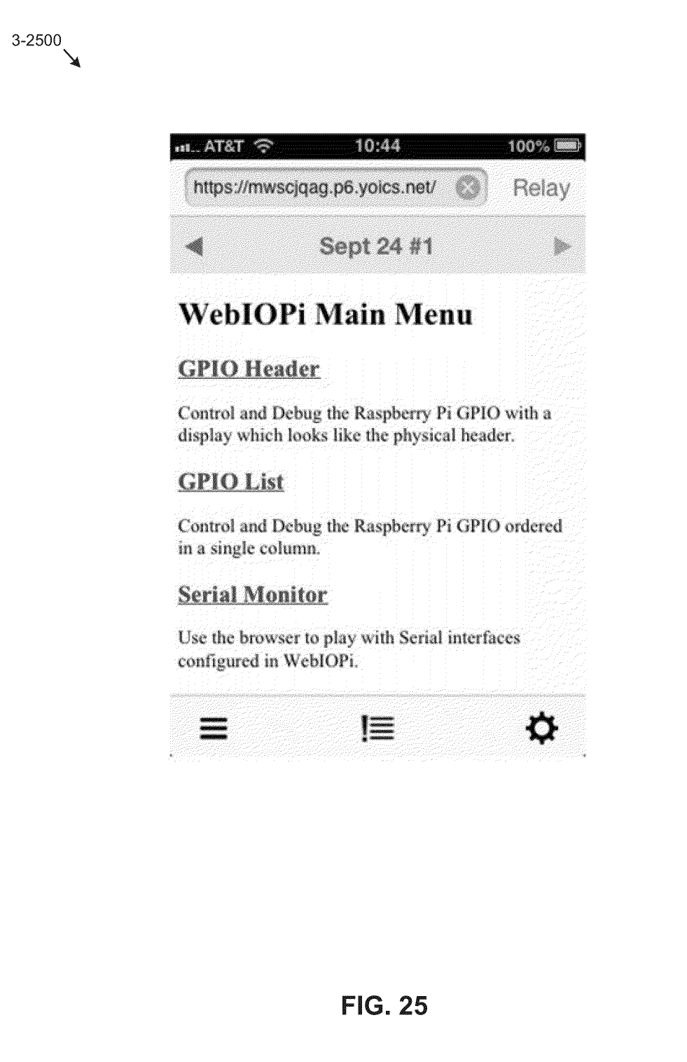

FIG. 25 depicts a display terminal device-specific browser rendering user interface 3-2500 as used in the installation and configuration of connected devices, in one embodiment. As an option, one or more instances of display terminal device-specific browser rendering user interface 3-2500 or any aspect thereof may be implemented in the context of the architecture and functionality of the embodiments described herein. Also, the display terminal device-specific browser rendering user interface 3-2500 or any aspect thereof may be implemented in any desired environment.

In one embodiment, for example, display terminal device-specific browser rendering user interface 3-2500 may be one screen of an iPhone app that may allow a user, developer, etc. to connect to one or more devices, platforms, etc. One embodiment, for example, may provide an interface, etc. that shows the connection mode. For example, the connection address to a remote Raspberry Pi may be https://mwscjqag.p6.yoics.net/ and the connection mode may be RELAY. In this case, for example, the connection between a user's iPhone and the Raspberry Pi device may be constructed using a relay server (at yoics.net). In this case, for example, the server address may be generated in a random or semi-random manner according to methods and techniques that may be described elsewhere herein and/or in one or more specifications incorporated by reference.

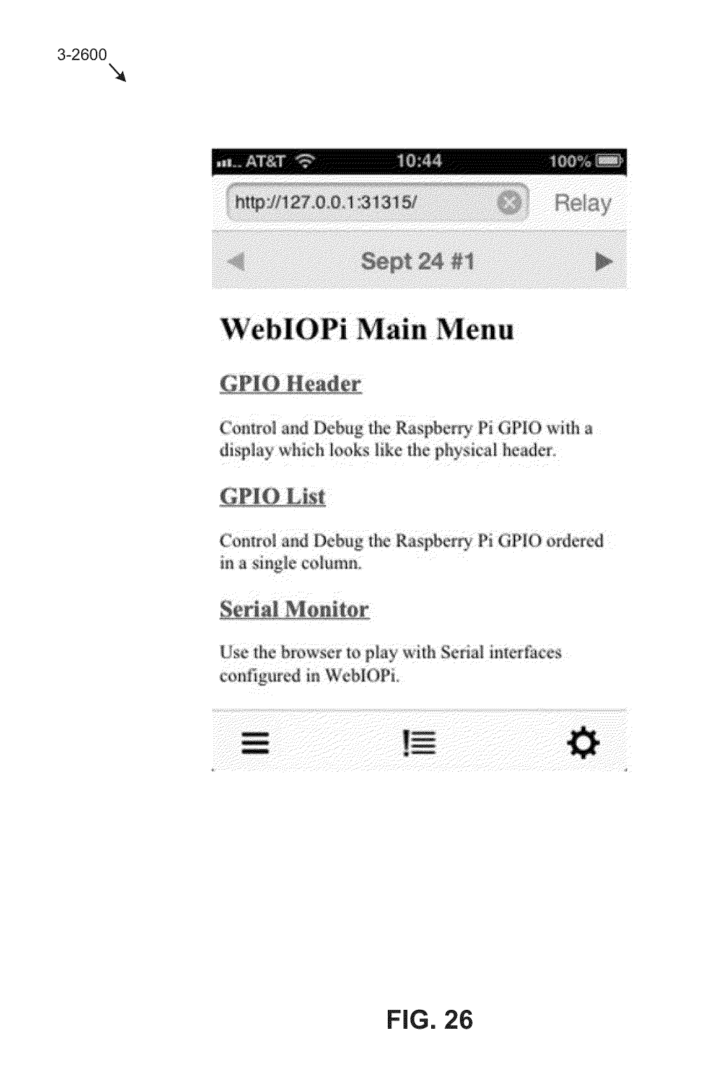

FIG. 26 depicts a display terminal port-addressable device-specific browser-oriented user interface 3-2600 as used in the installation and configuration of connected devices, in one embodiment. As an option, one or more instances of display terminal port-addressable device-specific browser-oriented user interface 3-2600 or any aspect thereof may be implemented in the context of the architecture and functionality of the embodiments described herein. Also, the display terminal port-addressable device-specific browser-oriented user interface 3-2600 or any aspect thereof may be implemented in any desired environment.

In one embodiment, for example, may be one screen of an iPhone app that may allow a user, developer, etc. to connect to one or more devices, platforms, etc. One embodiment, for example, may provide an interface, etc. that displays alternative information about the connection type, etc. For example, the address is shown as a localhost address 127.0.0.1 using port 31315. The use of localhost addresses to provide, for example, additional security between remote devices may be described elsewhere herein and/or in one ore more specifications incorporated by reference.

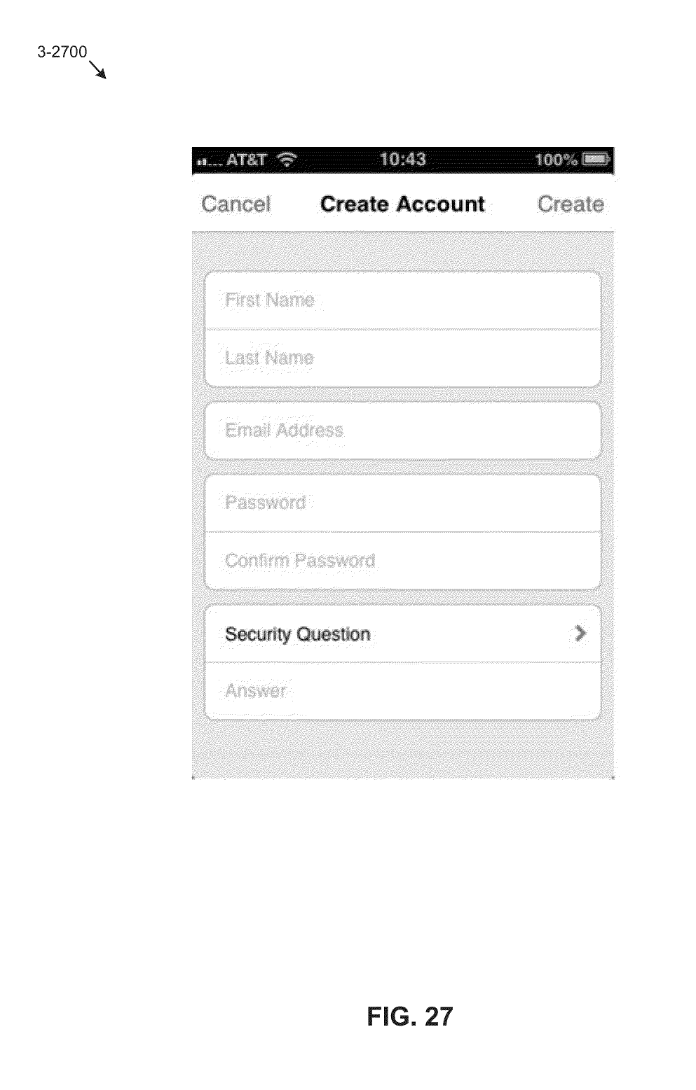

FIG. 27 depicts a display terminal account setup interview user interface 3-2700 as used in the installation and configuration of connected devices, in one embodiment. As an option, one or more instances of display terminal account setup interview user interface 3-2700 or any aspect thereof may be implemented in the context of the architecture and functionality of the embodiments described herein. Also, the display terminal account setup interview user interface 3-2700 or any aspect thereof may be implemented in any desired environment.

In one embodiment, for example, a display terminal account setup interview user interface 3-2700 may be one screen of an iPhone app that may allow a user, developer, etc. to connect to one or more devices, platforms, etc. One embodiment, for example, may provide an interface, etc. to create an account.

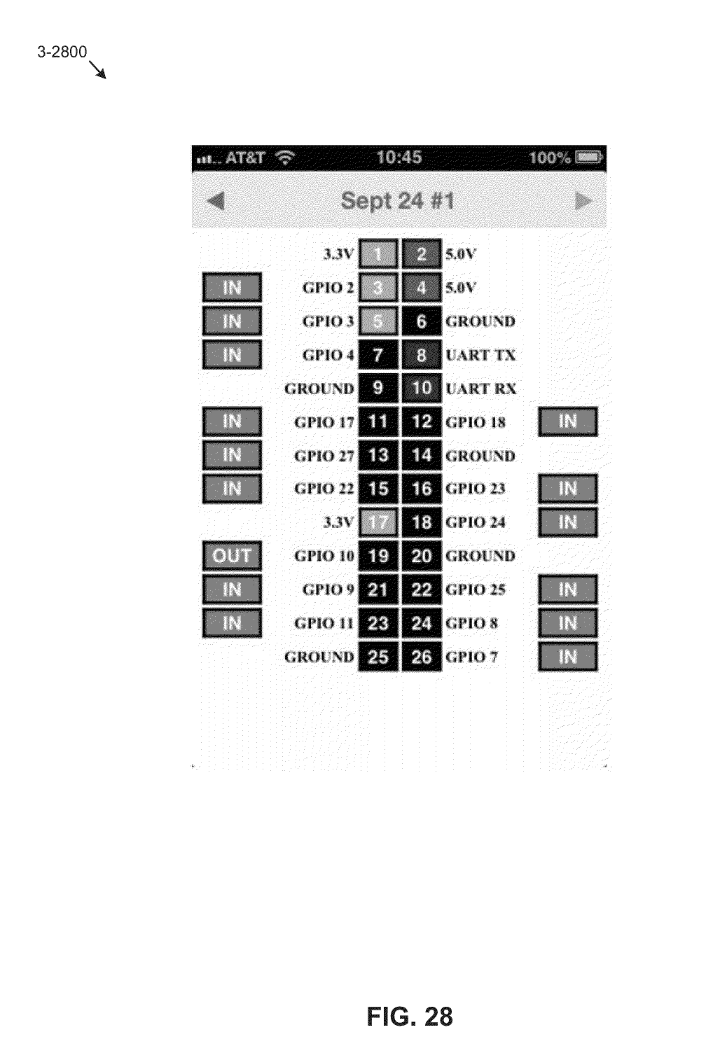

FIG. 28 depicts a display terminal device-specific signal configuration user interface 3-2800 as used in the installation and configuration of connected devices, in one embodiment. As an option, one or more instances of display terminal device-specific signal configuration user interface 3-2800 or any aspect thereof may be implemented in the context of the architecture and functionality of the embodiments described herein. Also, the display terminal device-specific signal configuration user interface 3-2800 or any aspect thereof may be implemented in any desired environment.

In one embodiment, for example, may be one screen of an iPhone app that may allow a user, developer, etc. to connect to one or more devices, platforms, etc. One embodiment, for example, may provide an interface, etc. to control a remote device. For example, the WebIOPi interface shown allows control of the Raspberry Pi GPIO functions. A similar screen may be displayed to allow control of any remote device functions. Such a screen would be created by a developer to allow a user to control household appliances, sprinkler systems and/or any device, platform, system, etc.

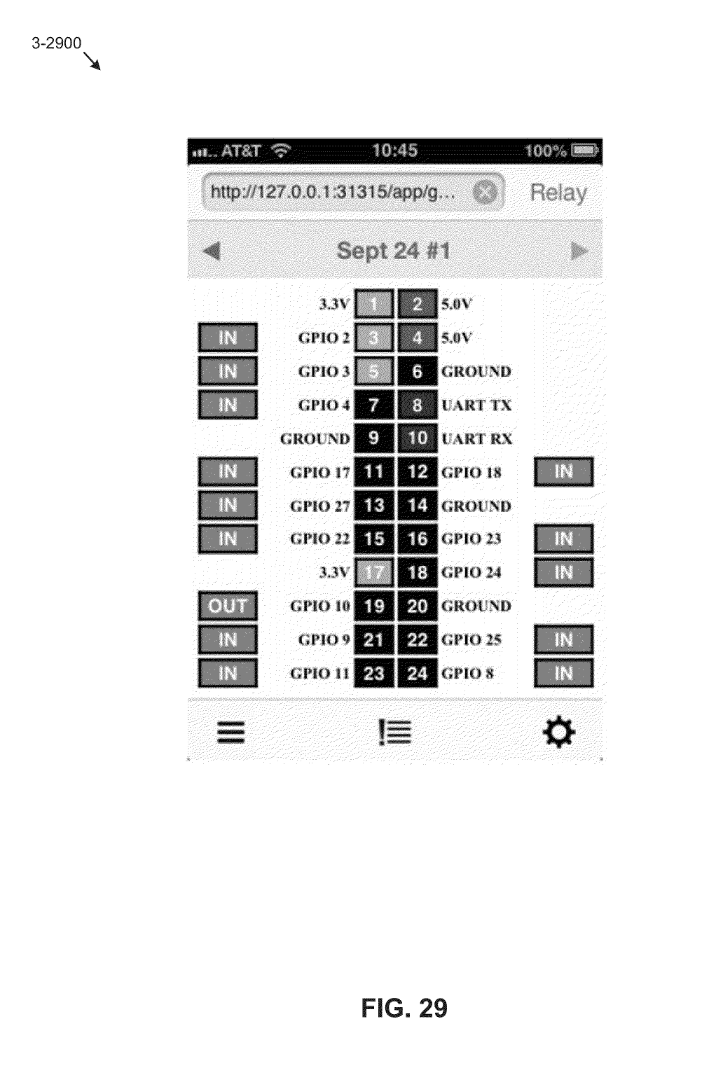

FIG. 29 depicts a display terminal instance-specific signal configuration user interface 3-2900 as used in the installation and configuration of connected devices, in one embodiment. As an option, one or more instances of display terminal instance-specific signal configuration user interface 3-2900 or any aspect thereof may be implemented in the context of the architecture and functionality of the embodiments described herein. Also, the display terminal instance-specific signal configuration user interface 3-2900 or any aspect thereof may be implemented in any desired environment.

In one embodiment, for example, a display terminal instance-specific signal configuration user interface 3-2900 may be one screen of an iPhone app that may allow a user, developer, etc. to connect to one or more devices, platforms, etc. One embodiment, for example, may provide an interface, etc. to view the connection address and other details of the communication links, etc. between user device (e.g., mobile phone, etc.) and remote device (e.g., Raspberry Pi, etc.).

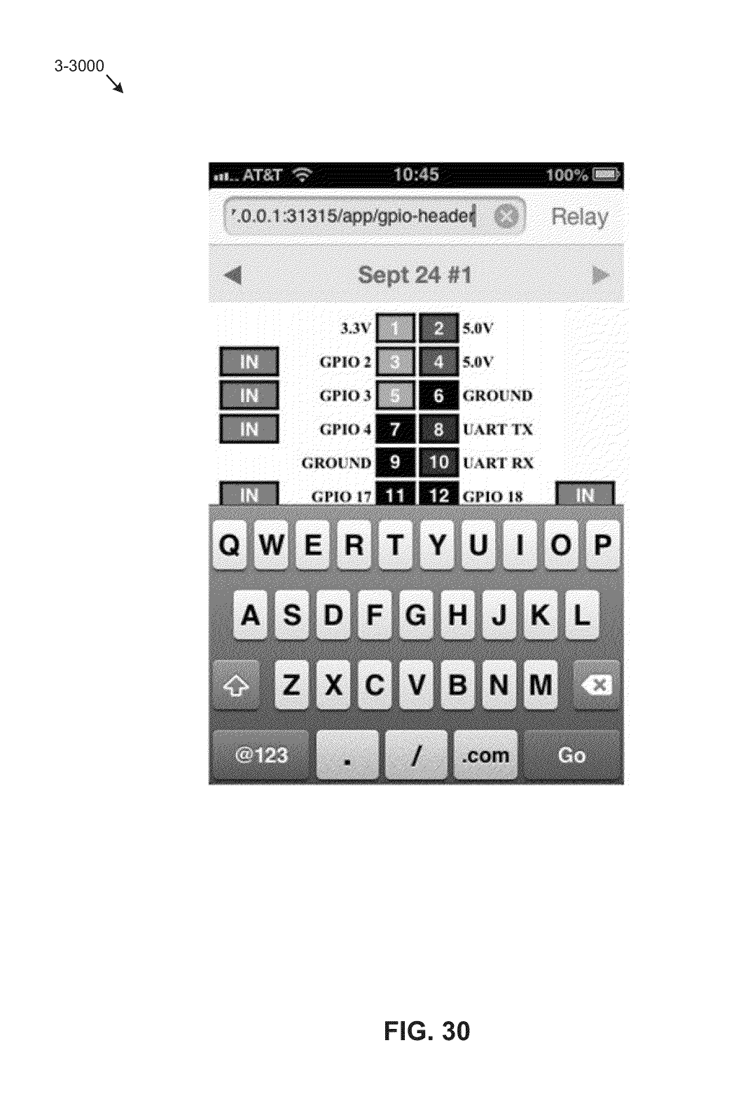

FIG. 30 depicts a display terminal signal configuration editor interface 3-3000 as used in the installation and configuration of connected devices, in one embodiment. As an option, one or more instances of display terminal signal configuration editor interface 3-3000 or any aspect thereof may be implemented in the context of the architecture and functionality of the embodiments described herein. Also, the display terminal signal configuration editor interface 3-3000 or any aspect thereof may be implemented in any desired environment.

In one embodiment, for example, a display terminal signal configuration editor interface 3-3000 may be one screen of an iPhone app that may allow a user, developer, etc. to connect to one or more devices, platforms, etc. One embodiment, for example, may provide an interface, etc. to allow the user, developer, etc. to change address details, etc. in an embedded browser interface. One embodiment, for example, may show an interface, etc. that is provided by an embedded Safari browser running on an iPhone, iPad, etc.

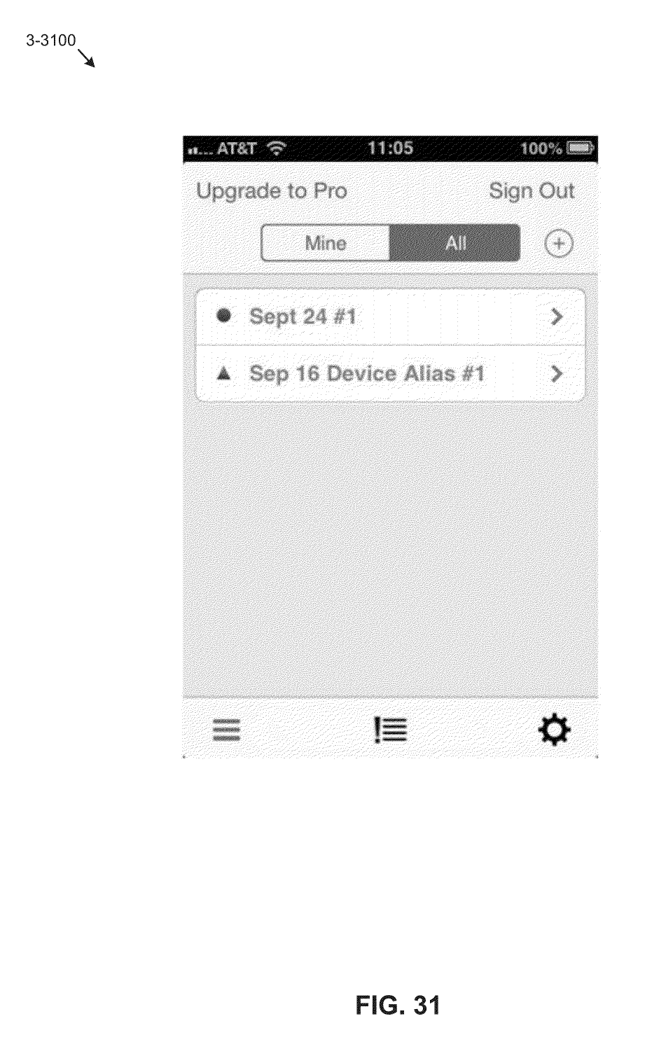

FIG. 31 depicts a display terminal device enumeration user interface 3-3100 as used in the installation and configuration of connected devices, in one embodiment. As an option, one or more instances of display terminal device enumeration user interface 3-3100 or any aspect thereof may be implemented in the context of the architecture and functionality of the embodiments described herein. Also, the display terminal device enumeration user interface 3-3100 or any aspect thereof may be implemented in any desired environment.

In one embodiment, for example, display terminal device enumeration user interface 3-3100 may be one screen of an iPhone app that may allow a user, developer, etc. to connect to one or more devices, platforms, etc. One embodiment, for example, may provide an interface, etc. that may show which devices are online, available, turned on, etc. (e.g., using a circle next to their names) and which devices are not online etc. (e.g., with a triangle next to their names). Of course any symbol, indication, notation, etc. may be used and any status, information, state, etc. may be displayed. Of course any naming, icon, symbols, etc. may be used to represent a device, groups of devices, etc.

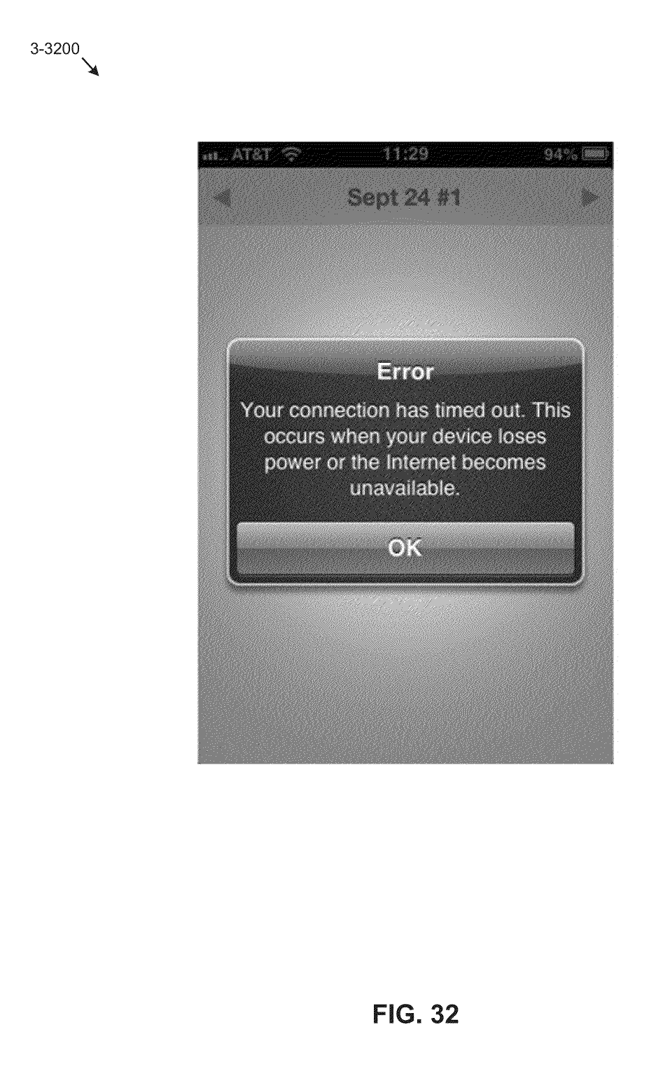

FIG. 32 depicts a display terminal device timeout status user interface 3-3200 as used in the installation and configuration of connected devices, in one embodiment. As an option, one or more instances of display terminal device timeout status user interface 3-3200 or any aspect thereof may be implemented in the context of the architecture and functionality of the embodiments described herein. Also, the display terminal device timeout status user interface 3-3200 or any aspect thereof may be implemented in any desired environment.

In one embodiment, for example, display terminal device timeout status user interface 3-3200 may be one screen of an iPhone app that may allow a user, developer, etc. to connect to one or more devices, platforms, etc. One embodiment, for example, may show an interface, etc. that conveys information, status, errors, notices, notifications and/or any other data, etc. to the user, developer, etc. One embodiment, for example, may provide an interface, etc. that shows how, why, when, etc., a connection, communication link, network, etc. has failed, dropped, etc.

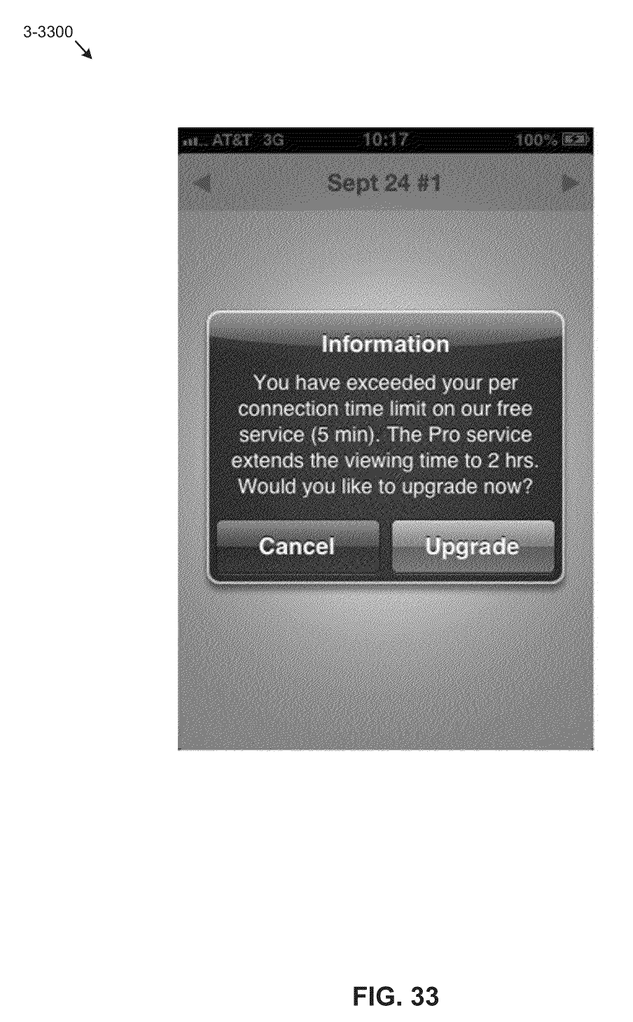

FIG. 33 depicts a display terminal device limit status user interface 3-3300 as used in the installation and configuration of connected devices, in one embodiment. As an option, one or more instances of display terminal device limit status user interface 3-3300 or any aspect thereof may be implemented in the context of the architecture and functionality of the embodiments described herein. Also, the display terminal device limit status user interface 3-3300 or any aspect thereof may be implemented in any desired environment.

In one embodiment, for example, display terminal device limit status user interface 3-3300 may be one screen of an iPhone app that may allow a user, developer, etc. to connect to one or more devices, platforms, etc. One embodiment, for example, may provide an interface, etc. that allows the OEM, service provider, etc. to regulate, monitor, control, upgrade, downgrade, upsell, and/or otherwise interact, service, etc. a user, developer, etc. One embodiment, for example, may provide an interface, etc. to control communication time and offer the ability to extend session times, etc.

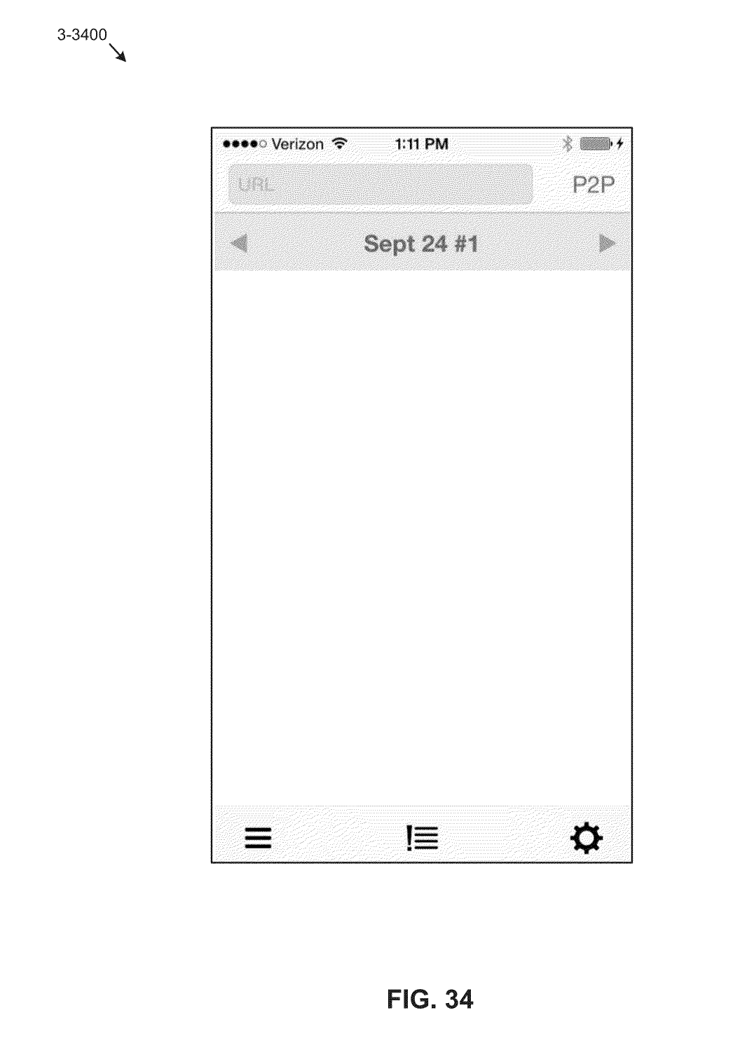

FIG. 34 depicts a display terminal peer-to-peer status user interface 3-3400 as used in the installation and configuration of connected devices, in one embodiment. As an option, one or more instances of display terminal peer-to-peer status user interface 3-3400 or any aspect thereof may be implemented in the context of the architecture and functionality of the embodiments described herein. Also, the display terminal peer-to-peer status user interface 3-3400 or any aspect thereof may be implemented in any desired environment.

In one embodiment, for example, display terminal peer-to-peer status user interface 3-3400 may be one screen of an iPhone app that may allow a user, developer, etc. to connect to one or more devices, platforms, etc. One embodiment, for example, may provide an interface, etc. to show that communication links, connections, etc. are operating a direct mode, peer-to-peer (P2P) mode, etc. Of course any connection mode, type, form, sequence, flow, etc, may be displayed.

While a representative selection of screen captures, etc. have been presented herein, of course any number, type, form, layout, representation, etc. of screens (and/or equivalent interfaces, etc.) may be used for both the portal (e.g., website(s) for developers, account registration, user setup, etc.) as well as any user app (e.g., for remote device access running for example on a mobile device such as an iPhone or Android device, etc.). Of course such techniques as described are intended to be widely applicable allowing a user, developer, etc. to access any number, type, form, etc. of system, device, IoT device(s), etc. from any other device(s) including mobile (phone, tablet, laptop, etc.) and/or fixed device (desktop, server, etc.).

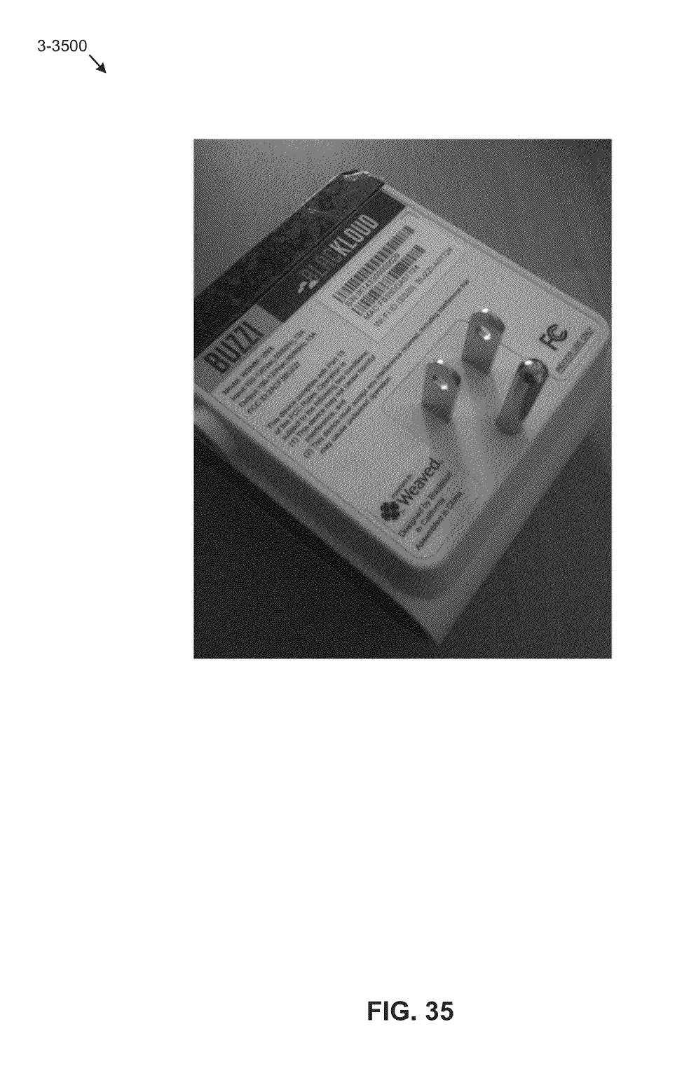

FIG. 35 presents an image of a connected device 3-3500 as used in the installation and configuration of connected devices, in one embodiment. As an option, one or more instances of connected device 3-3500 or any aspect thereof may be implemented in the context of the architecture and functionality of the embodiments described herein. Also, the connected device 3-3500 or any aspect thereof may be implemented in any desired environment.

One embodiment, for example, connected device 3-3500 may be a smart plug. A smart plug may be a type of IoT device that may be controlled remotely. For example the smart plug may allow a household appliance to be remotely controlled by switching power to that appliance on or off remotely. The software that is required to allow such remote control may be generated by a developer using the techniques described herein and/or in one or more specifications incorporated by reference. For example, some of this generated software may be incorporated into the smart plug platform (e.g., executed by a microprocessor, etc. included in the smart plug). The software that is required to perform such remote control may be also generated by a developer using the techniques described herein and/or in one or more specifications incorporated by reference and/or using similar techniques, etc. The software that performs such remote control may have the appearance and use the techniques, content, controls, displays, etc. that may be described herein and/or in one or more specifications incorporated by reference.

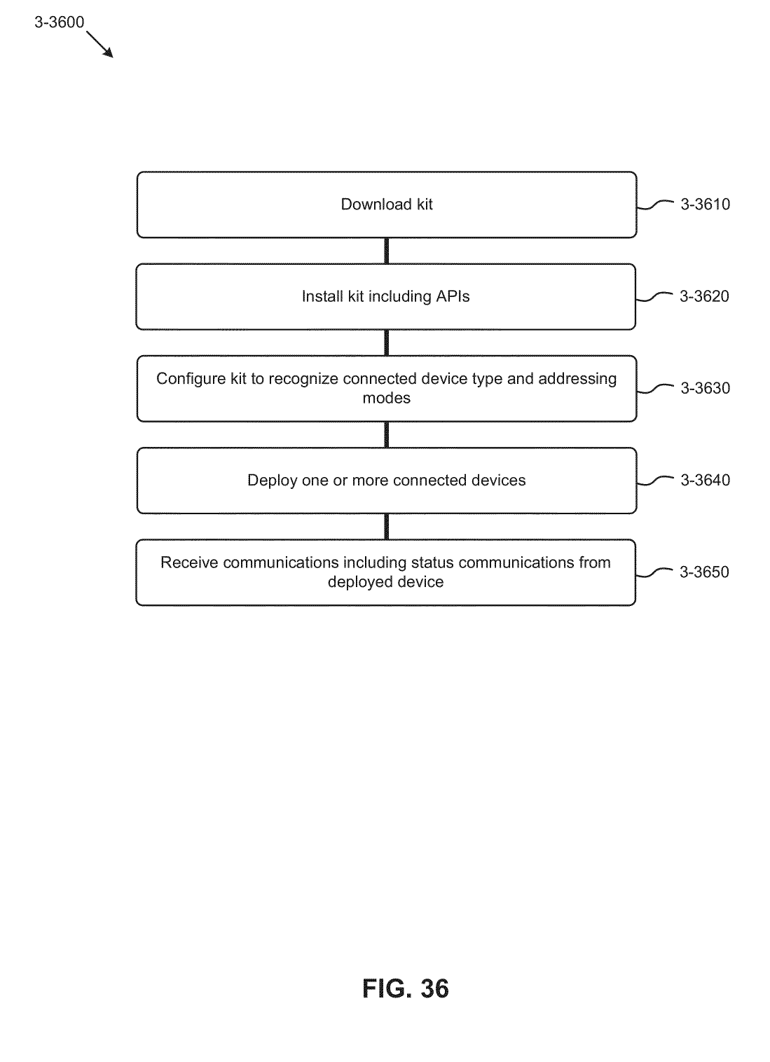

FIG. 36 depicts a process flow 3-3600 from initial download through status check performed after installation and configuration of connected devices, in one embodiment. As an option, one or more instances of process flow 3-3600 or any aspect thereof may be implemented in the context of the architecture and functionality of the embodiments described herein. Also, the process flow 3-3600 or any aspect thereof may be implemented in any desired environment.

The shown flow begins upon taking steps to download a kit (see 3-3610), then installing the kit including APIs (see 3-3620), configuring the kit to recognize connected device type(s) and addressing modes (see 3-3630), deploying one or more connected devices (see 3-3640), and commencing to receive communications including status communications from deployed device (see 3-3650). Any of the heretofore presented installation and configuration techniques can be used, and any of the herein-disclosed application programming interfaces (APIs) can be used.

Certain aspects in some embodiments of the present application are related to material disclosed in U.S. patent application Ser. No. 14/493,278, titled “MULTI-SERVER FRACTIONAL SUBDOMAIN DNS PROTOCOL” (Attorney Docket No. WEAV-P0001-10-US) filed on Sep. 22, 2014, the content of which is incorporated by reference in its entirety in this application.

Certain aspects in some embodiments of the present application are related to material disclosed in U.S. patent application Ser. No. 14/499,362, titled “DIRECT MAP PROXY SYSTEM AND PROTOCOL” (Attorney Docket No. WEAV-P0002-10-US) filed on Sep. 29, 2014, the content of which is incorporated by reference in its entirety in this Application.

### Additional Embodiments of the Disclosure

### Additional Practical Application Examples

Any of the foregoing can be used in conjunction with various application programming interfaces. Example APIs and aspects of their usage are given below in Table 1 and Table 2.

TABLE 1
Service API

| Ref | Weaved and Yoics Service API Reference |
|---|---|
| | NOTES: |
| | * Service API calls. |
| | ** API calls for the Application Developer. |
| | *** Other APIs. |
| | Usernames have been replaced with another |
| | Keys have been truncated with trailing ... |
| | 1. *New User - Service Registration |
| | The client registers a new user with the Yoics service. New users are easily added |
| | by sending the user's email, password and security challenge response to the Yoics |
| | service. In response, the service sends successful status or an error with a reason |
| | description to provide feedback to the user. |
| | To register a new user with weaved service following API must be used - defined |
| | in YoicsLib.m |
| | URL: |
| | http://www.yoics.net/web/api/user.ashx?key=<key>&email=<email>&pwd=<password> |
| | &que=<question>&ans=<answer>&first=<firstname>&last=<lastname>&country= |
| | <country>&apilevel=<apilevel>&action=register |
| | −(void)registerUserWithEmail:(NSString *)email |
| | password:(NSString *)pwd |
| | question:(NSString *)question |
| | answer:(NSString *)answer |
| | firstName:(NSString *)firstName |
| | lastName:(NSString *)lastName |
| | success:(void (\hat{ })(NSDictionary* response))success |
| | failure:(void (\hat{ })(NSError *))failure; |
| | Example: |
| | [[YoicsLib sharedYoicsLib] registerUserWithEmail:[_username |
| | cStringUsingEncoding:NSASCIIStringEncoding] |
| | password:[_password cStringUsingEncoding:NSASCIIStringEncoding] |
| | question:[cStringUsingEncoding:NSASCIIStringEncoding] |
| | answer:[cStringUsingEncoding:NSASCIIStringEncoding] |
| | firstName:[cStringUsingEncoding:NSASCIIStringEncoding] |
| | lastName:[cStringUsingEncoding:NSASCIIStringEncoding] |
| | success:\hat{ }(NSDictionary* response){ |
| | <some-success-handler-code> |
| | } |
| | failure:\hat{ }(NSError * failure) |
| | { |
| | <some-failure-handler-code> |
| | }]; |
| | Parameter(s): |
| | Yoics User Account (email) - Hexascii String value - represents the users |
| | Yoics account id or email. |
| | Yoics User Password (pwd) - Hexascii String value - represents the users |
| | Yoics account password. |
| | Users First Name (first) -Hexascii String value - represents the users first |
| | name. |
| | Users Last Name (last) - Hexascii String value - represents the users last |
| | name. |
| | Security Question (question) - Hexascii String value - represents the security |
| | question the user will be presented when recovering lost or forgotten passwords. |
| | Security Challenge (answer) - Hexascii String value - represents the security |
| | answer the user must supply when recovering lost or forgotten |
| | passwords. |
| | Return Value(s): |
| | Response - String value - shows text status for failures or shows detailed |
| | information in XML format. |
| | “InvalidToken”, 0701, “[0701] The Yoics API token is invalid or expired” |
| | “InvalidRequest”, 0702, “[0702] Error:DuplicateEmail:” |
| | “InvalidRequest”, 0703, “[0703] Error:IllegalEmail:<email>” |
| | “InvalidRequest”, 0704, “[0704] Error:CreateUserException:<message>” |
| | “InvalidRequest”, 0705, “[0705] Error:HttpException:<message>” |
| | “InvalidRequest”, 0706, “[0706] Error:<status>” |
| | “InvalidRequest”, 0707, “[0707]: email notification failed <message>” |
| | “InvalidRequest”, 0708, “[0708]: user profile missing” |
| | “InvalidRequest”, 0709, “[0709]: User profiled issue:<message>” |
| | “UnexpectedError”, 0799, “[0799] <text describing the system error>” |
| | Sample XML response: |
| | <NewDataSet> |
| | <Table> |
| | <status>ok</status> |
| | <authhash>Users authentication hash for future login calls</authhash> |
| | </Table> |
| | </NewDataSet> |
| | Sample JSON response: |
| | { “NewDataSet”: { “Table”: [ {“status”: “ok”,”authhash”:”hash value” } ] }} |
| | <NewDataSet> |
| | <Table> |
| | <error>errorcode</error> |
| | <message>error message text</message> |
| | </Table> |
| | </NewDataSet> |
| | 2. *User Login |
| | Before Invoking any API user must login into his account with username & |
| | password/authash. |
| | Defined in YoicsLib.m |
| | URL: |
| | https://www.yoics.net/web/api/login.ashx?key=<key>&usr=<userid>&pwd=<password> |
| | &auth=<authhash>&apilevel=<level>&type=<type> |
| | (i)- With Pwd: |
| | −(void)logInWithUser:(NSString*)user andPwd:(NSString*)pwd |
| | success:(void (\hat{ })(NSDictionary* response))success |
| | failure:(void (\hat{ })(NSError *error))failure |
| | p2pLoginSuccess:(void (\hat{ })(void))p2pSuccess |
| | p2pLoginFailure:(void (\hat{ }) void))p2pFailure; |
| | (ii)- With authash: |
| | − (void)logInWithUser:(NSString*)user andAuthHash:(NSString*)authash |
| | success:(void (\hat{ })(NSDictionary* response))success |
| | failure:(void (\hat{ })(NSError *error))failure |
| | p2pLoginSuccess:(void (\hat{ })(void))p2pSuccess |
| | p2pLoginFailure:(void (\hat{ })(void))p2pFailure; |
| | Example: |
| | [[YoicsLib sharedYoicsLib] log InWithUser:user andPwd:pwd |
| | success:\hat{ }(NSDictionary* response) |
| | { |
| | <some-success-handler-code> |
| | } |
| | failure:\hat{ }(NSError * failure) |
| | { |
| | <some-failure-handler-code> |
| | }]; |
| | The client must login to the Yoics Web API before any other messages can be |
| | invoked. The client passes in the users Yoics account ID and their password. In return, |
| | the client will get a LoginToken which is later used on other API messages to provide |
| | authentication information. |
| | NOTE: The LoginToken is only valid for an unspecified amount of time. The token |
| | can be used on other API messages until the InvalidToken error code is received. Once |
| | received, the Login Message must be invoked again to get a new LoginToken. |
| | Return Value(s): |
| | User Information as follows |
| | <NewDataSet> |
| | <Table> |
| | <userid>the name of the user logging in</userid> |
| | <email>the email address of the user logging in </email> |
| | <level>users Yoics service level (BASIC, PRO, etc)</level> |
| | <maxviewer>max number of concurrent camera viewers allowed</maxviewer> |
| | <view2×2state>if 2×2 matrix view is enable or disabled</view2×2state> |
| | <view4×4state>disabled</view4×4state> |
| | <token>security token used when calling other APIs</token> |
| | <maxstart>max number of connections to auto start</maxstart> |
| | <expires>users Yoics service level expiration date \| ‘never’</expires> |
| | <maxsharing>Max Yoics users per shared device</maxsharing> |
| | <authhash>Users authentication hash for future login calls</authhash> |
| | NOTE: The following attributes are optional based on API level. |
| | <apikey>StemConnectApplication</apikey> |
| | <name>Stem Innovation Inc</name> |
| | <deviceTypeList>19</deviceTypeList> |
| | <manufacturerID>12</manufacturerID> |
| | <expires>2099-12-31T12:00:00-05:00</expires> |
| | <featuresetid>STEMBASIC</featuresetid> |
| | <upgradedsetid>STEMPRO</upgradedsetid> |
| | <features>ads=0,share=0,concurrent=1,webduration=300,webdaily=500, |
| | p2pduration=300,p2pdaily=500,guest=0</features> |
| | <featurecached>true</featurecached><keycached>true</keycached> |
| | </Table> |
| | </NewDataSet> |
| | If an error occurs, the response will be as follow: |
| | <NewDataSet> |
| | <Table> |
| | <error>errorcode</error> |
| | <errorID>errorID</errorID> |
| | <message>[ errorID ] error message text</message> |
| | </Table> |
| | </NewDataSet> |
| | Possible error codes, IDs & messages include |
| | “InvalidUser”, 0101, “[0101] Failed to get user information or user does not exist” |
| | “InvalidCredentials”, 0102, “[0102] The username or password are invalid” |
| | “UnexpectedError”, 0199, “[0199] <text describing the system error>” |
| | “InvalidKey”, 0103, “[0103] The API application key is invalid” |
| | “LoginRedirect””, 0104, “[0104] <see below for full description>” |
| | When LoginRedirect is returned, the message field contains a new base URL to |
| | attempt login. The redirect allows Yoics to load balance the API access requests to the |
| | Yoics API. The message field will look like |
| | “<message>www2.yoics.net/web/api/</message>”. |
| | Sample XML response: |
| | <NewDataSet> |
| | <Table> |
| | <userid>another</userid> |
| | <email>another@gmail.com</email> |
| | <level>BASIC</level> |
| | <maxviewer>1</maxviewer> |
| | <view2×2state>disabled</view2×2state> |
| | <view4×4state>disabled </view4×4state> |
| | <token>EBE...</token> |
| | <maxstart>1</maxstart> |
| | <maxviewer>1</maxviewer> |
| | </Table> |
| | </NewDataSet> |
| | Sample JSON response: |
| | { “NewDataSet”: { “Table”: [ {“email”: “another@gmail.com”, “level”: “BASIC”, |
| | “maxstart”: “1”, “maxviewer”: [ “1”, “1” ], “token”:“EBE... |
| | ”, “userid”: “another”, “view2×2state”: “disabled”, “view4×4state”: “disabled” } |
| | ] }} |
| | 3. *User Logout |
| | Method call to logout from an account. Defined in YoicsLib.m |
| | URL: http://www.yoics.net/web/api/logout.ashx?token=<token>&type=<type> |
| | − (void)logoutWithSuccess:(void (\hat{ })(void))success failure:(void (\hat{ })(NSError |
| | *error))failure |
| | Example: [[YoicsLib sharedYoicsLib] logoutWithSuccess: <arguments as |
| | sspecified in declaration>]; |
| | Return Value(s): |
| | Status as follows |
| | <NewDataSet> |
| | <Table> |
| | <status>ok status when completed</status> |
| | </Table> |
| | </NewDataSet> |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | Possible error codes & messages include ... |
| | “InvalidToken”, 0201, “[0201] The Yoics API token is invalid or expired” |
| | “UnexpectedError”, 0299, “[0299] <text describing the system error>” |
| | Sample XML Response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | 4. *Connect to a device with Token |
| | The client can request web or mobile connections to devices for viewing |
| | purposes. Device connections are made by the Yoics Proxy servers on behalf of the |
| | user and then made available using secured URLs. The client requests the connection |
| | and then waits for the provisioning to occur, at which time the URL is returned. The API |
| | also provides methods to check a connection status or stop an existing connection. |
| | To Connect to a remote device (e.g., running weavedConnectd) from an |
| | Application (Client Device), with a Token, use this API. Defined in |
| | ServerCallYoicsAPI.m. |
| | URL: |
| | http://www.yoics.net/web/api/connect.ashx?token=<token>&deviceaddress= |
| | <deviceaddress>>&type=<type> |
| | + (void)deviceConnectionWithToken:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ServerCallYoicsAPI deviceConnectionWithToken:<arguments as |
| | specified in the declaration above>]; |
| | Return Value(s): |
| | Proxy Information - String value - shows text status for failures or shows |
| | detailed information in XML format. |
| | Possible error codes& messages include ... |
| | “InvalidToken”, 0401, “[0401] The Yoics API token is invalid or expired” |
| | “InvalidDevice”, 0402, “[0402] <deviceaddress> is an unknown device for |
| | <username>” |
| | “InvalidDevice”, 0403, “[0403] <deviceaddress> is not active |
| | “InvalidDevice”, 0404, “[0404] Viewer only valid for supported cameras |
| | “InvalidAccess”, 0405, “[0405] <deviceaddress> is not available for public |
| | access and is not shared with you. |
| | “ServiceError”, 0406, “[0406] Service limit reached for web connections. |
| | “InvalidRequest”, 0409, “[0409] Connection does not exist. |
| | “InvalidRequest”, 0410, “[0410] Priority connection block. |
| | “InvalidRequest”, 0411, “[0411] Guest pass failed verification. |
| | “UnexpectedError”, 0499, “[0499] <text describing the system error>” |
| | Sample XML response for connect: |
| | <NewDataSet> |
| | <Table> |
| | <deviceaddress>00:00:00:25:07:00:15:19</deviceaddress> |
| | <status>new \| assigned \| started \| running</status> |
| | <requested>2010-02-01T13:09:05.587-08:00</requested> |
| | <proxy>proxy1.yoics.net to proxy5.yoics.net</proxy> |
| | <url>https://sdgYeys.proxy5.yoics.net/<single-image-URL></url> |
| | <imageintervalms>milliseconds between image fetched</imageintervalms> |
| | <expirationsec>seconds until connection expires</expirationsec> |
| | <streamscheme>http \| rtsp</streamscheme> |
| | <streamuri>URI for stream (eg - video.cgi)</streamuri> |
| | Note: The following two attributes are optionally included when an existing |
| | connection is stopped inorder to start a new connection from a different |
| | location. |
| | <connectionOverridden>true \| false</connectionOverridden> |
| | <previousConnection>proxy URL</previousConnection> |
| | </Table> |
| | </NewDataSet> |
| | Sample XML response for status: |
| | <NewDataSet> |
| | <Table> |
| | <state>running</state> |
| | <ip>69.181.64.42</ip> |
| | <proxy>http://proxy6.yoics.net:39862</proxy> |
| | </Table> |
| | </NewDataSet> |
| | Sample XML response for stop: |
| | <NewDataSet> |
| | <Table> |
| | <status>ok</status> |
| | </Table> |
| | </NewDataSet> |
| | 5. ** Get the Connection Type in string format |
| | To check the type of connection established with the device(running |
| | weavedConnectd). Defined in YoicsDevice.m |
| | (NSString*)getStringConnectionType; |
| | Example: YoicsDevice dev = [[YoicsDevice alloc] init]; |
| | NSString *Connection = [dev getStringConnectionType]; |
| | Returns: NO CONNECTION / Local / Relay / P2P |
| | 6. ** Check if the user Owns the device |
| | Defined in YoicsDevice.m |
| | − (BOOL)isMine; |
| | Example: YoicsDevice dev = [[YoicsDevice alloc] init]; |
| | BOOL Owner = [dev isMine]; |
| | Returns:YES if device belongs to user NO if not. |
| | 7. *To get security question Via an e-mail |
| | The application may need to verify the user account when no password is |
| | available. For example, the user needs to recover their password. The client can get the |
| | users security challenge question for use in other APIs. In response, the service sends |
| | successful status or an error with a reason description to provide feedback to the user. |
| | Defined in YoicsLib.m |
| | URL: |
| | http://www.yoics.net/web/api/user.ashx?key=<key>&email=<email>>&apilevel=<apilevel> |
| | &action=getsecurityquestion |
| | + (void)getSecurityQuestionWithEmail:(NSString*)email |
| | success:(void (\hat{ })(NSDictionary *response))success |
| | failure:(void (\hat{ })(NSError *error))failure |
| | Example: |
| | [[YoicsLib sharedYoicsLib] getSecurityQuestionWithEmail:_txtEmail.text |
| | success:\hat{ }(NSDictionary *response) { |
| | <some-code-for-success> |
| | } |
| | failure:\hat{ }(NSError *error) { |
| | <some-code-for-failure> |
| | }]; |
| | Return Value(s): |
| | Response - String value - shows text status for failures or shows detailed |
| | information in XML format. |
| | Possible error codes& messages include ... |
| | “SecurityQuestionFailed”, 0741, “[0741] Unknown email address” |
| | “SecurityQuestionFailed”, 0742, “[0742] API key is required” |
| | “SecurityQuestionFailed”, 0743, “[0743] <text describing the system error>” |
| | “UnexpectedError”, 0799, “[0799] <text describing the system error>” |
| | Sample XML response: |
| | <NewDataSet> |
| | <Table> |
| | <passwordquestion>Place of Birth</passwordquestion> |
| | </Table> |
| | </NewDataSet> |
| | Sample JSON response: |
| | { “NewDataSet”: { “Table”: [ {“passwordquestion”: “Place of Birth” } ] }} |
| | <NewDataSet> |
| | <Table> |
| | <error>errorcode</error> |
| | <message>error message text</message> |
| | </Table> |
| | </NewDataSet> |
| | 8. *Password Recovery via an email |
| | The user may need to recover their password. This API requires the user to |
| | verify their account by answering the security challenge they provided on account |
| | registration. In response, the service sends successful status or an error with a reason |
| | description to provide feedback to the user. For this API, the user will receive an email |
| | with the new password. The API does not allow the password to be returned outside of |
| | the email delivery method. Defined in YoicsLib.m |
| | URL: |
| | http://www.yoics.net/web/api/user.ashx?key=<key>&email=<email>&answer=<answer> |
| | >&apilevel=<apilevel>&action=recoverpassword |
| | + (void)passwordRecoveryWithEmail:(NSString*)email |
| | answer:(NSString*)answer |
| | success:(void (\hat{ })(NSDictionary *response))success |
| | failure:(void (\hat{ })(NSError *error))failure |
| | Example: |
| | [[YoicsLib sharedYoicsLib] passwordRecoveryWithEmail:_txtEmail.text |
| | answer:[_txtAnswer.text lowercaseString] |
| | success:\hat{ }(NSDictionary *response) { |
| | <some-code-for-success> |
| | } |
| | failure:\hat{ }(NSError *error) { |
| | <some-code-for-failure> |
| | }]; |
| | Parameters: |
| | Registered Email (email) - Hexascii String value - represents the users |
| | registered email address |
| | Security Answer (answer) - Hexascii String value - represents the answer to |
| | the registered security question. |
| | Return Value(s): |
| | Response - String value - shows text status for failures or shows detailed |
| | information in XML format. |
| | Email - user will receive an email with further instructions on their new |
| | password. |
| | Possible error codes& messages include ... |
| | “PasswordFailed”, 0732, “[0732] Unknown email address” |
| | “PasswordFailed”, 0733, “[0733] API key is required” |
| | “PasswordFailed”, 0734, “[0734] text describing the system error>” |
| | “UnexpectedError”, 0799, “[0799] <text describing the system error>” |
| | Sample XML response: |
| | <NewDataSet> |
| | <Table> |
| | <status>ok</status> |
| | <password>new passwor here</password> {Optional based on skipemail} |
| | </NewDataSet> |
| | P11 Sample JSON response: |
| | { “NewDataSet”: { “Table”: [ {“passwordquestion”: “Place of Birth” } ] }} |
| | <NewDataSet> |
| | <Table> |
| | <error>errorcode</error> |
| | <message>error message text</message> |
| | </Table> |
| | </NewDataSet> |
| | 9. *Get Friends Device List |
| | The client will need device information to properly share or view devices. The |
| | Get Devices message provides methods to get user owner devices, friend's devices, |
| | and devices of specific types (such as cameras). |
| | To get list of friend's devices shared with current user this API must be used. |
| | Described in YoicsLib.m |
| | URL: |
| | http://test.yoics.net/web/api/getdevices.ashx?token=<token>&filter=<filter>&whose= |
| | <whose>&state=<state>&type=<type> |
| | − (void)getFriendsDevicesUsingBlockWithFilter:(NSString*)filter |
| | success:(void (\hat{ })(NSMutableArray *response))success |
| | failure:(void (\hat{ })(NSError *error))failure; |
| | Example: |
| | [[YoicsLib sharedYoicsLib] getFriendsDevicesUsingBlockWithFilter:@“all” |
| | success:\hat{ }(NSMutableArray *response) { |
| | <some-code-for-success> |
| | } |
| | failure:\hat{ }(NSError *error) { |
| | <some-code-for-failure> |
| | }]; |
| | Return Value(s): |
| | TBD |
| | 10. *Get My Device List |
| | To get the list of devices owned by a user this API must be used. Defined in |
| | YoicsLib.m |
| | URL: |
| | http://test.yoics.net/web/api/getdevices.ashx?token=<token>&filter=<filter>&whose= |
| | <whose>&state=<state>&type=<type> |
| | − (void)getMyDevicesUsingBlockWithFilter:(NSString*)filter |
| | success:(void (\hat{ })(NSMutableArray *response))success |
| | failure:(void (\hat{ })(NSError *error))failure; |
| | Example: Lists all the devices owned/registered by the user |
| | [[YoicsLib sharedYoicsLib] getMyDevicesUsingBlockWithFilter:@“all” |
| | success:\hat{ }(NSMutableArray *response) { |
| | <some-code-for-success> |
| | } |
| | failure:\hat{ }(NSError *error) { |
| | <some-code-for-failure> |
| | }]; |
| | Return Value(s): |
| | Device Information - String value |
| | <NewDataSet> |
| | <Table> |
| | <owneruserid>internal user ID for the device owner</owneruserid> |
| | <ownerusername>device owner's username</ownerusername> |
| | <devicetype>encoded device info string - see notes below</devicetype> |
| | <deviceaddress>unique ID for the device</deviceaddress> |
| | <devicelastip>last secured public IP and port</devicelastip> |
| | <lastcontacted>timestamp - see notes below</lastcontacted> |
| | <devicealias>Astak Mole</devicealias> |
| | <devicestate>active</devicestate> |
| | <encryptionflag>3</encryptionflag> |
| | <serverencryption>1</serverencryption> |
| | <minimumencryption>1</minimumencryption> |
| | <isglobal>0</isglobal> |
| | <laststatechanged>2010-06-01T11:09:30.64-07:00</laststatechanged> |
| | <applicationid>2</applicationid> |
| | <Column1>Tunnel</Column1> |
| | <lastinternalip>192.168.1.92:2061</lastinternalip> |
| | <webenabled>1</webenabled> |
| | <mobileenabled>1</mobileenabled> |
| | <sslenabled>0</sslenabled> |
| | <sslproxy>0</sslproxy> |
| | <weburi /> |
| | <mobileuri /> |
| | <addreturnurl>0</addreturnurl> |
| | <servicetitle>Camera Viewer</servicetitle> |
| | <webviewerurl /> |
| | <accesslevel>change</accesslevel> |
| | <CreateDate>2010-02-01T13:09:05.587-08:00</CreateDate> |
| | <manufacturer>Astak</manufacturer> |
| | </Table> |
| | </NewDataSet> |
| | NOTE: |
| | Encoded Device Info: Hexascii Encoded - Octet 0-1 is the Yoics service type. |
| | Octet 2-3 is the manufacturer code. Remaining octets are device specific. |
| | Timestamp - Formatted as 2010-06-01T11:09:30.64-07:00 |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | Possible error codes& messages include ... |
| | “InvalidToken”, 0301, “[0301] The Yoics API token is invalid or expired” |
| | “InvalidMessage”, 0302, “[0302] Invalid API message requested” |
| | “UnexpectedError”, 0399, “[0399] <text describing the system error>” |
| | Sample XML response: |
| | <NewDataSet> |
| | <Table> |
| | <owneruserid>E939F3C6-3B59-471F-8703-521DD58B7293</owneruserid> |
| | <ownerusername>doug</ownerusername> |
| | <devicetype>00:13:00:09:00:01:00:03:04:06:01:00</devicetype> |
| | <deviceaddress>00:00:00:25:07:00:15:19</deviceaddress> |
| | <devicelastip>76.215.57.198:2061</devicelastip> |
| | <lastcontacted>2010-06-01T11:09:30.64-07:00</lastcontacted> |
| | <devicealias>Astak Mole</devicealias> |
| | <devicestate>active</devicestate> |
| | <encryptionflag>3</encryptionflag> |
| | <serverencryption>1</serverencryption> |
| | <minimumencryption>1</minimumencryption> |
| | <isglobal>0</isglobal> |
| | <laststatechanged>2010-06-01T11:09:30.64-07:00</laststatechanged> |
| | <applicationid>2</applicationid> |
| | <Column1>Tunnel</Column1> |
| | <lastinternalip>192.168.1.92:2061</lastinternalip> |
| | <webenabled>1</webenabled> |
| | <mobileenabled>1</mobileenabled> |
| | <sslenabled>0</sslenabled> |
| | <sslproxy>0</sslproxy> |
| | <weburi /> |
| | <mobileuri /> |
| | <addreturnurl>0</addreturnurl> |
| | <servicetitle>Camera Viewer</servicetitle> |
| | <webviewerurl /> |
| | <accesslevel>change</accesslevel> |
| | <CreateDate>2010-02-01T13:09:05.587-08:00</CreateDate> |
| | <manufacturer>Astak</manufacturer> |
| | </Table> |
| | </NewDataSet> |
| | Sample JSON response: |
| | { “NewDataSet”: { “Table”: [ {“accesslevel”: “change”, “addreturnurl”: “0”, |
| | “applicationid”: “2”, “Column1”: “Tunnel”, “CreateDate”: “2010-10- |
| | 08T09:16:59.773-07:00”, “deviceaddress”: “00:FC:30:B1:E0:34:CD:08”, |
| | “devicealias”: “My Web Cam”, “devicelastip”: “76.215.57.198:2161”, |
| | “devicestate”: “active”, “devicetype”: “00:12:00:00:00:1B:00:6B:00:02”, |
| | “encryptionflag”: “3”, “isglobal”: “0”, “lastcontacted”: “2010-10- |
| | 18T13:32:31.54-07:00”, “lastinternalip”: “192.168.1.84:2161”, |
| | “laststatechanged”: “2010-10-18T13:32:31.54-07:00”, “manufacturer”: “Yoics |
| | Inc”, “minimumencryption”: “1”, “mobileenabled”: “1”, “mobileuri”: [ null ], |
| | “owneruserid”: “AAAAAAAA-BBBB-1111-AAAA-46FE31191A36”, “ownerusername”: |
| | “another”, “proxystate”: “none”, “serverencryption”: “1”, “servicetitle”: |
| | “Camera Folder”, “sslenabled”: “0”, “sslproxy”: “1”, “webenabled”: “1”, |
| | “weburi”: [ null ], “webviewerurl”: “192.168.1.84:8111” } ] }} |
| | 11. *Device Sharing |
| | The client will want to change sharing settings for specific devices. Users can |
| | share devices with Yoics and non-Yoics users either 1) using direct sharing with Yoics |
| | users 2) using Guest Passes from a Pro user to another non-Yoics user or 3) using |
| | email invitations to join Yoics and get access. Once shared, the sharing can remain |
| | indefinitely or can expire when using Guest Passes for Pro users. |
| | This API enables that feature.Defined in YoicsLib.m |
| | URL: |
| | http://www.yoics.net/web/api/sharing.ashx?token=<token>&state=<state>&deviceaddress= |
| | <deviceaddress>&email=<email>&guestpass=true&expiration=<expires>&code=<password> |
| | − (void)deviceSharingWithToken:(NSString*)token |
| | deviveAddress:(NSString*)deviceAddress |
| | state:(NSString*)state |
| | email:(NSString*)email |
| | guestpass:(BOOL)guestpass |
| | expiration:(NSString*)expires |
| | code:(NSString*)code |
| | success:(void (\hat{ })(NSDictionary *response))success |
| | failure:(void (\hat{ })(NSError *error))failure; |
| | Example: [[YoicsLib sharedYoicsLib] deviceSharingWithToken:token |
| | deviveAddress:deviceUIDstate:on |
| | email:”myfriend@gmail.com” |
| | guestpass:NO |
| | expiration:@“” |
| | code:@“” |
| | success:\hat{ }(NSDictionary * response) |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Sharing State (state) - String value - represents whether sharing is being |
| | added or removed. Possible values are “on” or “off”. |
| | Device Address (deviceaddress) - String value - represents the device |
| | address for the requested device, as obtained from the detailed device information |
| | returned from the Get device message. |
| | Shared Email (email) - Hexascii String value - represents the users email |
| | who's having (or had) a device shared with them. |
| | Guest Pass (guestpass) - String value - indicates sharing should be done |
| | using a Guest Pass (true or false) |
| | Guest Pass Expiration (expires) - String value - represents the number of |
| | hours before the guest pass expires. |
| | NOTE: Asterisk (*) is ‘Until Deleted’ and Zero (0) is ‘One Time’. |
| | Guest Pass Password (code) - Hexascii String value - represents a security |
| | code the user must provide when using a guest pass. |
| | Return Value(s): |
| | Sharing Status - String value - represents the status of the sharing message. |
| | Possible values are “Ok”. |
| | Possible error codes& messages include ... |
| | “InvalidToken”, 0501, “[0501] The Yoics API token is invalid or expired” |
| | “InvalidDevice”, 0502, “[0502] ] <deviceaddress> is an unknown device for |
| | <username>” |
| | “InvalidAccount”, 0503, “[0503] Guest Pass features require upgraded account” |
| | “InvalidAccount”, 0504, “[0504] User ‘<email>’ was not found” |
| | “InvalidAccount”, 0505, “[0505] User ‘<email>’ was not found” |
| | “InvalidAccount”, 0506, “[0506] User ‘<email>’ is not registered” |
| | “SharingLimit”, 0510, “[0510] “Sharing is limited to ‘n’ users” |
| | “UnexpectedError”, 0599, “[0599] <text describing the system error>” |
| | 12. *Get Sharing |
| | The client can get a list of users currently being shared a specific device. This |
| | sharing list allows the client to add or remove users from the sharing list. |
| | Defined in YoicsLib.m |
| | URL: |
| | http://www.yoics.net/web/api/getsharing.ashx?token=<token>&device=<deviceaddress> |
| | + (void)getSharingWithToken:(NSString*)token |
| | ofDevice:(NSString*)deviceAddress |
| | success:(void (\hat{ })(NSDictionary *response))success |
| | failure:(void (\hat{ })(NSError *error))failure; |
| | Example: |
| | [[YoicsLib sharedYoicsLib] getSharingWithToken:token |
| | ofDevice:deviceAddress/UID |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device |
| | address for the requested device, as obtained from the detailed device information |
| | returned from the Get Device message. |
| | Return Value(s): |
| | Sharing Information - String value - shows text status for failures or shows |
| | detailed information in XML format. |
| | Possible error codes& messages include ... |
| | “InvalidToken”, 0601, “[0601] The Yoics API token is invalid or expired” |
| | “InvalidRequest”, 0611, “[0611] Guest pass failed verification. |
| | “UnexpectedError”, 0699, “[0699] <text describing the system error>” |
| | Sample XML response: |
| | <NewDataSet> |
| | <Table> |
| | <UserName>another</UserName> |
| | <accesslevel>view \| change \| guest </accesslevel> |
| | <userid>EE4DCA34-AAAA-1111-BBBB-46FE31191A36 </userid> |
| | <Email>another@gmail.com</Email> |
| | <expires>9999/12/31 23:59:59</expires> |
| | <authcode xml:space=“preserve”></authcode> |
| | </Table> |
| | </NewDataSet> |
| | Sample JSON response: |
| | TBS |
| | 13. *Change Email / Usernname |
| | The user may need to change the email address associated with their |
| | account. In response, the service sends successful status or an error with a reason |
| | description to provide feedback to the user. |
| | Defined in ServerCallYoicsAPI.m |
| | URL: |
| | http://www.yoics.net/web/api/user.ashx?token=<token>&newemail=<email>&action=changeemail |
| | + (void)changeEmailWithToken:(NSString*)token |
| | newEmail:(NSString*)newEmail |
| | success:(void (\hat{ })(NSDictionary *response))success |
| | failure:(void (\hat{ })(NSError *error))failure; |
| | Example: |
| | [ServerCallYoicsAPI changeEmailWithToken: token |
| | newEmail: “NewEmail@gmail.com” |
| | success:\hat{ }(NSDictionary * response){ |
| | <some-code-for-success> |
| | } |
| | failure:\hat{ }(NSError *error) { |
| | <some-code-for-failure> |
| | }]; |
| | Return Value(s): |
| | Response - String value - shows text status for failures or shows detailed |
| | information in XML format. |
| | Possible error codes& messages include ... |
| | “InvalidToken”, 0701, “[0701] The Yoics API token is invalid or expired” |
| | “FailedEmail”, 0720, “[0720] <email> is not unique” |
| | “FailedEmail”, 0721, “[0721] <text describing the system error>” |
| | “UnexpectedError”, 0799, “[0799] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | <NewDataSet> |
| | <Table> |
| | <error>errorcode</error> |
| | <message>error message text</message> |
| | </Table> |
| | </NewDataSet> |
| | 14. *Change Password |
| | The user may need to change the password associated with their account. In |
| | response, the service sends successful status or an error with a reason description to |
| | provide feedback to the user. Defined in YoicsLib.m |
| | URL: |
| | http://www.yoics.net/web/api/user.ashx?token=<token>&oldpassword=<oldpassword>& |
| | newpassword=<newpassword>&action=changepassword |
| | −(void)changePasswordWithToken:(NSString*)token |
| | oldPwd:(NSString*)oldPassword |
| | newPwd:(NSString*)newPassword |
| | success:(void (\hat{ })(NSDictionary* response))success |
| | failure:(void (\hat{ })(NSError *))failure; |
| | Example: [[YoicsLib sharedYoicsLib] changePasswordWithToken: token |
| | oldPwd: oldSecret |
| | newPwd: newSecret |
| | success:\hat{ }(NSDictionary * response){ |
| | <some-code-for-success> |
| | } |
| | failure:\hat{ }(NSError *error) { |
| | <some-code-for-failure> |
| | } |
| | Parameter(s): |
| | Yoics Login Token (token) - String value - represents the Login Token for |
| | authentication. |
| | Old Password (oldpassword) - Hexascii String value - represents a current |
| | account password. |
| | New Password (newpassword) - Hexascii String value - represents a new |
| | account password. |
| | Return Value(s): |
| | Response - String value - shows text status for failures or shows detailed |
| | information in XML format. |
| | Possible error codes& messages include ... |
| | “InvalidToken”, 0701, “[0701] The Yoics API token is invalid or expired” |
| | “PasswordFailed”, 0731, “[0731] Problem confirming password change” |
| | “PasswordFailed”, 0734, “[0734] <message>” |
| | “UnexpectedError”, 0799, “[0799] <text describing the system error>” |
| | Sample XML response: |
| | <NewDataSet> |
| | <Table> |
| | <status>ok</status> |
| | <authhash>Users authentication hash for future login calls</authhash> |
| | </Table> |
| | </NewDataSet> |
| | Sample JSON response: |
| | { “NewDataSet”: { “Table”: [ {“status”: “ok” } ] }} |
| | <NewDataSet> |
| | <Table> |
| | <error>errorcode</error> |
| | <message>error message text</message> |
| | </Table> |
| | </NewDataSet> |
| | 15. **Remove a Device |
| | User may use this API to remove a particular device from the list of available |
| | devices. |
| | Defined in YoicsLib.m |
| | Here Token is not necessary. |
| | − (void)removeDeviceFromMyListDevice:(NSString*)uidDevice; |
| | Example: |
| | [[YoicsLib sharedYoicsLib] removeDeviceFromMyListDevice: |
| | DeviceUID/DeviceAddress]; |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “DeleteFailed”, 0860, “[0860] An exception occurred - <message>” |
| | “DeleteFailed”, “No device address was specified” |
| | “GetDeviceFailed”, 0861, “[0861] <deviceaddress> is an unknown device for |
| | this user” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 16. **Reset All Devices |
| | User may want to Reset all the devices List known to him. It clears the device |
| | list. |
| | Defined in YoicsLib.m |
| | (void)resetAllListDevices; |
| | Example: [[YoicsLib sharedYoicsLib] resetAllListDevices]; |
| | 17. ** Create A New Device |
| | The client registers a new device with the Yoics service. New devices are |
| | easily added by sending the device id and device name for an already active and |
| | unregistered device. In response, the service sends successful status or an error with a |
| | reason description to provide feedback to the user. |
| | Defined in ServerCallYoicsAPI.m |
| | URL: |
| | http://www.yoics.net/web/api/device.ashx?token=<token>&deviceaddress= |
| | <deviceaddress&devicetype=<type>&action=create |
| | + (void)createDeviceWithToken:(NSString*)token |
| | deviceAddress:(NSString*)deviceAddress |
| | withDeviceType:(int)deviceType |
| | success:(void (\hat{ })(NSDictionary *response))success |
| | failure:(void (\hat{ })(NSError *error))failure; |
| | Example: [ServerCallYoicsAPI createDeviceWithToken: token |
| | deviceAddress: deviceAddress/deviceUID |
| | withDeviceType: DeviceType |
| | success:\hat{ }(NSDictionary * response){ |
| | <some-code-for-success> |
| | } |
| | failure:\hat{ }(NSError *error) { |
| | <some-code-for-failure> |
| | } |
| | Parameter(s): |
| | Yoics Login Token (token) - String value - represents the Login Token for |
| | authentication. |
| | Device Address (deviceaddress) - String value - represents the device |
| | address for the requested device. |
| | Device Type (devicetype) - Hexascii String value - represents the encoded |
| | device type for the requested device. |
| | This must be provided by Yoics for each production device type. |
| | Return Value(s): |
| | Response - String value - shows text status for failures or shows detailed |
| | information in XML format. |
| | Possible error codes& messages include ... |
| | “InvalidToken”, 0801, “[0801] The Yoics API token is invalid or expired” |
| | “CreateFailed”, 0870, “[0870] Error:<message>:” |
| | “CreateFailed”, 0871, “[0871] Error: API Key not authorized for this function:” |
| | “CreateFailed”, 0872, “[0872] Error: API Key does not match device |
| | manufacturer:” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 18. *Register Device |
| | The client registers a new device with the Yoics service. New devices are |
| | easily added by sending the device id and device name for an already active and |
| | unregistered device. In response, the service sends successful status or an error with a |
| | reason description to provide feedback to the use. |
| | Defined in ServerCallYoicsAPI.m |
| | URL: |
| | http://www.yoics.net/web/api/device.ashx?token=<token>&deviceaddress=<deviceaddress> |
| | &alias=<devicename>&skipreset=<flag>&action=register |
| | + (void)registerDeviceWithToken:(NSString*)token |
| | deviceAddress:(NSString*)deviceAddress |
| | deviceAlias:(NSString*)deviceAlias |
| | success:(void (\hat{ })(NSDictionary *response))success |
| | failure:(void (\hat{ })(NSError *error))failure; |
| | Example: [ ServerCallYoicsAPI registerDeviceWithToken: token |
| | deviceAddress: deviceAddress |
| | deviceAlias: deviceAlias |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device |
| | address for the requested device. |
| | Device Name (alias) - Hexascii String value - represents the device name for |
| | the requested device. |
| | Return Value(s): |
| | Response - String value - shows text status for failures or shows detailed |
| | information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “InvalidName”, 0803, “[0803] The device name is missing” |
| | “RegistrationFailed”, 0804, “[0804] Error:FailedToGetNewSecret:” |
| | “RegistrationFailed”, 0805, “[0805] Error:UpdateSecretFailed:” |
| | “RegistrationFailed”, 0806, “[0806] Error:DeviceNotFound:” |
| | “RegistrationFailed”, 0807, “[0807] Error:DuplicateName:” |
| | “RegistrationFailed”, 0808, “[0808] Error:DuplicateAddress:” |
| | “RegistrationFailed”, 0809, “[0809] Error:MissingArguments:” |
| | “RegistrationFailed”, 0810, “[0810] Error:RegistrationException:<message>” |
| | “RegistrationFailed”, 0811, “[0811] Error:RegistrationTemporarilyDisabled:” |
| | “UnexpectedError”, 0899, “[0899] <text describing the system error>” |
| | Sample XML response: |
| | <NewDataSet> |
| | <Table> |
| | <secret><sharedsecretstring></secret> |
| | </Table> |
| | </NewDataSet> |
| | Sample JSON response: |
| | { “NewDataSet”: { “Table”: [ {“secret”: “<shared secret string>” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 19. * Get Device |
| | The client registers gets information about an existing device with the Yoics |
| | service. In response, the service sends successful status or an error with a reason |
| | description to provide feedback to the user. |
| | Defined in ServerCallYoicsAPI.m |
| | URL: |
| | http://www.yoics.net/web/api/device.ashx?token=<token>&deviceaddress=<deviceaddress> |
| | &action=get |
| | + (void)getDeviceWithToken:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ ServerCallYoicsAPI getDeviceWithToken: token |
| | deviceAddress: deviceAddress |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device address |
| | for the requested device. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “GetDeviceFailed”, 0820, “[0820] Invalid Device or the current user does not own |
| | the device.” |
| | “GetDeviceFailed”, 0821, “[0821] <deviceaddress> is an unknown device for this |
| | user” |
| | “UnexpectedError”, 0899, “[0899] <text describing the system error>” |
| | Sample XML response: |
| | <NewDataSet> |
| | <Table> |
| | <owneruserid>EE4DCA34-AAAA-1111-BBBB-46FE31191A36</owneruserid> |
| | <devicetype>00:00:00:03:00:02:00:00:04:01:FF:BF</devicetype> |
| | <deviceaddress>00:00:00:1B:FE:00:3F:A4</deviceaddress> |
| | <lastcontacted>2010-09-01T20:50:22.627-07:00</lastcontacted> |
| | <devicestate>inactive</devicestate> |
| | <webviewerurl /> |
| | <clientdownload /> |
| | <viewerregistrationurl /> |
| | <secured>0</secured> |
| | <supportsudp>1</supportsudp> |
| | <udpport>0</udpport> |
| | <supportstcp>0</supportstcp> |
| | <chatserverport>0</chatserverport> |
| | <supportsreflector>0</supportsreflector> |
| | <enabled>1</enabled> |
| | <chatserver /> |
| | <securitykey>11:22:AA:BB:C8:ED:1E:71:A4:C4:30:F8:81:5A:C1:7D:B1:A8:37:B6</secu |
| | ri tykey> |
| | <devicelastip>76.215.57.198:1027</devicelastip> |
| | <devicealias>Lorex Viewer</devicealias> |
| | <serverencryption>1</serverencryption> |
| | <encryptionflag>3</encryptionflag> |
| | <minimumencryption>1</minimumencryption> |
| | <isglobal>0</isglobal> |
| | <laststatechanged>2010-09-01T20:50:22.627-07:00</laststatechanged> |
| | <lastinternalip>192.168.1.73:1027</lastinternalip> |
| | <nonce /> |
| | <ownerusername>another</ownerusername> |
| | <webenabled>1</webenabled> |
| | <mobileenabled>1</mobileenabled> |
| | <sslenabled>0</sslenabled> |
| | <sslproxy>1</sslproxy> |
| | <weburi /> |
| | <mobileuri /> |
| | <addreturnurl>0</addreturnurl> |
| | <servicetitle>Camera Viewer</servicetitle> |
| | <CreateDate>2010-09-01T14:12:04.957-07:00</CreateDate> |
| | <manufacturer>Lorex Technology Inc.</manufacturer> |
| | <lastsecuritykey>11:22:AA:BB:C8:ED:1E:71:A4:C4:30:F8:81:5A:C1:7D:B1:A8:37:B6 |
| | </lastsecuritykey> |
| | <dirtysecuritykey>0</dirtysecuritykey> |
| | <alertFlag>false</alertFlag> |
| | </Table> |
| | </NewDataSet> |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 20. *Rename Device |
| | The client can rename any device owned by the current authenticated user. In |
| | response, the service sends successful status or an error with a reason description to |
| | provide feedback to the user. |
| | Defined in YoicsLib.m |
| | URL: |
| | http://www.yoics.net/web/api/device.ashx?token=<token>&deviceaddress=<deviceaddress> |
| | &alias=<devicename>&action=rename |
| | − (void)renameDeviceWithToken:(NSString *)token |
| | deviceAddress:(NSString *)deviceAddress |
| | newAlias:(NSString *)newAlias |
| | success:(void (\hat{ })(NSDictionary* response))success |
| | failure:(void (\hat{ })(NSError *))failure; |
| | Example: [[YoicsLib sharedYoicsLib] renameDeviceWithToken: token |
| | deviceAddress: deviceAddress |
| | newAlias: NewDeviceName |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device |
| | address for the requested device. |
| | Device Name (Newalias) - Hexascii String value - represents the new device |
| | name for the requested device. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “RenameFailed”, 0830, “[0830] Invalid Device or the current user does not own |
| | the device.” |
| | “RenameFailed”, 0831, “[0831] No alias (new name) was specified.” |
| | “RenameFailed”, 0832, “[0832] Failed to set new name.” |
| | “RenameFailed”, 0833, “[0833] Duplicate alias (new name) was specified.” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 21. * Transfer Device |
| | The client can transfer ownership of any owned device to another registered |
| | user. In response, the service sends successful status or an error with a reason |
| | description to provide feedback to the user. |
| | Defined in ServerCallYoicsAPI.m |
| | URL: |
| | http://www.yoics.net/web/api/device.ashx?token=<token>&deviceaddress=<deviceaddress> |
| | &newuser=<newuser>&action=transfer |
| | + (void)transferDeviceToUser:(NSString*)NewUser |
| | token:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ ServerCallYoicsAPI transferDeviceToUser: NewUser]; |
| | Parameter(s): |
| | Yoics Login Token (token) - String value - represents the Login Token for |
| | authentication. |
| | Device Address (deviceaddress) - String value - represents the device |
| | address for the requested device. |
| | New Email (newuser) - Hexascii String value - represents the registered email |
| | for the new device owner. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “TransferFailed”, 0840, “[0840] No new user was specified.” |
| | “TransferFailed”, 0841, “[0841] Invalid Device or the current user does not |
| | own the device.” |
| | “TransferFailed”, 0842, “[0842] The specified user does not exist.” |
| | “TransferFailed”, 0843, “[0843] The specified user already has a device named |
| | <name>.” |
| | “TransferFailed”, 0844, “[0844] Failed to change the device ownership.” |
| | “TransferFailed”, 0845, “[0845] Ownership changed but access could not be |
| | reset.” |
| | “Unexpected Error”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 22. *Reset Secret Device |
| | The client may need to reset the security secret for any device they own. The |
| | device should be active when this API is used or the device may become unuseable. In |
| | response, the service sends successful status or an error with a reason description to |
| | provide feedback to the user. Defined in ServerCallYoicsAPI.m |
| | URL: |
| | http://www.yoics.net/web/api/device.ashx?token=<token>&deviceaddress= |
| | <deviceaddress>&action=resetsecret |
| | + (void)resetSecretDeviceWithToken:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ ServerCallYoicsAPI resetSecretDeviceWithToken: <list of args as |
| | specified above>]; |
| | deviceAddress: DevicdAddress/UID |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameters: |
| | Yoics Login Token (token) - String value - represents the Login Token for |
| | authentication. |
| | Device Address (deviceaddress) - String value - represents the device |
| | address for the requested device. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “ResetFailed”, 0850, “[0850] Invalid Device or the current user does not own |
| | the device.” |
| | “InvalidDevice”, 0851, “[0851] <deviceaddress> is not active.” |
| | “ResetFailed”, 0852, “[0852] Secret could not be changed” |
| | “ResetFailed”, 0853, “[0853] <text describing the system error>” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | Get Device response is a detailed record of the device. Examples included below. |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 23. **Remove Device From Friends Device List |
| | Client may request to remove a device from a list of available devices for a |
| | particular shared user. |
| | Defined in YoicsLib.m |
| | − (void)removeDeviceFromMyFriendDevice:(NSString*)uidDevice]; |
| | Example: [[YoicsLib sharedYoicsLib] removeDeviceFromMyFriendDevice: |
| | uidDevice]; |
| | 24. **Get The List of Own Devices Available |
| | Client may request to know the list of devices available which he owns. They |
| | will be loaded from cache. |
| | Defined in YoicsLib.m |
| | −(void)getMyDevicesFromCache; |
| | Example: [[YoicsLib sharedYoicsLib] getMyDevicesFromCache ]; |
| | Return Value(s): |
| | TBD |
| | 25. **Get The List of Friends Devices Available |
| | Client may request to know the list of friends devices available to him. They |
| | will be loaded from cache. |
| | Defined in YoicsLib.m |
| | −(void)getFriendDevicesFromCache; |
| | Example: [[YoicsLib sharedYoicsLib] getFriendDevicesFromCache ]; |
| | Return Value(s): |
| | TBD |
| | 26. ** Get The Handset IP Details |
| | Client may request to know the public ip and handset ip. Service request may |
| | respond with Public IP, Handset IP and Netmask on success and with proper error |
| | codes on failure. |
| | Defined in YoicsLib.m |
| | (I) − (void) getIpInformationWithSuccess:(void (\hat{ })(NSString* ip))success |
| | failure:(void (\hat{ })(NSError *error))failure; |
| | (ii) − (void) getIpInformation; |
| | Return Value(s): |
| | TBD |
| | 27. *Register Device Skip Secret With Token |
| | This enables a client to register a new device without a secret. Similar to |
| | Register device with ‘skipsecret’ flag enabled. |
| | Defined in ServerCallYoicsAPI.m |
| | URL: |
| | http://www.yoics.net/web/api/device.ashx?token=<token>&deviceaddress= |
| | <deviceaddress>&alias=<devicename>&skipreset=true&action=register |
| | + (void)registerDeviceSkipSecretWithToken:(NSString*)token |
| | deviceAddress:(NSString*)deviceAddress |
| | deviceAlias:(NSString*)deviceAlias |
| | success:(void (\hat{ })(NSDictionary *response))success |
| | failure:(void (\hat{ })(NSError *error))failure; |
| | Return Value(s): |
| | Same as that for Register Device. |
| | 28. * Get Product Information |
| | Client may request to know the current product / Package information which |
| | he has subscribed to. Returns BASIC / PRO / DVRPLUS / DVRPREMIUM on success |
| | and Probably an error code on failure. |
| | Defined in YoicsLib.m |
| | − (void)getProductInformationSuccess:(void (\hat{ })(BOOL response))success; |
| | Return Value(s): |
| | TBD |
| | 29. *Get Manufacturer Details |
| | To check the manufacturer details of a particular device client may request |
| | with this API. |
| | Defined in YoicsLib.m |
| | −(void)getManufacturerWithsuccess:(void (\hat{ })(NSDictionary* response))success |
| | f ailure:(void (\hat{ })(NSError *))failure; |
| | Return Value(s): |
| | TBD |
| | 30. *Upgrade User Account |
| | Authorized API developers are allowed to perform in-app style purchases on |
| | behalf of their users and automatically notify the Yoics Service when a purchase or |
| | upgrade is completed. This process is required in order for Yoics to enable the premium |
| | services that get purchased within external applications. To have your developer |
| | account enabled for this feature, Yoics must be contacted to provision this feature. |
| | Note: For Apple iTunes purchases, the iTunes receipt must be sent in the |
| | transaction and authorization fields, unless otherwise agreed to with Yoics. All other |
| | fields should have valid values. |
| | Defined in YoicsLib.m |
| | URL: |
| | http://www.yoics.net/web/api/user.ashx?token=<token>&newplan=<newplan>&cost= |
| | <cost>&discount=<discount>&transaction=<transaction>&authorization=<authorization> |
| | &duration=<duration>&email=<email>&promotion=<promotion>&email=<emailflag> |
| | &apilevel=<apilevel>&action=upgrade |
| | (i) |
| | − (void)upgradeAccountWithTransaction:(NSString *)transaction |
| | authorization:(NSString *)authoriaztion |
| | price:(NSString*)price |
| | success:(void (\hat{ })(NSDictionary *response))success |
| | failure:(void (\hat{ })(NSError *error))failure; |
| | (ii) |
| | − (void)upgradeAccountWithTransaction:(NSString *)transaction |
| | authorization:(NSString *)authoriaztion |
| | packageInfo:(NSMutableDictionary *)packageInfo |
| | success:(void (\hat{ })(NSDictionary *response))success |
| | failure:(void (\hat{ })(NSError *error))failure; |
| | Parameter(s): |
| | Yoics Login Token (token) - String value - represents the Login Token for |
| | authentication. |
| | Plan Identifier (newplan) - String value - represents the unique service plan |
| | being purchased or upgraded. |
| | Cost (cost) - decimal value - represents the cost of the plan in USD currency. |
| | Discount (discount) - decimal value - represents the discount amount in USD |
| | currency. |
| | Service Duraton (duration) - integer value - represents the number of months |
| | the new plan is valid, from the date of purchase. |
| | Transaction ID (transaction) - Hexascii String value - represents the |
| | transaction ID for the purchase. |
| | Authorization Code (authorization) - Hexascii String value - represents the |
| | purchase authorization code for the purchase. |
| | Promotion Code (promotion) - String value - represents the promotion code |
| | that may have been used during the purchase to apply a discount. |
| | Email Indicator (emailflag) - String value - represents an indicator if Yoics |
| | should email a receipt to the user. By default the email is not sent when third party |
| | applications manage purchases. Values are ‘true’ or ‘false’ |
| | Yoics API Level (apilevel) - String value - represents the numeric version of |
| | the API the client uses. |
| | Return Value(s): |
| | Response - String value - shows text status for failures or shows detailed |
| | information in XML format. |
| | Possible error codes& messages include ... |
| | “InvalidToken”, 0701, “[0701] The Yoics API token is invalid or expired” |
| | “UpgradeError”, 0751, “[0751] User upgrades not allowed for this API” |
| | “UpgradeError”, 0752, “[0752] Service upgraded encountered unexpected error” |
| | “UpgradeError”, 0753, “[0753] Failed: Setup failed - duplicate transaction” |
| | “UpgradeError”, 0753, “[0753] Failed: Setup failed for unknown reason” |
| | “UpgradeError”, 0754, “[0754] Failed: Purchase delay exceeded by <minutes> |
| | for <transactionid>” |
| | “UpgradeError”, 0754, “[0754] “Failed: Transaction mismatch of |
| | <transactionid> for <transaction>” |
| | “UpgradeError”, 0754, “[0754] Failed: Product code mismatch <product> for |
| | <newplan> for <transaction>” |
| | “UpgradeError”, 0754, “[0754] Failed: Failed to parse receipt” |
| | “UpgradeError”, 0754, “[0754] Failed: Unknown reason” |
| | Sample XML response: |
| | <NewDataSet> |
| | <Table> |
| | <status>ok</status |
| | <note>Must perform API login to get new settings</note> |
| | </Table> |
| | </NewDataSet> |
| | Sample JSON response: |
| | { “NewDataSet”: { “Table”: [ {“status”: “ok” } ] }} |
| | <NewDataSet> |
| | <Table> |
| | <error>errorcode</error> |
| | <message>error message text</message> |
| | </Table> |
| | </NewDataSet> |
| | END |
| | *** Other API |
| | (I) getDevicesWithToken( ) - defined in ServiceCallYoicsAPI.m. This API is internally |
| | invoked |
| | −getFriendsDevicesUsingBlockWithFilter( ) & getMyDevicesUsingBlockWithFilter( ). |
| | Both defined in YoicsLib.m |
| | (II) deleteDeviceWithToken( ) - defined in ServiceCallYoicsAPI.m and commented its |
| | wrapper in YoicsLib.m |
| | + (void)deleteDeviceWithToken:(NSString*)token |
| | deviceAddress:(NSString*)deviceAddress success:(void (\hat{ }) (NSDictionary |
| | *response))success failure:(void (\hat{ })(NSError *error))failure; |
| | (III) getProductMapSuccess( ) - defined in ServerCallYoicsAPI.m has been used in |
| | getProductInformationSuccess( ) in YoicsLib.m |
| | + (void)getProductMapSuccess:(void (\hat{ })(NSDictionary *response))success |
| | failure:(void (\hat{ })(NSError *error))failure; |
| | (IV) getPlanDescriptor( ) - defined in ServerCallYoicsAPI.m and used in |
| | getProductInformationSuccess( ) in YoicsLib.m |
| | + (void)getPlanDescriptor:(NSString *)plan success:(void (\hat{ })(NSDictionary |
| | *response))success failure:(void (\hat{ })(NSError *error))failure; |
| | (V) logoutWithToken( ) - defined in ServerCallYoicsAPI.m used in logoutWithSuccess( ) |
| | in YoicsLib.m |
| | + (void)logoutWithToken:(NSString*)token success:(void (\hat{ })(NSDictionary |
| | *response))success failure:(void (\hat{ })(NSError *error))failure; |
| | END Weaved and Yoics Service API Reference |
| | NOTES: |
| | * Service API calls. |
| | ** API calls for the APPlication Developer. |
| | *** Other APIs. |
| | Usernames have been replaced with another |
| | Keys have been truncated with trailing ... |
| | 1. *New User - Service Registration |
| | The client registers a new user with the Yoics service. New users are easily added |
| | by sending the user's email, password and security challenge response to the Yoics |
| | service. In response, the service sends successful status or an error with a reason |
| | description to provide feedback to the user. |
| | To register a new user with weaved service following API must be used - defined |
| | in YoicsLib.m |
| | URL: |
| | http://www.yoics.net/web/api/user.ashx?key=<key>&email=<email>&pwd=<password> |
| | &que=<question>&ans=<answer>&first=<firstname>&last=<lastname>&country= |
| | <country>&apilevel=<apilevel>&action=register |
| | −(void)registerUserWithEmail:(NSString *)email |
| | password:(NSString *)pwd |
| | question:(NSString *)question |
| | answer:(NSString *)answer |
| | firstName:(NSString *)firstName |
| | lastName:(NSString *)lastName |
| | success:(void (\hat{ })(NSDictionary* response))success |
| | failure:(void (\hat{ })(NSError *))failure; |
| | Example: |
| | [[YoicsLib sharedYoicsLib] registerUserWithEmail:[_username |
| | cStringUsingEncoding:NSASCIIStringEncoding] |
| | password:[_password cStringUsingEncoding:NSASCIIStringEncoding] |
| | question:[_cStringUsingEncoding:NSASCIIStringEncoding] |
| | answer:[_cStringUsingEncoding:NSASCIIStringEncoding] |
| | firstName:[_cStringUsingEncoding:NSASCIIStringEncoding] |
| | lastName[_cStringUsingEncoding:NSASCIIStringEncoding] |
| | success:\hat{ }(NSDictionary* response){ |
| | <some-success-handler-code> |
| | } |
| | failure:\hat{ }(NSError * failure) |
| | { |
| | <some-failure-handler-code> |
| | }]; |
| | Parameter(s): |
| | Yoics User Account (email) - Hexascii String value - represents the users |
| | Yoics account id or email. |
| | Yoics User Password (pwd) - Hexascii String value - represents the users |
| | Yoics account password. |
| | Users First Name (first) -Hexascii String value - represents the users first |
| | name. |
| | Users Last Name (last) - Hexascii String value - represents the users last |
| | name. |
| | Security Question (question) - Hexascii String value - represents the security |
| | question the user will be presented when recovering lost or forgotten passwords. |
| | Security Challenge (answer) - Hexascii String value - represents the security |
| | answer the user must supply when recovering lost or forgotten passwords. |
| | Return Value(s): |
| | Response - String value - shows text status for failures or shows detailed |
| | information in XML format. |
| | “InvalidToken”, 0701, “[0701] The Yoics API token is invalid or expired” |
| | “InvalidRequest”, 0702, “[0702] Error:DuplicateEmail:” |
| | “InvalidRequest”, 0703, “[0703] Error:IllegalEmail:<email>” |
| | “Invalid Request”, 0704, “[0704] Error:CreateUserException:<message>” |
| | “Invalid Request”, 0705, “[0705] Error:HttpException:<message>” |
| | “Invalid Request”, 0706, “[0706] Error:<status>” |
| | “InvalidRequest”, 0707, “[0707]: email notification failed <message>” |
| | “InvalidRequest”, 0708, “[0708]: user profile missing” |
| | “InvalidRequest”, 0709, “[0709]: User profiled issue:<message>” |
| | “UnexpectedError”, 0799, “[0799] <text describing the system error>” |
| | Sample XML response: |
| | <NewDataSet> |
| | <Table> |
| | <status>ok</status> |
| | <authhash>Users authentication hash for future login calls</authhash> |
| | </Table> |
| | </NewDataSet> |
| | Sample JSON response: |
| | { “NewDataSet”: { “Table”: [ {“status”: “ok”,”authhash”:”hash value” } ] }} |
| | <NewDataSet> |
| | <Table> |
| | <error>errorcode</error> |
| | <message>error message text</message> |
| | </Table> |
| | </NewDataSet> |
| | 2. *User Login |
| | Before Invoking any API user must login into his account with username & |
| | password/authash. |
| | Defined in YoicsLib.m |
| | URL: |
| | https://www.yoics.net/web/api/login.ashx?key=<key>&usr=<userid>&pwd=<password> |
| | &auth=<authhash>&apilevel=<level>&type=<type> |
| | (i)- With Pwd: |
| | −(void)logInWithUser:(NSString*)user andPwd:(NSString*)pwd |
| | success:(void (\hat{ })(NSDictionary* response))success |
| | failure:(void (\hat{ })(NSError *error))failure |
| | p2pLoginSuccess:(void (\hat{ })(void))p2pSuccess |
| | p2pLoginFailure:(void (\hat{ }) void))p2pFailure; |
| | (ii)- With authash: |
| | − (void)logInWithUser:(NSString*)user andAuthHash:(NSString*)authash |
| | success:(void (\hat{ })(NSDictionary* response))success |
| | failure:(void (\hat{ })(NSError *error))failure |
| | p2pLoginSuccess:(void (\hat{ })(void))p2pSuccess |
| | p2pLoginFailure:(void (\hat{ })(void))p2pFailure; |
| | Example: |
| | [[YoicsLib sharedYoicsLib] logInWithUser:user andPwd:pwd |
| | success:\hat{ }(NSDictionary* response) |
| | { |
| | <some-success-handler-code> |
| | } |
| | failure:\hat{ }(NSError * failure) |
| | { |
| | <some-failure-handler-code> |
| | }]; |
| | The client must login to the Yoics Web API before any other messages can be |
| | invoked. The client passes in the users Yoics account ID and their password. In return, |
| | the client will get a LoginToken which is later used on other API messages to provide |
| | authentication information. |
| | NOTE: The LoginToken is only valid for an unspecified amount of time. The token |
| | can be used on other API messages until the InvalidToken error code is received. Once |
| | received, the Login Message must be invoked again to get a new LoginToken. |
| | Return Value(s): |
| | User Information as follows |
| | <NewDataSet> |
| | <Table> |
| | <userid>the name of the user logging in</userid> |
| | <email>the email address of the user logging in </email> |
| | <level>users Yoics service level (BASIC, PRO, etc)</level> |
| | <maxviewer>max number of concurrent camera viewers allowed</maxviewer> |
| | <view2×2state>if 2×2 matrix view is enable or disabled</view2×2state> |
| | <view4×4state>disabled</view4×4state> |
| | <token>security token used when calling other APIs</token> |
| | <maxstart>max number of connections to auto start</maxstart> |
| | <expires>users Yoics service level expiration date \| ‘never’</expires> |
| | <maxsharing>Max Yoics users per shared device</maxsharing> |
| | <authhash>Users authentication hash for future login calls</authhash> |
| | NOTE: The following attributes are optional based on API level. |
| | <apikey>StemConnectApplication</apikey> |
| | <name>Stem Innovation Inc</name> |
| | <deviceTypeList>19</deviceTypeList> |
| | <manufacturerID>12</manufacturerID> |
| | <expires>2099-12-31T12:00:00-05:00</expires> |
| | <featuresetid>STEMBASIC</featuresetid> |
| | <upgradedsetid>STEMPRO</upgradedsetid> |
| | <features>ads=0,share=0,concurrent=1,webduration=300,webdaily=500, |
| | p2pduration=300,p2pdaily=500,guest=0</features> |
| | <featurecached>true</featurecached><keycached>true</keycached> |
| | </Table> |
| | </NewDataSet> |
| | If an error occurs, the response will be as follow: |
| | <NewDataSet> |
| | <Table> |
| | <error>errorcode</error> |
| | <errorID>errorID</errorID> |
| | <message>[ errorID ] error message text</message> |
| | </Table> |
| | </NewDataSet> |
| | Possible error codes, IDs & messages include |
| | “InvalidUser”, 0101, “[0101] Failed to get user information or user does not |
| | exist” |
| | “InvalidCredentials”, 0102, “[0102] The username or password are invalid” |
| | “UnexpectedError”, 0199, “[0199] <text describing the system error>” |
| | “InvalidKey”, 0103, “[0103] The API application key is invalid” |
| | “LoginRedirect””, 0104, “[0104] <see below for full description>” |
| | When LoginRedirect is returned, the message field contains a new base URL to |
| | attempt login. The redirect allows Yoics to load balance the API access requests to the |
| | Yoics API. The message field will look like |
| | “<message>www2.yoics.net/web/api/</message>”. |
| | Sample XML response: |
| | <NewDataSet> |
| | <Table> |
| | <userid>another</userid> |
| | <email>another@gmail.com</email> |
| | <level>BASIC</level> |
| | <maxviewer>1</maxviewer> |
| | <view2×2state>disabled</view2×2state> |
| | <view4×4state>disabled</view4×4state> |
| | <token>EBE...</token> |
| | <maxstart>1</maxstart> |
| | <maxviewer>1</maxviewer> |
| | </Table> |
| | </NewDataSet> |
| | Sample JSON response: |
| | { “NewDataSet”: { “Table”: [ {“email”: “another@gmail.com”, “level”: “BASIC”, |
| | “maxstart”: “1”, “maxviewer”: [ “1”, “1” ], “token”:“EBE... |
| | ”, “userid”: “another”, “view2×2state”: “disabled”, “view4×4state”: “disabled” } |
| | ] }} |
| | 3. *User Logout |
| | Method call to logout from an account. Defined in YoicsLib.m |
| | URL: http://www.yoics.net/web/api/logout.ashx?token=<token>&type=<type> |
| | (void)logoutWithSuccess:(void (\hat{ })(void))success failure:(void (\hat{ })(NSError |
| | *error))failure |
| | Example: [[YoicsLib sharedYoicsLib] logoutWithSuccess: <arguments ass |
| | specified in declaration>]; |
| | Return Value(s): |
| | Status as follows |
| | <NewDataSet> |
| | <Table> |
| | <status>ok status when completed</status> |
| | </Table> |
| | </NewDataSet> |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | Possible error codes & messages include ... |
| | “InvalidToken”, 0201, “[0201] The Yoics API token is invalid or expired” |
| | “UnexpectedError”, 0299, “[0299] <text describing the system error>” |
| | Sample XML Response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | 4. *Connect to a device with Token |
| | The client can request web or mobile connections to devices for viewing |
| | purposes. Device connections are made by the Yoics Proxy servers on behalf of the |
| | user and then made available using secured URLs. The client requests the connection |
| | and then waits for the provisioning to occur, at which time the URL is returned. The API |
| | also provides methods to check a connection status or stop an existing connection. |
| | To Connect to a remote device(running weavedConnectd) from an Application |
| | (Client Device), with a Token, use this API. Defined in ServerCallYoicsAPI.m. |
| | URL: |
| | http://www.yoics.net/web/api/connect.ashx?token=<token>&deviceaddress=<deviceaddress>> |
| | &type=<type> |
| | + (void)deviceConnectionWithToken:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ServerCallYoicsAPI deviceConnectionWithToken:<arguments as |
| | specified in the declaration above>]; |
| | Return Value(s): |
| | Proxy Information - String value - shows text status for failures or shows |
| | detailed information in XML format. |
| | Possible error codes& messages include ... |
| | “InvalidToken”, 0401, “[0401] The Yoics API token is invalid or expired” |
| | “InvalidDevice”, 0402, “[0402] <deviceaddress> is an unknown device for |
| | <username>” |
| | “InvalidDevice”, 0403, “[0403] <deviceaddress> is not active |
| | “InvalidDevice”, 0404, “[0404] Viewer only valid for supported cameras |
| | “InvalidAccess”, 0405, “[0405] <deviceaddress> is not available for public |
| | access and is not shared with you. |
| | “ServiceError”, 0406, “[0406] Service limit reached for web connections. |
| | “InvalidRequest”, 0409, “[0409] Connection does not exist. |
| | “InvalidRequest”, 0410, “[0410] Priority connection block. |
| | “InvalidRequest”, 0411, “[0411] Guest pass failed verification. |
| | “UnexpectedError”, 0499, “[0499] <text describing the system error>” |
| | Sample XML response for connect: |
| | <NewDataSet> |
| | ’<Table> |
| | <deviceaddress>00:00:00:25:07:00:15:19</deviceaddress> |
| | <status>new \| assigned \| started \| running</status> |
| | <requested>2010-02-01T13:09:05.587-08:00</requested> |
| | <proxy>proxy1.yoics.net to proxy5.yoics.net</proxy> |
| | <url>https://sdgYeys.proxy5.yoics.net/<single-image-URL></url> |
| | <imageintervalms>milliseconds between image fetched</imageintervalms> |
| | <expirationsec>seconds until connection expires</expirationsec> |
| | <streamscheme>http \| rtsp</streamscheme> |
| | <streamuri>URI for stream (eg - video.cgi)</streamuri> |
| | Note: The following two attributes are optionally included when an existing |
| | connection is stopped inorder to start a new connection from a different |
| | location. |
| | <connectionOverridden>true \| false</connectionOverridden> |
| | <previousConnection>proxy URL</previousConnection> |
| | </Table> |
| | </NewDataSet> |
| | Sample XML response for status: |
| | <NewDataSet> |
| | <Table> |
| | <state>running</state> |
| | <ip>69.181.64.42</ip> |
| | <proxy>http://proxy6.yoics.net:39862</proxy> |
| | </Table> |
| | </NewDataSet> |
| | Sample XML response for stop: |
| | <NewDataSet> |
| | <Table> |
| | <status>ok</status> |
| | </Table> |
| | </NewDataSet> |
| | 5. ** Get the Connection Type in string format |
| | To check the type of connection established with the device(running |
| | weavedConnectd). Defined in YoicsDevice.m |
| | (NSString*)getStringConnectionType; |
| | Example: YoicsDevice dev = [[YoicsDevice alloc] init]; |
| | NSString *Connection = [dev getStringConnectionType]; |
| | Returns: NO CONNECTION / Local / Relay / P2P |
| | 6. ** Check if the user Owns the device |
| | Defined in YoicsDevice.m |
| | (BOOL)isMine; |
| | Example: YoicsDevice dev = [[YoicsDevice alloc] init]; |
| | BOOL Owner = [dev isMine]; |
| | Returns: YES if device belongs to user NO if not. |
| | 7. *To get security question Via an e-mail |
| | The application may need to verify the user account when no password is |
| | available. For example, the user needs to recover their password. The client can get the |
| | users security challenge question for use in other APIs. In response, the service sends |
| | successful status or an error with a reason description to provide feedback to the user. |
| | Defined in YoicsLib.m |
| | URL: |
| | http://www.yoics.net/web/api/user.ashx?key=<key>&email=<email>>&apilevel= |
| | <apilevel>&action=getsecurityquestion |
| | + (void)getSecurityQuestionWithEmail:(NSString*)email |
| | success:(void (\hat{ })(NSDictionary *response))success |
| | failure:(void (\hat{ })(NSError *error))failure |
| | Example: |
| | [[YoicsLib sharedYoicsLib] getSecurityQuestionWithEmail:_txtEmail.text |
| | success:\hat{ }(NSDictionary *response) { |
| | <some-code-for-success> |
| | } |
| | failure:\hat{ }(NSError *error) { |
| | <some-code-for-failure> |
| | }]; |
| | Return Value(s): |
| | Response - String value - shows text status for failures or shows detailed |
| | information in XML format. |
| | Possible error codes& messages include ... |
| | “SecurityQuestionFailed”, 0741, “[0741] Unknown email address” |
| | “SecurityQuestionFailed”, 0742, “[0742] API key is required” |
| | “SecurityQuestionFailed”, 0743, “[0743] <text describing the system error>” |
| | “UnexpectedError”, 0799, “[0799] <text describing the system error>” |
| | Sample XML response: |
| | <NewDataSet> |
| | <Table> |
| | <passwordquestion>Place of Birth</passwordquestion> |
| | </Table> |
| | </NewDataSet> |
| | Sample JSON response: |
| | { “NewDataSet”: { “Table”: [ {“passwordquestion”: “Place of Birth” } ] }} |
| | <NewDataSet> |
| | <Table> |
| | <error>errorcode</error> |
| | <message>error message text</message> |
| | </Table> |
| | </NewDataSet> |
| | 8. *Password Recovery via an email |
| | The user may need to recover their password. This API requires the user to |
| | verify their account by answering the security challenge they provided on account |
| | registration. In response, the service sends successful status or an error with a reason |
| | description to provide feedback to the user. For this API, the user will receive an email |
| | with the new password. The API does not allow the password to be returned outside of |
| | the email delivery method. Defined in YoicsLib.m |
| | URL: |
| | http://www.yoics.net/web/api/user.ashx?key=<key>&email=<email>&answer=<answer> |
| | >&apilevel=<apilevel>&action=recoverpassword |
| | + (void)passwordRecoveryWithEmail:(NSString*)email |
| | answer:(NSString*)answer |
| | success:(void (\hat{ })(NSDictionary *response))success |
| | failure:(void (\hat{ })(NSError *error))failure |
| | Example: |
| | [[YoicsLib sharedYoicsLib] passwordRecoveryWithEmail:_txtEmail.text |
| | answer:[_txtAnswer.text lowercaseString] |
| | success:\hat{ }(NSDictionary *response) { |
| | <some-code-for-success> |
| | } |
| | failure:\hat{ }(NSError *error) { |
| | <some-code-for-failure> |
| | }]; |
| | Parameters: |
| | Registered Email (email) - Hexascii String value - represents the users |
| | registered email address |
| | Security Answer (answer) - Hexascii String value - represents the answer to |
| | the registered security question. |
| | Return Value(s): |
| | Response - String value - shows text status for failures or shows detailed |
| | information in XML format. |
| | Email - user will receive an email with further instructions on their new |
| | password. |
| | Possible error codes& messages include ... |
| | “PasswordFailed”, 0732, “[0732] Unknown email address” |
| | “PasswordFailed”, 0733, “[0733] API key is required” |
| | “PasswordFailed”, 0734, “[0734] text describing the system error>” |
| | “UnexpectedError”, 0799, “[0799] <text describing the system error>” |
| | Sample XML response: |
| | <NewDataSet> |
| | <Table> |
| | <status>ok</status> |
| | <password>new password here</password> {Optional based on skipemail} |
| | </NewDataSet> |
| | Sample JSON response: |
| | { “NewDataSet”: { “Table”: [ {“passwordquestion”: “Place of Birth” } ] }} |
| | <NewDataSet> |
| | <Table> |
| | <error>errorcode</error> |
| | <message>error message text</message> |
| | </Table> |
| | </NewDataSet> |
| | 9. *Get Friends Device List |
| | The client will need device information to properly share or view devices. The |
| | Get Devices message provides methods to get user owner devices, friends devices, |
| | and devices of specific types (such as cameras). |
| | To get list of friend's devices shared with current user this API must be used. |
| | Described in YoicsLib.m |
| | URL: |
| | http://test.yoics.net/web/api/getdevices.ashx?token=<token>&filter=<filter>&whose= |
| | <whose>&state=<state>&type=<type> |
| | − (void)getFriendsDevicesUsingBlockWithFilter:(NSString*)filter |
| | success:(void (\hat{ })(NSMutableArray *response))success |
| | failure:(void (\hat{ })(NSError *error))failure; |
| | Example: |
| | [[YoicsLib sharedYoicsLib] getFriendsDevicesUsingBlockWithFilter:@“all” |
| | success:\hat{ }(NSMutableArray *response) { |
| | <some-code-for-success> |
| | } |
| | failure:\hat{ }(NSError *error) { |
| | <some-code-for-failure> |
| | }]; |
| | Return Value(s): |
| | TBD |
| | 10. *Get My Device List |
| | To get the list of devices owned by a user this API must be used. Defined in |
| | YoicsLib.m |
| | URL: |
| | http://test.yoics.net/web/api/getdevices.ashx?token=<token>&filter=<filter>&whose= |
| | <whose>&state=<state>&type=<type> |
| | − (void)getMyDevicesUsingBlockWithFilter:(NSString*)filter |
| | success:(void (\hat{ })(NSMutableArray *response))success |
| | failure:(void (\hat{ })(NSError *error))failure; |
| | Example: Lists all the devices owned/registered by the user |
| | [[YoicsLib sharedYoicsLib] getMyDevicesUsingBlockWithFilter:@“all” |
| | success:\hat{ }(NSMutableArray *response) { |
| | <some-code-for-success> |
| | } |
| | failure:\hat{ }(NSError *error) { |
| | <some-code-for-failure> |
| | }]; |
| | Return Value(s): |
| | Device Information - String value |
| | <NewDataSet> |
| | <Table> |
| | <owneruserid>internal user ID for the device owner</owneruserid> |
| | <ownerusername>device owner's username</ownerusername> |
| | <devicetype>encoded device info string - see notes below</devicetype> |
| | <deviceaddress>unique ID for the device</deviceaddress> |
| | <devicelastip>last secured public IP and port</devicelastip> |
| | <lastcontacted>timestamp - see notes below</lastcontacted> |
| | <devicealias>Astak Mole</devicealias> |
| | <devicestate>active</devicestate> |
| | <encryptionflag>3</encryptionflag> |
| | <serverencryption>1</serverencryption> |
| | <minimumencryption>1</minimumencryption> |
| | <isglobal>0</isglobal> |
| | <laststatechanged>2010-06-01T11:09:30.64-07:00</laststatechanged> |
| | <applicationid>2</applicationid> |
| | <Column1>Tunnel</Column1> |
| | <lastinternalip>192.168.1.92:2061</lastinternalip> |
| | <webenabled>1</webenabled> |
| | <mobileenabled>1</mobileenabled> |
| | <sslenabled>0</sslenabled> |
| | <sslproxy>0</sslproxy> |
| | <weburi /> |
| | <mobileuri /> |
| | <addreturnurl>0</addreturnurl> |
| | <servicetitle>Camera Viewer</servicetitle> |
| | <webviewerurl /> |
| | <accesslevel>change</accesslevel> |
| | <CreateDate>2010-02-01T13:09:05.587-08:00</CreateDate> |
| | <manufacturer>Astak</manufacturer> |
| | </Table> |
| | </NewDataSet> |
| | NOTE: |
| | Encoded Device Info: Hexascii Encoded - Octet 0-1 is the Yoics service type. |
| | Octet 2-3 is the manufacturer code. Remaining octets are device specific. |
| | Timestamp - Formatted as 2010-06-01T11:09:30.64-07:00 |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | Possible error codes& messages include ... |
| | “InvalidToken”, 0301, “[0301] The Yoics API token is invalid or expired” |
| | “InvalidMessage”, 0302, “[0302] Invalid API message requested” |
| | “UnexpectedError”, 0399, “[0399] <text describing the system error>” |
| | Sample XML response: |
| | <NewDataSet> |
| | <Table> |
| | <owneruserid>E939F3C6-3B59-471F-8703-521DD58B7293</owneruserid> |
| | <ownerusername>doug</ownerusername> |
| | <devicetype>00:13:00:09:00:01:00:03:04:06:01:00</devicetype> |
| | <deviceaddress>00:00:00:25:07:00:15:19</deviceaddress> |
| | <devicelastip>76.215.57.198:2061</devicelastip> |
| | <lastcontacted>2010-06-01T11:09:30.64-07:00</lastcontacted> |
| | <devicealias>Astak Mole</devicealias> |
| | <devicestate>active</devicestate> |
| | <encryptionflag>3</encryptionflag> |
| | <serverencryption>1</serverencryption> |
| | <minimumencryption>1</minimumencryption> |
| | <isglobal>0</isglobal> |
| | <laststatechanged>2010-06-01T11:09:30.64-07:00</laststatechanged> |
| | <applicationid>2</applicationid> |
| | <Column1>Tunnel</Column1> |
| | <lastinternalip>192.168.1.92:2061</lastinternalip> |
| | <webenabled>1</webenabled> |
| | <mobileenabled>1</mobileenabled> |
| | <sslenabled>0</sslenabled> |
| | <sslproxy>0</sslproxy> |
| | <weburi /> |
| | <mobileuri /> |
| | <addreturnurl>0</addreturnurl> |
| | <servicetitle>Camera Viewer</servicetitle> |
| | <webviewerurl /> |
| | <accesslevel>change</accesslevel> |
| | <CreateDate>2010-02-01T13:09:05.587-08:00</CreateDate> |
| | <manufacturer>Astak</manufacturer> |
| | </Table> |
| | </NewDataSet> |
| | Sample JSON response: |
| | { “NewDataSet”: { “Table”: [ {“accesslevel”: “change”, “addreturnurl”: “0”, |
| | “applicationid”: “2”, “Column1”: “Tunnel”, “CreateDate”: “2010-10- |
| | 08T09:16:59.773-07:00”, “deviceaddress”: “00:FC:30:B1:E0:34:CD:08”, |
| | “devicealias”: “My Web Cam”, “devicelastip”: “76.215.57.198:2161”, |
| | “devicestate”: “active”, “devicetype”: “00:12:00:00:00:1B:00:6B:00:02”, |
| | “encryptionflag”: “3”, “isglobal”: “0”, “lastcontacted”: “2010-10- |
| | 18T13:32:31.54-07:00”, “lastinternalip”: “192.168.1.84:2161”, |
| | “laststatechanged”: “2010-10-18T13:32:31.54-07:00”, “manufacturer”: “Yoics |
| | Inc”, “minimumencryption”: “1”, “mobileenabled”: “1”, “mobileuri”: [ null ], |
| | “owneruserid”: “AAAAAAAA-BBBB-1111-AAAA-46FE31191A36”, “ownerusername”: |
| | “another”, “proxystate”: “none”, “serverencryption”: “1”, “servicetitle”: |
| | “Camera Folder”, P10 “sslenabled”: “0”, “sslproxy”: “1”, “webenabled”: “1”, |
| | “weburi”: [ null ], “webviewerurl”: “192.168.1.84:8111” } ] }} |
| | 11. *Device Sharing |
| | The client will want to change sharing settings for specific devices. Users can |
| | share devices with Yoics and non-Yoics users either 1) using direct sharing with Yoics |
| | users 2) using Guest Passes from a Pro user to another non-Yoics user or 3) using |
| | email invitations to join Yoics and get access. Once shared, the sharing can remain |
| | indefinitely or can expire when using Guest Passes for Pro users. |
| | This API enables that feature.Defined in YoicsLib.m |
| | URL: |
| | http://www.yoics.net/web/api/sharing.ashx?token=<token>&state=<state>&deviceaddress= |
| | <deviceaddress>&email=<email>&guestpass=true&expiration=<expires>&code=<password> |
| | − (void)deviceSharingWithToken:(NSString*)token |
| | deviveAddress:(NSString*)deviceAddress |
| | state:(NSString*)state |
| | email:(NSString*)email |
| | guestpass:(BOOL)guestpass |
| | expiration:(NSString*)expires |
| | code:(NSString*)code |
| | success:(void (\hat{ })(NSDictionary *response))success |
| | failure:(void (\hat{ })(NSError *error))failure; |
| | Example: [[YoicsLib sharedYoicsLib] deviceSharingWithToken:token |
| | deviveAddress:deviceUIDstate:on |
| | email:“myfriend@gmail.com” |
| | guestpass:NO |
| | expiration:@“” |
| | code:@“” |
| | success:\hat{ }(NSDictionary * response) |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Sharing State (state) - String value - represents whether sharing is being |
| | added or removed. Possible values are “on” or “off”. |
| | Device Address (deviceaddress) - String value - represents the device |
| | address for the requested device, as obtained from the detailed device information |
| | returned from the Get device message. |
| | Shared Email (email) - Hexascii String value - represents the users email |
| | who's having (or had) a device shared with them. |
| | Guest Pass (guestpass) - String value - indicates sharing should be done |
| | using a Guest Pass (true or false) |
| | Guest Pass Expiration (expires) - String value - represents the number of |
| | hours before the guest pass expires. |
| | NOTE: Asterisk (*) is ‘Until Deleted’ and Zero (0) is ‘One Time’. |
| | Guest Pass Password (code) - Hexascii String value - represents a security |
| | code the user must provide when using a guest pass. |
| | Return Value(s): |
| | Sharing Status - String value - represents the status of the sharing message. |
| | Possible values are “Ok”. |
| | Possible error codes& messages include ... |
| | “InvalidToken”, 0501, “[0501] The Yoics API token is invalid or expired” |
| | “InvalidDevice”, 0502, “[0502] ] <deviceaddress> is an unknown device for |
| | <username>” |
| | “InvalidAccount”, 0503, “[0503] Guest Pass features require upgraded account” |
| | “InvalidAccount”, 0504, “[0504] User ‘<email>’ was not found” |
| | “InvalidAccount”, 0505, “[0505] User ‘<email>’ was not found” |
| | “InvalidAccount”, 0506, “[0506] User ‘<email>’ is not registered” |
| | “SharingLimit”, 0510, “[0510] “Sharing is limited to ‘n’ users” |
| | “UnexpectedError”, 0599, “[0599] <text describing the system error>” |
| | 12. *Get Sharing |
| | The client can get a list of users currently being shared a specific device. This |
| | sharing list allows the client to add or remove users from the sharing list. |
| | Defined in YoicsLib.m |
| | URL: |
| | http://www.yoics.net/web/api/getsharing.ashx?token=<token>&device=<deviceaddress> |
| | + (void)getSharingWithToken:(NSString*)token |
| | ofDevice:(NSString*)deviceAddress |
| | success:(void (\hat{ })(NSDictionary *response))success |
| | failure:(void (\hat{ })(NSError *error))failure; |
| | Example: |
| | [[YoicsLib sharedYoicsLib] getSharingWithToken:token |
| | ofDevice:deviceAddress/UID |
| | success:\hat{ }(NSDictionary * resp onse){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device |
| | address for the requested device, as obtained from the detailed device information |
| | returned from the Get Device message. |
| | Return Value(s): |
| | Sharing Information - String value - shows text status for failures or shows |
| | detailed information in XML format. |
| | Possible error codes& messages include ... |
| | “InvalidToken”, 0601, “[0601] The Yoics API token is invalid or expired” |
| | “InvalidRequest”, 0611, “[0611] Guest pass failed verification. |
| | “UnexpectedError”, 0699, “[0699] <text describing the system error>” |
| | Sample XML response: |
| | <NewDataSet> |
| | <Table> |
| | <UserName>another</UserName> |
| | <accesslevel>view \| change \| guest </accesslevel> |
| | <userid>EE4DCA34-AAAA-1111-BBBB-46FE31191A36 </userid> |
| | <Email>another@gmail.com</Email> |
| | <expires>9999/12/31 23:59:59</expires> |
| | <authcode xml:space=“preserve”></authcode> |
| | </Table> |
| | </NewDataSet> |
| | Sample JSON response: |
| | TBS |
| | 13. *Change Email / Usernname |
| | The user may need to change the email address associated with their |
| | account. In response, the service sends successful status or an error with a reason |
| | description to provide feedback to the user. |
| | Defined in ServerCallYoicsAPI.m |
| | URL: |
| | http://www.yoics.net/web/api/user.ashx?token=<token>&newemail=<email>&action=changeemail |
| | + (void)changeEmailWithToken:(NSString*)token |
| | newEmail:(NSString*)newEmail |
| | success:(void (\hat{ })(NSDictionary *response))success |
| | failure:(void (\hat{ })(NSError *error))failure; |
| | Example: |
| | [ServerCallYoicsAPI changeEmailWithToken: token |
| | newEmail: “NewEmail@gmail.com” |
| | success:\hat{ }(NSDictionary * response){ |
| | <some-code-for-success> |
| | } |
| | failure:\hat{ }(NSError *error) { |
| | <some-code-for-failure> |
| | }]; |
| | Return Value(s): |
| | Response - String value - shows text status for failures or shows detailed |
| | information in XML format. |
| | Possible error codes& messages include ... |
| | “InvalidToken”, 0701, “[0701] The Yoics API token is invalid or expired” |
| | “FailedEmail”, 0720, “[0720] <email> is not unique” |
| | “FailedEmail”, 0721, “[0721] <text describing the system error>” |
| | “UnexpectedError”, 0799, “[0799] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | <NewDataSet> |
| | <Table> |
| | <error>errorcode</error> |
| | <message>error message text</message> |
| | </Table> |
| | </NewDataSet> |
| | 14. *Change Password |
| | The user may need to change the password associated with their account. In |
| | response, the service sends successful status or an error with a reason description to |
| | provide feedback to the user. Defined in YoicsLib.m |
| | URL: |
| | http://www.yoics.net/web/api/user.ashx?token=<token>&oldpassword=<oldpassword> |
| | &newpassword=<newpassword>&action=changepassword |
| | −(void)changePasswordWithToken:(NSString*)token |
| | oldPwd:(NSString*)oldPassword |
| | newPwd:(NSString*)newPassword |
| | success:(void (\hat{ })(NSDictionary* response))success |
| | failure:(void (\hat{ })(NSError *))failure; |
| | Example: [[YoicsLib sharedYoicsLib] changePasswordWithToken: token |
| | oldPwd: oldSecret |
| | newPwd: newSecret |
| | success:\hat{ }(NSDictionary * response){ |
| | <some-code-for-success> |
| | } |
| | failure:\hat{ }(NSError *error) { |
| | <some-code-for-failure> |
| | } |
| | Parameter(s): |
| | Yoics Login Token (token) - String value - represents the Login Token for |
| | authentication. |
| | Old Password (oldpassword) - Hexascii String value - represents a current |
| | account password. |
| | New Password (newpassword) - Hexascii String value - represents a new |
| | account password. |
| | Return Value(s): |
| | Response - String value - shows text status for failures or shows detailed |
| | information in XML format. |
| | Possible error codes& messages include ... |
| | “InvalidToken”, 0701, “[0701] The Yoics API token is invalid or expired” |
| | “PasswordFailed”, 0731, “[0731] Problem confirming password change” |
| | “PasswordFailed”, 0734, “[0734] <message>” |
| | “UnexpectedError”, 0799, “[0799] <text describing the system error>” |
| | Sample XML response: |
| | <NewDataSet> |
| | <Table> |
| | <status>ok</status> |
| | <authhash>Users authentication hash for future login calls</authhash> |
| | </Table> |
| | </NewDataSet> |
| | Sample JSON response: |
| | { “NewDataSet”: { “Table”: [ {“status”: “ok” } ] }} |
| | <NewDataSet> |
| | <Table> |
| | <error>errorcode</error> |
| | <message>error message text</message> |
| | </Table> |
| | </NewDataSet> |
| | 15. **Remove a Device |
| | User may use this API to remove a particular device from the list of available |
| | devices. |
| | Defined in YoicsLib.m |
| | Here Token is not necessary. |
| | − (void)removeDeviceFromMyListDevice:(NSString*)uidDevice; |
| | Example: |
| | [[YoicsLib sharedYoicsLib] removeDeviceFromMyListDevice: |
| | DeviceUID/DeviceAddress]; |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “DeleteFailed”, 0860, “[0860] An exception occurred - <message>” |
| | “DeleteFailed”, “No device address was specified” |
| | “GetDeviceFailed”, 0861, “[0861] <deviceaddress> is an unknown device for this |
| | user” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 16. **Reset All Devices |
| | User may want to Reset all the devices List known to him. It clears the device |
| | list. |
| | Defined in YoicsLib.m |
| | (void)resetAllListDevices; |
| | Example: [[YoicsLib sharedYoicsLib] resetAllListDevices]; |
| | 17. ** Create A New Device |
| | The client registers a new device with the Yoics service. New devices are |
| | easily added by sending the device id and device name for an already active and |
| | unregistered device. In response, the service sends successful status or an error with |
| | a reason description to provide feedback to the user. |
| | Defined in ServerCallYoicsAPI.m |
| | URL: |
| | http://www.yoics.net/web/api/device.ashx?token=<token>&deviceaddress= |
| | <deviceaddress&devicetype=<type>&action=create |
| | + (void)createDeviceWithToken:(NSString*)token |
| | deviceAddress:(NSString*)deviceAddress |
| | withDeviceType:(int)deviceType |
| | success:(void (\hat{ })(NSDictionary *response))success |
| | failure:(void (\hat{ })(NSError *error))failure; |
| | Example: [ServerCallYoicsAPI createDeviceWithToken: token |
| | deviceAddress: deviceAddress/deviceUID |
| | withDeviceType: DeviceType |
| | success:\hat{ }(NSDictionary * response){ |
| | <some-code-for-success> |
| | } |
| | failure:\hat{ }(NSError *error) { |
| | <some-code-for-failure> |
| | } |
| | Parameter(s): |
| | Yoics Login Token (token) - String value - represents the Login Token for |
| | authentication. |
| | Device Address (deviceaddress) - String value - represents the device |
| | address for the requested device. |
| | Device Type (devicetype) - Hexascii String value - represents the encoded |
| | device type for the requested device. |
| | This must be provided by Yoics for each production device type. |
| | Return Value(s): |
| | Response - String value - shows text status for failures or shows detailed |
| | information in XML format. |
| | Possible error codes& messages include ... |
| | “InvalidToken”, 0801, “[0801] The Yoics API token is invalid or expired” |
| | “CreateFailed”, 0870, “[0870] Error:<message>:” |
| | “CreateFailed”, 0871, “[0871] Error: API Key not authorized for this function:” |
| | “CreateFailed”, 0872, “[0872] Error: API Key does not match device |
| | manufacturer:” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follows: |
| | <NewDataSet> |
| | <Table> |
| | <error>errorcode</error> |
| | <message>error message text</message> |
| | </Table> |
| | </NewDataSet> |
| | 18. *Register Device |
| | The client registers a new device with the Yoics service. New devices are |
| | easily added by sending the device id and device name for an already active and |
| | unregistered device. In response, the service sends successful status or an error with |
| | a reason description to provide feedback to the user. |
| | Defined in ServerCallYoicsAPI.m |
| | URL: |
| | http://www.yoics.net/web/api/device.ashx?token=<token>&deviceaddress= |
| | <deviceaddress>&alias=<devicename>&skipreset=<flag>&action=register |
| | + (void)registerDeviceWithToken:(NSString*)token |
| | deviceAddress:(NSString*)deviceAddress |
| | deviceAlias:(NSString*)deviceAlias |
| | success:(void (\hat{ })(NSDictionary *response))success |
| | failure:(void (\hat{ })(NSError *error))failure; |
| | Example: [ ServerCallYoicsAPI registerDeviceWithToken: token |
| | deviceAddress: deviceAddress |
| | deviceAlias: deviceAlias |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device |
| | address for the requested device. |
| | Device Name (alias) - Hexascii String value - represents the device name for |
| | the requested device. |
| | Return Value(s): |
| | Response - String value - shows text status for failures or shows detailed |
| | information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “InvalidName”, 0803, “[0803] The device name is missing” |
| | “RegistrationFailed”, 0804, “[0804] Error:FailedToGetNewSecret:” |
| | “RegistrationFailed”, 0805, “[0805] Error:UpdateSecretFailed:” |
| | “RegistrationFailed”, 0806, “[0806] Error:DeviceNotFound:” |
| | “RegistrationFailed”, 0807, “[0807] Error:DuplicateName:” |
| | “RegistrationFailed”, 0808, “[0808] Error:DuplicateAddress:” |
| | “RegistrationFailed”, 0809, “[0809] Error:MissingArguments:” |
| | “RegistrationFailed”, 0810, “[0810] Error:RegistrationException:<message>” |
| | “RegistrationFailed”, 0811, “[0811] Error:RegistrationTemporarilyDisabled:” |
| | “UnexpectedError”, 0899, “[0899] <text describing the system error>” |
| | Sample XML response: |
| | <NewDataSet> |
| | <Table> |
| | <secret><sharedsecretstring></secret> |
| | </Table> |
| | </NewDataSet> |
| | Sample JSON response: |
| | { “NewDataSet”: { “Table”: [ {“secret”: “<shared secret string>” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 19. * Get Device |
| | The client registers / gets information about an existing device with the Yoics |
| | service. In response, the service sends successful status or an error with a reason |
| | description to provide feedback to the user. |
| | Defined in ServerCallYoicsAPI.m |
| | URL: |
| | http://www.yoics.net/web/api/device.ashx?token=<token>&deviceaddress= |
| | <deviceaddress>&action=get |
| | + (void)getDeviceWithToken:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ ServerCallYoicsAPI getDeviceWithToken: token |
| | deviceAddress: deviceAddress |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device address |
| | for the requested device. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “GetDeviceFailed”, 0820, “[0820] Invalid Device or the current user does not own |
| | the device.” |
| | “GetDeviceFailed”, 0821, “[0821] <deviceaddress> is an unknown device for this |
| | user” |
| | “UnexpectedError”, 0899, “[0899] <text describing the system error>” |
| | Sample XML response: |
| | <NewDataSet> |
| | <Table> |
| | <owneruserid>EE4DCA34-AAAA-1111-BBBB-46FE31191A36</owneruserid> |
| | <devicetype>00:00:00:03:00:02:00:00:04:01:FF:BF</devicetype> |
| | <deviceaddress>00:00:00:1B:FE:00:3F:A4</deviceaddress> |
| | <lastcontacted>2010-09-01T20:50:22.627-07:00</lastcontacted> |
| | <devicestate>inactive</devicestate> |
| | <webviewerurl /> |
| | <clientdownload /> |
| | <viewerregistrationurl /> |
| | <secured>0</secured> |
| | <supportsudp>1</supportsudp> |
| | <udpport>0</udpport> |
| | <supportstcp>0</supportstcp> |
| | <chatserverport>0</chatserverport> |
| | <supportsreflector>0</supportsreflector> |
| | <enabled>1</enabled> |
| | <chatserver /> |
| | <securitykey>11:22:AA:BB:C8:ED:1E:71:A4:C4:30:F8:81:5A:C1:7D:B1:A8:37:B6 |
| | </securitykey> |
| | <devicelastip>76.215.57.198:1027</devicelastip> |
| | <devicealias>Lorex Viewer</devicealias> |
| | <serverencryption>1</serverencryption> |
| | <encryptionflag>3</encryptionflag> |
| | <minimumencryption>1</minimumencryption> |
| | <isglobal>0</isglobal> |
| | <laststatechanged>2010-09-01T20:50:22.627-07:00</laststatechanged> |
| | <lastinternalip>192.168.1.73:1027</lastinternalip> |
| | <nonce /> |
| | <ownerusername>another</ownerusername> |
| | <webenabled>1</webenabled> |
| | <mobileenabled>1</mobileenabled> |
| | <sslenabled>0</sslenabled> |
| | <sslproxy>1</sslproxy> |
| | <weburi /> |
| | <mobileuri /> |
| | <addreturnurl>0</addreturnurl> |
| | <servicetitle>Camera Viewer</servicetitle> |
| | <CreateDate>2010-09-01T14:12:04.957-07:00</CreateDate> |
| | <manufacturer>Lorex Technology Inc.</manufacturer> |
| | <lastsecuritykey>11:22:AA:BB:C8:ED:1E:71:A4:C4:30:F8:81:5A:C1:7D:B1:A8:37:B6 |
| | </lastsecuritykey> |
| | <dirtysecuritykey>0</dirtysecuritykey> |
| | <alertFlag>false</alertFlag> |
| | </Table> |
| | </NewDataSet> |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 20. *Rename Device |
| | The client can rename any device owned by the current authenticated user. |
| | In response, the service sends successful status or an error with a reason description to |
| | provide feedback to the user. |
| | Defined in YoicsLib.m |
| | URL: |
| | http://www.yoics.net/web/api/device.ashx?token=<token>&deviceaddress=<deviceaddress> |
| | &alias=<devicename>&action=rename |
| | − (void)renameDeviceWithToken:(NSString *)token |
| | deviceAddress:(NSString *)deviceAddress |
| | newAlias:(NSString *)newAlias |
| | success:(void (\hat{ })(NSDictionary* response))success |
| | failure:(void (\hat{ })(NSError *))failure; |
| | Example: [[YoicsLib sharedYoicsLib] renameDeviceWithToken: token |
| | deviceAddress: deviceAddress |
| | newAlias: NewDeviceName |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameter(s): |
| | Yoics Login Token (token) - String value - represents the Login Token for |
| | authentication. |
| | Device Address (deviceaddress) - String value - represents the device |
| | address for the requested device. |
| | Device Name (Newalias) - Hexascii String value - represents the new device |
| | name for the requested device. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “RenameFailed”, 0830, “[0830] Invalid Device or the current user does not own |
| | the device.” |
| | “RenameFailed”, 0831, “[0831] No alias (new name) was specified.” |
| | “RenameFailed”, 0832, “[0832] Failed to set new name.” |
| | “RenameFailed”, 0833, “[0833] Duplicate alias (new name) was specified.” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 21. * Transfer Device |
| | The client can transfer ownership of any owned device to another registered |
| | user. In response, the service sends successful status or an error with a reason |
| | description to provide feedback to the user. |
| | Defined in ServerCallYoicsAPI.m |
| | URL: |
| | http://www.yoics.net/web/api/device.ashx?token=<token>&deviceaddress= |
| | <deviceaddress>&newuser=<newuser>&action=transfer |
| | + (void)transferDeviceToUser:(NSString*)NewUser |
| | token:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ ServerCallYoicsAPI transferDeviceToUser: NewUser]; |
| | Parameter(s): |
| | Yoics Login Token (token) - String value - represents the Login Token for |
| | authentication. |
| | Device Address (deviceaddress) - String value - represents the device |
| | address for the requested device. |
| | New Email (newuser) - Hexascii String value - represents the registered email |
| | for the new device owner. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “TransferFailed”, 0840, “[0840] No new user was specified.” |
| | “TransferFailed”, 0841, “[0841] Invalid Device or the current user does not |
| | own the device.” |
| | “TransferFailed”, 0842, “[0842] The specified user does not exist.” |
| | “TransferFailed”, 0843, “[0843] The specified user already has a device named |
| | <name>.” |
| | “TransferFailed”, 0844, “[0844] Failed to change the device ownership.” |
| | “TransferFailed”, 0845, “[0845] Ownership changed but access could not be |
| | reset.” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 22. *Reset Secret Device |
| | The client may need to reset the security secret for any device they own. The |
| | device should be active when this API is used or the device may become unuseable. |
| | In response, the service sends successful status or an error with a reason description to |
| | provide feedback to the user. Defined in ServerCallYoicsAPI.m |
| | URL: |
| | http://www.yoics.net/web/api/device.ashx?token=<token>&deviceaddress=<deviceaddress> |
| | &action=resetsecret |
| | + (void)resetSecretDeviceWithToken:(NSString*)token |
| | deviceAddress:(NSString*)deviceAddress |
| | success:(void (\hat{ })(NSDictionary *response))success |
| | failure:(void (\hat{ })(NSError *error))failure; |
| | Example: [ ServerCallYoicsAPI resetSecretDeviceWithToken: <list of args as |
| | specified above>]; |
| | deviceAddress: DevicdAddress/UID |
| | success:\hat{ }(NSDictionary * response){ |
| | <some-code-for-success> |
| | } |
| | failure:\hat{ }(NSError *error) { |
| | <some-code-for-failure> |
| | }]; |
| | Parameters: |
| | Yoics Login Token (token) - String value - represents the Login Token for |
| | authentication. |
| | Device Address (deviceaddress) - String value - represents the device |
| | address for the requested device. |
| | Return Value(s): |
| | Registration Response - String value - shows text status for failures or shows |
| | detailed information in XML format. |
| | Possible error codes& messages include ... |
| | “InvalidToken”, 0801, “[0801] The Yoics API token is invalid or expired” |
| | “InvalidDevice”, 0802, “[0802] The device address is missing” |
| | “ResetFailed”, 0850, “[0850] Invalid Device or the current user does not own |
| | the device.” |
| | “InvalidDevice”, 0851, “[0851] <deviceaddress> is not active.” |
| | “ResetFailed”, 0852, “[0852] Secret could not be changed” |
| | “ResetFailed”, 0853, “[0853] <text describing the system error>” |
| | “UnexpectedError”, 0899, “[0899] <text describing the system error>” |
| | Sample XML response: |
| | <NewDataSet> |
| | <Table> |
| | <status>ok</status> |
| | </Table> |
| | </NewDataSet> |
| | Sample JSON response: |
| | { “NewDataSet”: { “Table”: [ {“status”: “ok” } ] }} |
| | Get Device response is a detailed record of the device. Examples included below. |
| | If an error occurs, the response will be as follow: |
| | <NewDataSet> |
| | <Table> |
| | <error>errorcode</error> |
| | <message>error message text</message> |
| | </Table> |
| | </NewDataSet> |
| | 23. **Remove Device From Friends Device List |
| | Client may request to remove a device from a list of available devices for a |
| | particular shared user. |
| | Defined in YoicsLib.m |
| | − (void)removeDeviceFromMyFriendDevice:(NSString*)uidDevice]; |
| | Example: [[YoicsLib sharedYoicsLib] removeDeviceFromMyFriendDevice: |
| | uidDevice]; |
| | 24. **Get The List of Own Devices Available |
| | Client may request to know the list of devices available which he owns. They |
| | will be loaded from cache. |
| | Defined in YoicsLib.m |
| | −(void)getMyDevicesFromCache; |
| | Example: [[YoicsLib sharedYoicsLib] getMyDevicesFromCache ]; |
| | Return Value(s): |
| | TBD |
| | 25. **Get The List of Friends Devices Available |
| | Client may request to know the list of friend's devices available to him. They |
| | will be loaded from cache. |
| | Defined in YoicsLib.m |
| | −(void)getFriendDevicesFromCache; |
| | Example: [[YoicsLib sharedYoicsLib] getFriendDevicesFromCache ]; |
| | Return Value(s): |
| | TBD |
| | 26. ** Get The Handset IP Details |
| | Client may request to know the public ip and handset ip. Service request may |
| | respond with Public IP, Handset IP and Netmask on success and with proper error |
| | codes on failure. |
| | Defined in YoicsLib.m |
| | (I) − (void) getIpInformationWithSuccess:(void (\hat{ })(NSString* ip))success |
| | failure:(void (\hat{ })(NSError *error))failure; |
| | (ii) − (void) getIpInformation; |
| | Return Value(s): |
| | TBD |
| | 27. *Register Device Skip Secret With Token |
| | This enables a client to register a new device without a secret. Similar to |
| | Register device with ‘skipsecret ’ flag enabled. |
| | Defined in ServerCallYoicsAPI.m |
| | URL: |
| | http://www.yoics.net/web/api/device.ashx?token=<token>&deviceaddress= |
| | <deviceaddress>&alias=<devicename>&skipreset=true&action=register |
| | + (void)registerDeviceSkipSecretWithToken:(NSString*)token |
| | deviceAddress:(NSString*)deviceAddress |
| | deviceAlias:(NSString*)deviceAlias |
| | success:(void (\hat{ })(NSDictionary *response))success |
| | failure:(void (\hat{ })(NSError *error))failure; |
| | Return Value(s): |
| | Same as that for Register Device. |
| | 28. * Get Product Information |
| | Client may request to know the current product / Package information which |
| | he has subscribed to. Returns BASIC / PRO / DVRPLUS / DVRPREMIUM on success |
| | and Probably an error code on failure. |
| | Defined in YoicsLib.m |
| | − (void)getProductInformationSuccess:(void (\hat{ })(BOOL response))success; |
| | Return Value(s): |
| | TBD |
| | 29. *Get Manufacturer Details |
| | To check the manufacturer details of a particular device client may request |
| | with this API. |
| | Defined in YoicsLib.m |
| | −(void)getManufacturerWithsuccess:(void (\hat{ })(NSDictionary* response))success |
| | failure:(void (\hat{ })(NSError *))failure; |
| | Return Value(s): |
| | TBD |
| | 30. *Upgrade User Account |
| | Authorized API developers are allowed to perform in-app style purchases on |
| | behalf of their users and automatically notify the Yoics Service when a purchase or |
| | upgrade is completed. This process is required in order for Yoics to enable the |
| | premium services that get purchased within external applications. To have your |
| | developer account enabled for this feature, Yoics must be contacted to provision this |
| | feature. |
| | Note: For Apple iTunes purchases, the iTunes receipt must be sent in the |
| | transaction and authorization fields, unless otherwise agreed to with Yoics. All other |
| | fields should have valid values. |
| | Defined in YoicsLib.m |
| | URL: |
| | http://www.yoics.net/web/api/user.ashx?token=<token>&newplan=<newplan>&cost= |
| | <cost>&discount=<discount>&transaction=<transaction>&authorization=<authorization> |
| | &duration=<duration>&email=<email>&promotion=<promotion>&email=<emailflag> |
| | &apilevel=<apilevel>&action=upgrade |
| | (i) |
| | − (void)upgradeAccountWithTransaction:(NSString *)transaction |
| | authorization:(NSString *)authoriaztion |
| | price:(NSString*)price |
| | success:(void (\hat{ })(NSDictionary *response))success |
| | failure:(void (\hat{ })(NSError *error))failure; |
| | (ii) |
| | − (void)upgradeAccountWithTransaction:(NSString *)transaction |
| | authorization:(NSString *)authoriaztion |
| | packageInfo:(NSMutableDictionary *)packageInfo |
| | success:(void (\hat{ })(NSDictionary *response))success |
| | failure:(void (\hat{ })(NSError *error))failure; |
| | Parameter(s): |
| | Yoics Login Token (token) - String value - represents the Login Token for |
| | authentication. |
| | Plan Identifier (newplan) - String value - represents the unique service plan |
| | being purchased or upgraded. |
| | Cost (cost) - decimal value - represents the cost of the plan in USD currency. |
| | Discount (discount) - decimal value - represents the discount amount in USD |
| | currency. |
| | Service Duraton (duration) - integer value - represents the number of months |
| | the new plan is valid, from the date of purchase. |
| | Transaction ID (transaction) - Hexascii String value - represents the |
| | transaction ID for the purchase. |
| | Authorization Code (authorization) - Hexascii String value - represents the |
| | purchase authorization code for the purchase. |
| | Promotion Code (promotion) - String value - represents the promotion code |
| | that may have been used during the purchase to apply a discount. |
| | Email Indicator (emailflag) - String value - represents an indicator if Yoics |
| | should email a receipt to the user. By default the email is not sent when third party |
| | applications manage purchases. Values are ‘true’ or ‘false’ |
| | Yoics API Level (apilevel) - String value - represents the numeric version of |
| | the API the client uses. |
| | Return Value(s): |
| | Response - String value - shows text status for failures or shows detailed |
| | information in XML format. |
| | Possible error codes& messages include ... |
| | “InvalidToken”, 0701, “[0701] The Yoics API token is invalid or expired” |
| | “UpgradeError”, 0751, “[0751] User upgrades not allowed for this API” |
| | “UpgradeError”, 0752, “[0752] Service upgraded encountered unexpected error” |
| | “UpgradeError”, 0753, “[0753] Failed: Setup failed - duplicate transaction” |
| | “UpgradeError”, 0753, “[0753] Failed: Setup failed for unknown reason” |
| | “UpgradeError”, 0754, “[0754] Failed: Purchase delay exceeded by <minutes> |
| | for <transactionid>” |
| | “UpgradeError”, 0754, “[0754] “Failed: Transaction mismatch of |
| | <transactionid> for <transaction>” |
| | “UpgradeError”, 0754, “[0754] Failed: Product code mismatch <product> for |
| | <newplan> for <transaction>” |
| | “UpgradeError”, 0754, “[0754] Failed: Failed to parse receipt” |
| | “UpgradeError”, 0754, “[0754] Failed: Unknown reason” |
| | Sample XML response: |
| | <NewDataSet> |
| | <Table> |
| | <status>ok</status |
| | <note>Must perform API login to get new settings</note> |
| | </Table> |
| | </NewDataSet> |
| | Sample JSON response: |
| | { “NewDataSet”: { “Table”: [ {“status”: “ok” } ] }} |
| | <NewDataSet> |
| | <Table> |
| | <error>errorcode</error> |
| | <message>error message text</message> |
| | </Table> |
| | </NewDataSet> |
| | END |
| | *** Other API |
| | (I) getDevicesWithToken( ) - defined in ServiceCallYoicsAPI.m. This API is internally |
| | invoked in |
| | −getFriendsDevicesUsingBlockWithFilter( ) & getMyDevicesUsingBlockWithFilter( ). |
| | Both defined in YoicsLib.m |
| | (II) deleteDeviceWithToken( ) - defined in ServiceCallYoicsAPI.m and commented its |
| | wrapper in YoicsLib.m |
| | + (void)deleteDeviceWithToken:(NSString*)token |
| | deviceAddress:(NSString*)deviceAddress success:(void (\hat{ }) (NSDictionary |
| | *response))success failure:(void (\hat{ })(NSError *error))failure; |
| | (III) getProductMapSuccess( ) - defined in ServerCallYoicsAPI.m has been used in |
| | getProductInformationSuccess( ) in YoicsLib.m |
| | + (void)getProductMapSuccess:(void (\hat{ })(NSDictionary *response))success |
| | failure:(void (\hat{ })(NSError *error))failure; |
| | (IV) getPlanDescriptor( ) - defined in ServerCallYoicsAPI.m and used in |
| | getProductInformationSuccess( ) in YoicsLib.m |
| | + (void)getPlanDescriptor:(NSString *)plan success:(void (\hat{ })(NSDictionary |
| | *response))success failure:(void (\hat{ })(NSError *error))failure; |
| | (V) IogoutWithToken( ) - defined in ServerCallYoicsAPI.m used in logoutWithSuccess( ) |
| | in YoicsLib.m |
| | + (void)IogoutWithToken:(NSString*)token success:(void (\hat{ })(NSDictionary |
| | *response))success failure:(void (\hat{ })(NSError *error))failure; |
| | END Weaved and Yoics Service API Reference |

TABLE 2
P2P API

| Ref | Weaved and Yoics P2P API Reference | |
|---|---|---|
| | SCOPE | |
| | The Yoics IOS P2P library API is used by third- party applications to create | |
| | native peer to peer connections to Yoics enabled devices. | |
| | API ARCHITECTURE | |
| | The Yoics IOS P2P library API is an Objective-C class that interfaces to the | |
| | Yoics Core Library which is provided in binary form for both IOS hardware and | |
| | simulator. The API class methods are either synchronous or asynchronous depending | |
| | on the method. Asynchronous method calls are later responded to by a callback. | |
| | INSTALLATION | |
| | To use the library in your project you must first add the library binaries and | |
| | objective C wrapper into your project. Once they are added you must configure your | |
| | project to be able to use the library. | |
| | UNPACKING | |
| | In your project create a <project>\lib\yoics directory in your tree. Unpack the | |
| | Yoics IOS P2P library in this directory. Once unpacked you should have the | |
| | following files added to your tree: | |
| | <project>\lib\yoics\include\yoics_api.h | // Yoics library interface header |
| | files | |
| | <project>\lib\yoics\include\...h | |
| | <project>\lib\yoics\libyoics_lib_dev.a | // Yoics device library binary |
| | <project>\lib\yoics\libyoics_lib_sim.a | // Yoics simulator library binary |
| | <project>\lib\yoics\YoicsConnection.h | //Objective-C class wrapper for |
| | the yoics lib | |
| | <project>\lib\yoics\YoicsConnection.m | |
| | <project>\lib\yoics\NSString+HexValue.h | //Objective-C class for string to |

| hex value conversion | | |
|---|---|---|
| <project>\lib\yoics\NSString+HexValue.m | | |
| CONFIGURATION | | |
| Open the project in Xcode, from the Xcode menu select Project/Project | | |
| Settings. Select the Build tab. | | |
| In header search path put <project>\lib\yoics\include | | |
| In library search path put<project>\lib\yoics | | |
| In preprocessor macros put IOS | | |
| Add the resources to your project as shown: | | |
| FUNCTIONAL API | | |
| The Yoics IOS P2P library API provides methods to initialize, create and | | |
| shutdown Peer to Peer connections with Yoics devices. Yoics Peer to Peer connections | | |
| are the preferable method of creating connections to Yoics enabled devices as they | | |
| provide much better performance. A fallback method is to use the Yoics Proxy server | | |
| infrastructure as described in the Yoics Web Service API. | | |
| This API only provides Peer to Peer functionality; it knows nothing about | | |
| device directory services, permissions or sharing. The Yoics Web API can provide | | |
| this functionality and must be used to provide the correct device addresses for this | | |
| library. | | |
| The Class and Methods are in the file YoicsConnection.m, and this code can be | | |
| customized to provide added functionality. | | |
| 1. *Initiallization method | | |
| Before you can use the library you must initialize the class. Defined in | | |
| YoicsConnection.h | | |
| This will also internally allocate memory required for the yoics P2P connection. | | |
| [YoicsConnection theYoicsConnection]; | | |
| 2. *De-Initiallize Mehod | | |
| When your application closes, to clean up the Yoics Library cleanly you should | | |
| have the following code: (defined in YoicsConnection.h) | | |
| [[YoicsConnection theYoicsConnction] yoicsShutdown]; | | |
| [[YoicsConnection theYoicsConnction] yoicsPoolDestroy]; | | |
| It should be noted that “yoicsShutdown” can be called any time after a | | |
| yoicsInitialize, but yoicsPoolDestroy can only be called once and once called the Yoics | | |
| Library is dead and cannot be recovered without a software application restart. | | |
| 3. Yoics Service Connection Method | | |
| Before the library can provide a Peer to Peer connection it must be securely | | |
| attached/initialized to the Yoics service. This requires login credentials. The service | | |
| connection method takes a username and either a plane text password or an authash | | |
| (see the Yoics Web API document for information on authash). This service connection | | |
| is fully encrypted and protects any data between the library and the Yoics service. | | |
| To initiate a connection to the service the following method call example must | | |
| be used: | | |
| Defined in YoicsConnection.h | | |
| (i) -(S16)yoicsInitialize:(const char*)username | | |
| password:(const char*)password | | |
| authash:(BOOL)authash; | | |
| (ii) -(S16)yoicsInitialize:(const char*)username | | |
| password:(const char*)password | | |
| authash:(BOOL)authash | | |
| success:(void (\hat{ })(void))success | | |
| failure:(void (\hat{ })(void))failure; | | |
| Example: YoicsConnection *yoicsConn = [YoicsConnection | | |
| theYoicsConnection]; | | |
| [yoicsConn yoicsInitialize:[_username | | |
| cStringUsingEncoding:NSASCIIStringEncoding] | | |
| password:[_password | | |
| cStringUsingEncoding:NSASCIIStringEncoding] | | |
| authash:FALSE]; | | |
| The username is an ASCII encoded username, and the password can be | | |
| either an ASCII encoded password or an authash. Specify authash as TRUE if and | | |
| authash is password instead of a password. | | |
| If the method returned <0 then the service initialization did not start. | | |
| This connection method returns: | | |
| -1 if it is already initialized. | | |
| -2 if invalid username, password or authash | | |
| -3 if failed to allocate memory. | | |
| If the connection method returns >= 0 then the connection and initialization | | |
| has been started and final connection status will be returned by a callback, or by polling | | |
| the Yoics connection state. | | |
| 4. Yoics Connection Status | | |
| The current Yoics service initialization and connection status can be | | |
| determined by an asynchronous callback or by polling the connection state. | | |
| On a connection success the following callback will be called in | | |
| YoicsConnection.h | | |
| -(void)callYoicsServerConnectSuccess | | |
| { | | |
| [self _dispatchToDelegatesWithSel:@selector(yoicsServerConnectSuccess)]; | | |
| } | | |
| If the connection failed the following callback will be called in YoicsConnection.m | | |
| -(void)callYoicsServerConnectFailure | | |
| { | | |
| [self _dispatchToDelegatesWithSel:@selector(yoicsServerConnectFailure)]; | | |
| } | | |
| You may also poll the server state to determine if the connection state shows | | |
| connected as so: | | |
| If(yoicsConnection.serverState==5) printf(“Connected to Yoics Service\n”); | | |
| 5. Shutdown Method | | |
| If the connection has failed, the application is to shutdown, or the operator | | |
| wants to switch users, the shutdown method can be used to shut-down any P2P | | |
| connections and unattached the library from the Yoics Service. One this has been done | | |
| Yoics connection method can be reused. This method is synchronous. | | |
| Defined in YoicsConnection.h | | |
| [[YoicsConnection theYoicsConnction] yoicsShutdown]; | | |
| 6. Yoics Peer 2 Peer Connection Method - With DeviceAddress | | |
| To establish a Peer to Peer connection the yoicsP2PConnect2 method can be | | |
| called. It requires a Yoics device address retrieved from the Yoics Web API that the | | |
| account initialized and connected to via the library has access to. It also requires a port | | |
| to run the connection tunnel on, the RandomInt method can be used to generate a | | |
| random port number. | | |
| Defined in yoicsConnection.h | | |
| -(S16)yoicsP2PConnect2:(NSString *)address | | |
| port:(U16)port | | |
| connectionLimitInSecond:(int)timeLimit; | | |
| The method is an asynchronous method and status can be determined by a | | |
| callback or polling. The asynchronous callback will only work if the call has been | | |
| successful. The method returns >=0 if it was successful in initiating a P2P connection. | | |
| If there was an error one of the following codes will be returned: | | |
| -1 if the address is in a bad format or the P2P library is not initialized. | | |
| -2 if the P2P library is not connected to the Yoics service. | | |
| -3 if the P2P library does not have any more connection slots. | | |
| Example Peer to peer connection code, with Yoics Proxy Fallback: | | |
| if (yoicsConnect.serverState == 5) { | | |
| // Connect device via Yoics lib | | |
| [yoicsConnect yoicsP2PConnect2:self.deviceAddress | | |
| port:self.connectDeviceViaPort] | | |
| } else { | | |
| // Connect device via API web service | | |
| ... | | |
| } | | |
| Another Variant: | | |
| -(S16)yoicsP2PConnect2:(NSString *)address port:(U16)port | | |
| connectionLimitInSecond:(int)timeLimit | | |
| success:(P2PDeviceConnectionSuccess)success | | |
| failure:(P2PDeviceConnectionFailure)failure | | |
| close:(P2PDeviceConnectionClose)close | | |
| createSessionOK:(int *)sessionOK; | | |
| Above two methods are supported when deviceAddress are passed as NSString | | |
| Objects. | | |
| Below method is supported when the Device address is an array of Unsigned | | |
| characters. | | |
| -(S16)yoicsP2PConnect:(U8*)uid | | |
| port:(U16)port | | |
| connectionLimitInSecond:(int)timeLimit; | | |
| 7. Get Product Information with Product ID | | |
| Information to identify the type of product. Response may include an image of | | |
| a product and a video. Defined in DeviceConnection.h | | |
| + | | |
| (NSDictionary*)getInformationConnectionWithProductID:(NSString*)productID; | | |
| Example: [DeviceConnection getInformationConnectionWithProductID:prodID]; | | |
| 8. Subscribe to P2P Notifications | | |
| To subscribe to P2P notifications of Yoics library call this method. | | |
| Defined in LoginObject.h | | |
| It might be a kind of web login for P2P Connection. | | |
| -(id) initWithUsername:(NSString *)username | | |
| password:(NSString*)pwd | | |
| type:(int)type method:(int)method | | |
| Example: | | |
| LoginObject *login = [[LoginObject alloc] init ]; | | |
| [login initWithUsername:[_username | | |
| cStringUsingEncoding:NSASCIIStringEncoding] | | |
| password:[_password | | |
| cStringUsingEncoding:NSASCIIStringEncoding] | | |
| type:[_loginType LOGIN_PW/LOGIN_HASH] | | |
| method: [_methodCall SYNC_CALL/ASYNC_CALL]]; | | |
| Returns a “LoginObject”. | | |
| 9. Connect To The Server | | |
| After the web login succeeds, user must initialize / request to connect to the | | |
| server before establishing a P2P connection. Following call does it - Defined in | | |
| LoginObject.h | | |
| (void) p2pLogin; | | |
| Example: LoginObject *login = [[LoginObject alloc] init ]; | | |
| [login p2pLogin]; | | |
| 10. Get Random Port | | |
| Get a random port number, returns random port number. Defined in | | |
| YoicsConnection.h. | | |
| +(int) getRandomPort _yoicsConnectionPort = [YoicsConnection | | |
| getRandomPort] | | |
| 11. Disconnect a P2P Session | | |
| Defined in YoicsConnection.h | | |
| -(void)yoicsP2PDisconnect:(U16)sessionIndex; | | |
| Example: [yoicsConnect yoicsP2PDisconnect:<sessionIndex>]; | | |
| To destroy / disconnect all P2P sessions | | |
| -(void)yoicsP2PDestroyAllSession | | |
| Example: [yoicsConnect yoicsP2PDestroyAllSession]; | | |
| 12. Connect To A Device | | |
| To Connect to a remote device (running weavedConnectd) from an Application | | |
| / (Client Device), use this API. Defined in DeviceConnection.h. | | |
| It creates a peer-to-Peer connection within the specified timeLimit. | | |
| In case if it fails in that time limit, user does not login to P2P server it creates a | | |
| proxy connection with the device instead. | | |
| +(void)connectToDevice: (NSString*)deviceAddress | | |
| deviceType:(NSString*)deviceType | | |
| token:(NSString*)token | | |
| typeConnection:(int)typeConnection | | |
| expirationSec:(int)timeLimit | | |
| success:(DeviceConnectionSuccess)success | | |
| failure:(DeviceConnectionFailure)failure | | |
| destroy:(DeviceConnectionClose)destroy; | | |
| typeConnection - specifies if the connection must be only P2P / only proxy / a | | |
| standard Yoics connection. | | |
| Example: [Device Connection connectToDevice: <arguments as specified in | | |
| the defined above>]; | | |
| 13. Call back Methods | | |
| Call backs are executed whenever a server connection (or) a session (or) is | | |
| established or rejected. | | |
| Callback's are to be defined in the following format for server | | |
| connection(server_callback), session establishment(session_callback) and | | |
| proxy_connection(proxy_callback) events respectively. | | |
| Defined in YoicsConnection.h | | |
| S16 server_callback(U8 type, U16 address, U8 *data, U16 length); | | |
| S16 session_callback(U8 type, U8 *peer_uid, U8 *data, U16 session_index); | | |
| S16 proxy_callback(U16 type, S32 idex, U8 *data, U16 len); | | |
| Yoics Interface Methods | | |
| Following are the Yoics public interface API's defined in yoics_api.h | | |
| /*-----------------------------------------------------------------*/ | | |
| /* Server Specific API calls */ | | |
| /*-----------------------------------------------------------------*/ | | |
| 14. Yoics_connect | | |
| This method starts the yoics service. Accepts YOICS_CONFIG structure and a | | |
| server_callback. | | |
| Application Configuration parameters for Yoics Startup | | |
| typedef struct YCONFIG_ | | |
| { | | |
| U8 | *adapter; | // To get UID. |
| U8 | *in_uid; | // UID to use for this session (null is OK for PROXY, will |
| generate) | | |
| U8 | *serial_num; | // Serial Number to use (NULL is OK if no Serial |
| Number Support is needed, not used for proxy) | | |
| U8 | *yoicsid; | // Yoics ID for proxy connections, NULL for devices |
| U8 | *in_secret; | Secret, password for PROXY, or secret for device |
| // | | |
| U16 | app_type; | // Type of Application, maybe be overridden by platform |
| specific library | | |
| U16 | app_ver; | // Version of this Application |
| U16 | app_subversion; | // Subversion of this Application |
| U16 | manf_id; | // Manufacture ID - Must be set to get manufacture |
| specific portal behavior | | |
| U16 | platform_version; | // |
| U16 | max_depth; | // Max packet Queue depth per tunnel, may be |
| overridden by platform specific library | | |
| U16 | id_index; | // |
| U16 | encryption_support; | // |
| U16 | our_UDP_port; | // use if not upnp_port |
| U16 | port; | // |
| U16 | encryption_requested; // Requested Encription Level | |
| U16 | config_flags; | // Bitmap of Yoics Support to turn on |
| (CONFIG_BCASTER,CONFIG_UPNP,CONFIG_NATPNP,CONFIG_HASH_SECR | | |
| ET) | | |
| U16 | dest_port; | |
| U16 | upnp_port; | // UPNP port or NAT PMP port to use |
| U8 *upnp_idstr; | | // ID string for UPNP port forwarding. |
| IPADDR | localipf; | // Local IP address found before Yoics Initalization by |

```
UPNP/NATPMP.
  IPADDR  dest_ip;
  }YOICS_CONFIG;
The server callback is a user written function with the following format:
S16 server_callback(U8 type, U16 address, U8 *data, U16 length)
  S16 Yoics_connect(YOICS_CONFIG *, S16(*server_callback)(U8, U16, U8 *,
U16));
15.  Set Server
        Sets the target Yoics server, if default server list is not to be used.
        void Yoics_Set_Server(U8 *yoics_server, U16 port);
    param U8 *yoics_server - String describing the yoics server name or IP address
    param U16 port - Port to connect to on specified youcs server.
    Return -1 if yoics_server specified is bad.
    Return 0 if yoics server has been set.
16.  Get Current Server IP Address
        Gets the current connected Yoics Server IP address
        IPADDR Yoics_Get_Current_Server( );
        Returns current server ip.
17.  Get Current Server Port No
        U16 Yoics_Get_Current_Server_Port( );
      Returns the current connected Yoics Server port
18.  End Service
        Shuts down the Yoics service and cleans up any sessions and tunnels.
        S16Yoics_end_service(void);
      Returns 0 on success.
19.  Reconnect
        Forces the connection to the Yoics service to reconnect. Diagnotic and
testing function.
        S16 Yoics_reconnect(void);
      Returns 0 if reconnect was initiated.
20.  Server Connection State
        Returns the current server connection state or -1 if failed.
        S16 Yoics_Server_Connection_State(void);
21.  Session Initiallize
      Initialize the session request callback to accept sessions into a program
      S16 Yoics_Session_Init(S16(*callback)(U8,U8 *,U8*, U16));
    *callback  - pointer to callback that handles session connection events.
    Returns 0 is callback was set.
    The specified is used to handle session connection events
    S16 session_callback(U8 type, U8 *peer_uid, U8* data, U16 session_index);
22. Create Session
      Create a session with the target uid, must have previously called
Yoics_Session_Init to be successful. Needs UID of peer to initiate connection with.
        S16 Yoics_Session_create(U8 *uid);
    Returns 0 if initate packet was sent to server.
    This call is not reliable. Conformation of connection event will happen when
server sends connetion event with specified UID and information to previously initialized
callback inYoics_Session_Init.
23.  Destroy/Terminate Session
      Used to disconnect and destroy a session. Accepts session_index to
destroy/close as a parameter.
      S16 Yoics_Session_destroy(U16 session_index);
    Return -1 if no session found.
    Return 0 if destroy was successful
24.  Session Information
      Returns session information structure if session is found.
    S16 Yoics_Session_Info(U16 session_index, SESSION_INF *session_info);
    Return -1 if no session found.
    Return 0 if session info was returned.
25.  Session Shutdown
    Shuts down the session engine, cleans up any allocated memory
      void  Yoics_Session_shutdown(void);
26. Yoics Poll
      Process yoics protocol packets and other yoics housekeeping.
      S16Yoics_poll(U16 type);
    Param U16 type  - Type of poll call
      - 0 Normal poll, may block for up to 200 ms on accept for data, returns
quick on user selects.
    - 1 Quick poll, non-blocking returns as fast as yoics internal processing
can take place.
    - 2 Thread call, does not return until Yoics_end_service is called, run in
own thread.
  Return 0 - for now this is all may return status in future.
  For Normal poll the user may use the ‘Yoics_set_select’ to set user sockets to
return on.
  For Quick poll this call will return as soon as yoics packet processing is done.
  For Thread call, user should create a new thread with this call (experiment
27.  Init Select
      Initialize select system. Returns 0 on success.
        void Yoics_Init_Select(void);
28.  Set Socket
      Add a socket to Yoics_poll's accept wait, will return immediately if accept
triggers on this socket.
      S16 Yoics_Set_Select(SOCKET);
  Param SOCKET sock socket you wish to add to yoics_poll accept wait
  Returns 0 o success.
29.  Delete Socket
      Remove a socket to Yoics_poll's accept wait.
      S16 Yoics_Del_Select(SOCKET);
  Param SOCKET sock socket you wish to remove from yoics_poll accept wait
  Returns 0 on success.
30.  Check if socket Is selected
      Returns if the socket has been selected.
      S16Yoics_Is_Select(SOCKET sock);
  Param SOCKET sock socket you wish to check select on.
  Returns 1 if Socket is selected, 0 socket not selected.
31.  Maximum Number of Connections
      Returns the maximum supported connections
  U16 Yoics_Return_Max_Connections(void);
32.  Get NAT Type
      Returns the detected NAT type.
      U8 Yoics_Return_NAT_Type(void);
        Return 0= not calculated
          1= unkonwn
          2= inc port
          9= nice mapped
33.  Get Server SPI
      Return the current SPI
      U32 Yoics_Return_Server_SPI(void);
34.  Get Our IP
      Gets IP address bound by the system. Returns IP Address.
      IPADDR Yoics_Get_Our_Bound_IP(void);
35.  Get Our Port
      Gets our port bound by the system. Returns Port Number.
      U16 Yoics_Get_Our_Bound_Port(void);
36.  Get Our Mapped IP
      Gets IP address Mapped by the router. Returns mapped IP address.
      IPADDR Yoics_Get_Our_Mapped_IP(void);
37.  Get Our Mapped Port
      Gets our port mapped by the router. Returns Mapped Port.
      U16 Yoics_Get_Our_Mapped_Port(void);
/*-----------------------------------------------------------------*/
/*  Session Specific API calls  */
/*-----------------------------------------------------------------*/
38.  Session Initalization
      Initialize the session request callback to accept sessions into a program.
  S16 Yoics_Session_Init(S16(*callback)(U8,U8 *,U8*, U16));
  param *callback- pointer to callback that handles session connection events.
  Return 0 if callback was set.
      The specified is used to handle session connection events
  S16 session_callback(U8 type, U8 *peer_uid, U8* data, U16 session_index);
39.  Create Session
      Create a session with the target uid, must have previously called
Yoics_Session_Init to be successful.
      S16 Yoics_Session_create(U8 *uid);
  Param U8  *uid - UID of peer to initiate connection with
  Return 0 if initate packet was sent to server.
  This call is not reliable. Conformation of connection event will happen when
server sends connetion event with specified UID and information to previously initialized
callback in Yoics_Session_Init.
40.  Destroy Session
      Disconnect and destroy a session.
      S16 Yoics_Session_destroy(U16 session_index);
      param U16 session_index- session_index to destroy/close.
      Return -1 if no session found. Return 0 if destroy was successful
41.  Set TimeOut For A Session
      Sets a session timeout. Params are - session_index to get info on and
time_out value.
      S16 Yoics_Session_Set_Timeout(U16 session_index, U16 time_out);
      Return -1 if no session found.
      Return 0 if session info was returned.
42.  Get Session Information
      Returns a session information structure if session found. Takes
session_index to get info on as parameters.
  S16 Yoics_Session_Info(U16 session_index, SESSION_INF *session_info);
      Return -1 if no session found.
      Return 0 if session info was returned.
43. Session Shutdown
      Shuts down the session engine, cleans up any allocated memory.
      void  Yoics_Session_shutdown(void);
44.  Force Ping
      Force a ping packet out all sessions, useful to see if sessions are still up
after sleep recovery.
      int Yoics_Session_Force_Ping(void);
  Return 1 if pings were sent, 0 if no sessions are active
45.  Session Last Contact
      Gets the last contact in seconds of the particular session peer. Use after a
Yoics_Session_Force_Ping to determine if a peer is still alive. Can be used after coming
out of sleep mode.
      U32 Yoics_Session_Lastcontact(U16 session_index);
  Takes index of session to check as parameter.
  Return timestamp in seconds of last contact (from U32
Yoics_second_count(void))
46.  Return the second count tick timestamp
      Return second count that Yoics Library uses for internal timing.
      U32 Yoics_second_count(void);
47.  * Search for Active Session
      Search for a session index based on session ID in active session list.
      int session_find_index(U8 *sid);
  Param session id
  Return 0 if no session found or a session index
/*-----------------------------------------------------------------*/
/* Proxy APIs */
/*-----------------------------------------------------------------*/
48.  * Proxy Client Start
        This Function is to initialize the proxy core to be a proxy client; it will start a
listening TCP socket on the specified IP and Port. Typically the IP address will be
0.0.0.0 or INADDR-ANY. If an IP is specified do a hard bind with SO_REUSEADDR and
only on that IP. The restricted IP will only allow connections from this address, if set to
0.0.0.0 any address can connect, or if 127.0.0.1 only localhost; but can be set to any IP.
It can be called multiple times as long as each time it is called with a different, valid
session_index. The session_index is created during the p2p session create.
  S16 proxy_client_start(IPADDR ip, U16 port, IPADDR restrict_ip, U16
session_index);
  param[in] ip The IP address you wish to bind the proxy to.
  param[in] port  The port you wisht to bind the proxy to.
  param[in] restricted IP if desired or 0.0.0.0 for any.
  param[in] session_index is the p2p session you wish to attach this proxy to.
  return 0>= if the proxy has been setup and attached to the session
  return <0 if faild to initialize
49.  * Proxy Client Listener
    This function is to initialize the proxy core to be a device (bcaster). The
target IP and port is the target to send all requests to.
S16 proxy_init_listener(IPADDR target_ip, U16 target_port);
  param[in] target_ip the IP address you wish the bcaster to connect.
  param[in] target_port the port you wish the bcaster to connect.
  param[in] callback for proxy module events
  return 0 = OK
  return -1  = Failed to Malloc Memory
  return -3 = Already Initialized
  return <-1  = failed.
50.  Set Proxy Callback
      Initialize the Proxy connection request callback to connect to a
server(device).
  param *callback- pointer to callback that handles proxy connection events.
  S16 proxy_set_callback(S16 (*callback)(U16, S32, U8 *, U16));
51.  Proxy Poll
      This must be called between 1 and 10 times a second depending on the
latency needed for proxy operations. Parmas session index.
      S16proxy_poll(s16 sindex);
52.  Proxy Shutdown
      Shuts down the proxy operation and cleans up any resources used.
      void  proxy_shutdown(void);
53.  Proxy Client Shutdown
      Shuts down the proxy for a single session.
      S16 proxy_client_shutdown(U16 session_index);
54.  Proxy Status
      Forces callback printIn activity to display the proxy internal state.
      void  proxy_status(void);
55.  Free Active Proxies
      Forces the active proxies to be killed and cleaned up without affecting
future proxies. Could be used to kill stale connections in a reduced function
environment.
      void  proxy_free_active(void);
END Weaved and Yoics P2P API Reference_______________________
```

### System Architecture Overview

### Additional System Architecture Examples

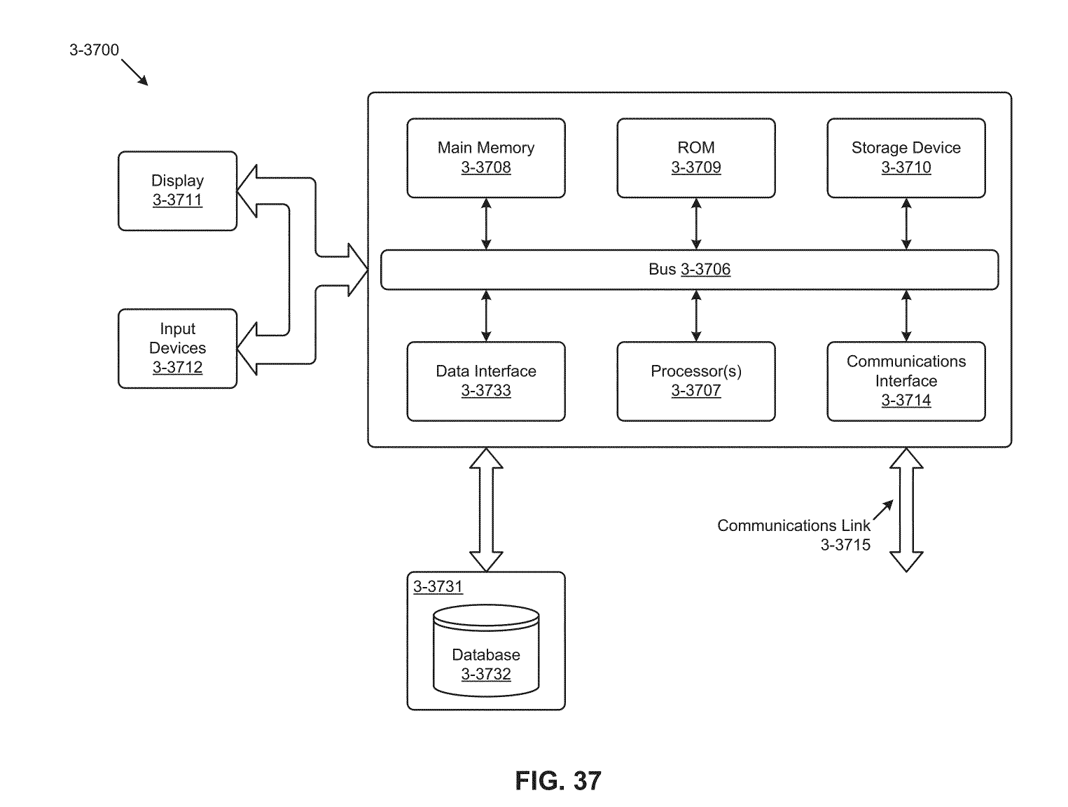

FIG. 37 depicts a block diagram of an instance of a computer system 3-3700 suitable for implementing certain embodiments of the present disclosure, in one embodiment. Computer system 3-3700 includes a bus 3-3706 or other communication mechanism for communicating information, which interconnects subsystems and devices such as a processor 3-3707, a system memory (e.g., main memory 3-3708, or an area of random access memory RAM), a static storage device (e.g., ROM 3-3709), a storage device 3-3710 (e.g., magnetic or optical), a data interface 3-3733, a communication interface 3-3714 (e.g., modem or Ethernet card), a display 3-3711 (e.g., CRT or LCD), input devices 3-3712 (e.g., keyboard, cursor control), and an external data repository 3-3731.

According to one embodiment of the disclosure, computer system 3-3700 performs specific operations by processor 3-3707 executing one or more sequences of one or more instructions contained in system memory. Such instructions may be read into system memory from another computer readable/usable medium such as a static storage device or a disk drive. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 3-3707 for execution. Such a medium may take many forms including, but not limited to, non-volatile media and volatile media. Non-volatile media includes, for example, optical or magnetic disks such as disk drives or tape drives. Volatile media includes dynamic memory such as a RAM memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 3-3700. According to certain embodiments of the disclosure, two or more instances of computer system 3-3700 coupled by a communications link 3-3715 (e.g., LAN, PTSN, or wireless network) may perform the sequence of instructions required to practice the disclosure in coordination with one another.

Computer system 3-3700 may transmit and receive messages, data, and instructions including programs (e.g., application code), through communications link 3-3715 and communication interface 3-3714. Received program code may be executed by processor 3-3707 as it is received and/or stored in storage device 3-3710 or any other non-volatile storage for later execution. Computer system 3-3700 may communicate through a data interface 3-3733 to a database 3-3732 on an external data repository 3-3731. Data items in database 3-3732 can be accessed using a primary key (e.g., a relational database primary key). A module as used herein can be implemented using any mix of any portions of the system memory and any extent of hard-wired circuitry including hard-wired circuitry embodied as a processor 3-3707. Some embodiments include one or more special-purpose hardware components (e.g., power control, logic, sensors, etc.).

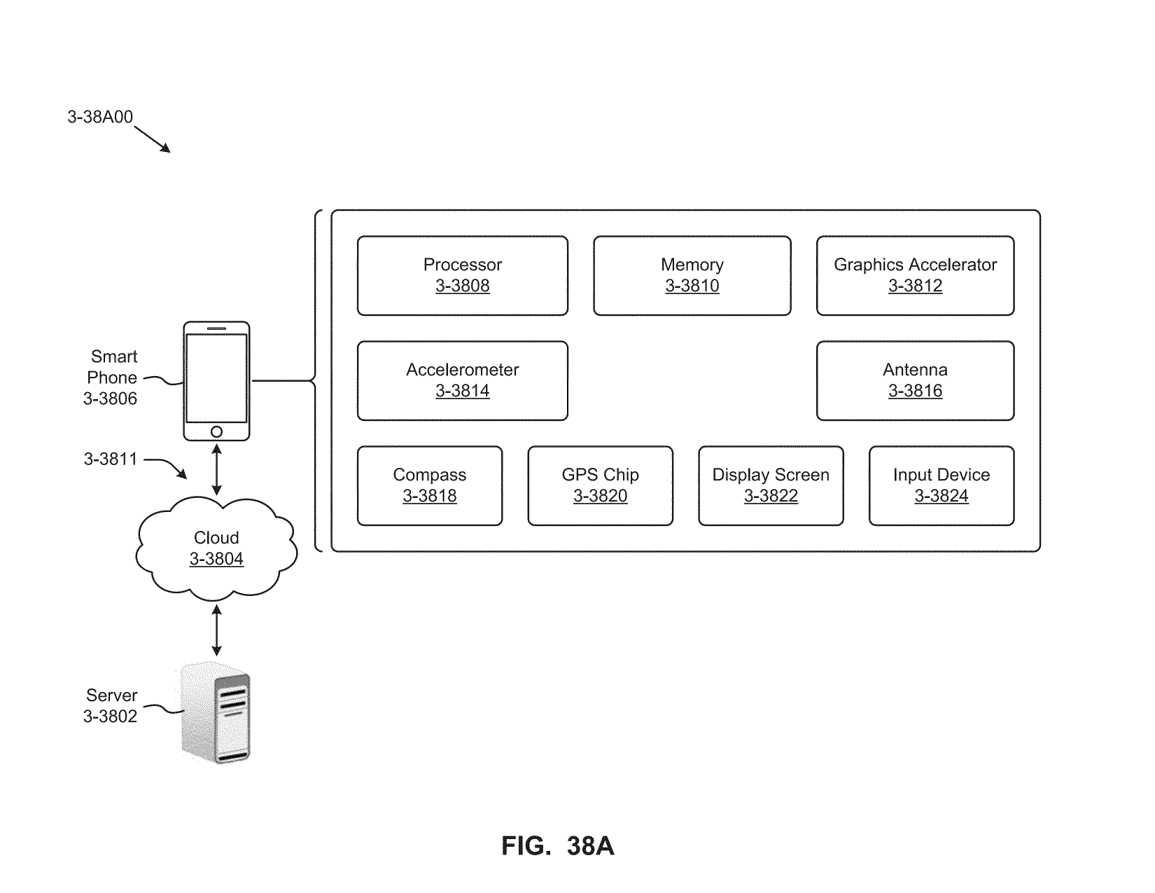

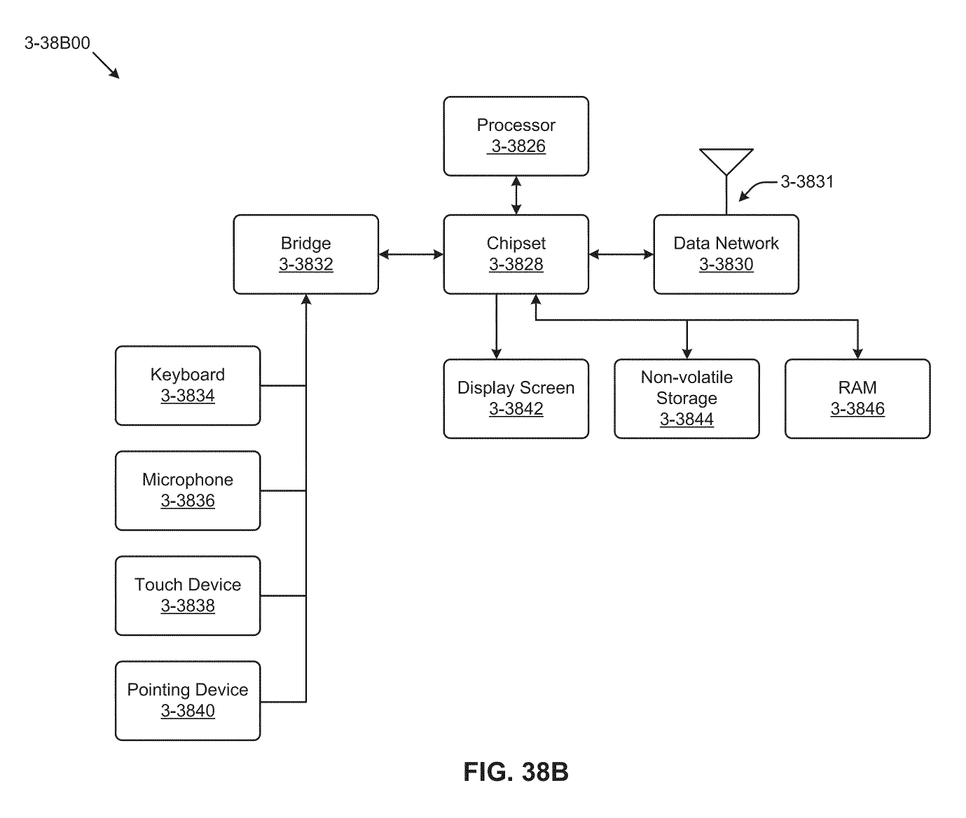

FIG. 38A is a diagram illustrating a mobile terminal (see smart phone architecture 3-38A00), in one embodiment. As shown, the smart phone 3-3806 includes a housing, display screen, and interface device, which may include a button, microphone, and/or touch screen. In certain embodiments, a smart phone has a high resolution camera device, which can be used in various modes. An example of a smart phone can be an iPhone from Apple Inc. of Cupertino, Calif. Alternatively, a smart phone can be a Galaxy from Samsung, or others.

In an example, the smart phone may include one or more of the following features (which are found in an iPhone 4 from Apple Inc., although there can be variations).
GSM model: UMTS/HSDPA/HSUPA (850, 900, 1900, 2100 MHz); GSM/EDGE (850, 900, 1800, 1900 MHz)
CDMA model: CDMA EV-DO Rev. A (800, 1900 MHz)
802.11b/g/n Wi-Fi (802.11n 2.4 GHz only)
Bluetooth 2.1+EDR wireless technology
Assisted GPS
Digital compass
Wi-Fi
Cellular
Retina display
3.5-inch (diagonal) widescreen multi-touch display
800:1 contrast ratio (typical)
500 cd/m2 max brightness (typical)
Fingerprint-resistant oleophobic coating on front and back
Support for display of multiple languages and characters simultaneously
5-megapixel iSight camera
Video recording, HD (720p) up to 30 frames per second with audio
VGA-quality photos and video at up to 30 frames per second with the front camera
Tap to focus video or still images
LED flash
Photo and video geotagging
Built-in rechargeable lithium-ion battery
Charging via USB to computer system or power adapter
Talk time: Up to 20 hours on 3G, up to 14 hours on 2G (GSM)
Standby time: Up to 300 hours
Internet use: Up to 6 hours on 3G, up to 10 hours on Wi-Fi
Video playback: Up to 10 hours
Audio playback: Up to 40 hours
Frequency response: 20 Hz to 22,000 Hz
Audio formats supported: AAC (8 to 320 Kbps), protected AAC (from iTunes Store), HE-AAC, MP3 (8 to 320 Kbps), MP3 VBR, audible (formats 2, 3, 4, audible enhanced audio, AAX, and AAX+), Apple lossless, AIFF, and WAV
User-configurable maximum volume limit
Video out support with Apple digital AV adapter or Apple VGA adapter; 576p and 480p with Apple component AV cable; 576i and 480i with Apple composite AV cable (cables sold separately)
Video formats supported: H.264 video up to 1080p, 30 frames per second, main profile Level 3.1 with AAC-LC audio up to 160 Kbps, 48 kHz, stereo audio in .m4v, .mp4, and .mov file formats; MPEG-4 video up to 2.5 Mbps, 640 by 480 pixels, 30 frames per second, simple profile with AAC-LC audio up to 160 Kbps per channel, 48 kHz, stereo audio in .m4v, .mp4, and .mov file formats; motion JPEG (M-JPEG) up to 35 Mbps, 1280 by 1020 pixels, 30 frames per second, audio in ulaw, PCM stereo audio in .avi file format
Three-axis gyro
Accelerometer
Proximity sensor
Ambient light sensor, etc.

Embodiments of the present disclosure may be used with other mobile terminals. Examples of suitable mobile terminals include a portable mobile terminal such as a media player, a cellular phone, a personal data organizer, or the like. In such embodiments, a portable mobile terminal may include a combination of the functionalities of such devices. In addition, a mobile terminal may allow a user to connect to and communicate through the Internet or through other networks such as local or wide area networks. For example, a portable mobile terminal may allow a user to access the internet and to communicate using email, text messaging, instant messaging, or using other forms of electronic communication. By way of example, the mobile terminal may be similar to an iPod having a display screen or an iPhone available from Apple, Inc.

In certain embodiments, a device may be powered by one or more rechargeable and/or replaceable batteries. Such embodiments may be highly portable, allowing a user to carry the mobile terminal while traveling, working, exercising, and so forth. In this manner, and depending on the functionalities provided by the mobile terminal, a user may listen to music, play games or video, record video or take pictures, place and receive telephone calls, communicate with others, control other devices (e.g., via remote control and/or Bluetooth functionality), and so forth while moving freely with the device. In addition, the device may be sized such that it fits relatively easily into a pocket or the hand of the user. While certain embodiments of the present disclosure are described with respect to portable mobile terminals, it should be noted that the presently disclosed techniques may be applicable to a wide array of other, less portable, mobile terminals and systems that are configured to render graphical data, such as a desktop computer.

The smart phone 3-3806 is configured to communicate with a server 3-3802 in electronic communication with any forms of handheld mobile terminals. Illustrative examples of such handheld mobile terminals can include functional components such as a processor 3-3808, memory 3-3810, graphics accelerator 3-3812, accelerometer 3-3814, communications interface 3-3811 (possibly including an antenna 3-3816), compass 3-3818, GPS chip 3-3820, display screen 3-3822, and an input device 3-3824. Each device is not limited to the illustrated components. The components may be hardware, software or a combination of both.

In some examples, instructions can be input to the handheld mobile terminal through an input device 3-3824 that instructs the processor 3-3808 to execute functions in an electronic imaging application. One potential instruction can be to generate an abstract of a captured image of a portion of a human user. In such a case the processor 3-3808 instructs the communications interface 3-3811 to communicate with the server 3-3802 (e.g., possibly through or using a cloud 3-3804) and transfer data (e.g., image data). The data is transferred by the communications interface 3-3811 and either processed by the processor 3-3808 immediately after image capture or stored in memory 3-3810 for later use, or both. The processor 3-3808 also receives information regarding the display screen's attributes, and can calculate the orientation of the device, e.g., using information from an accelerometer 3-3814 and/or other external data such as compass headings from a compass 3-3818, or GPS location from a GPS chip 3-3820, and the processor then uses the information to determine an orientation in which to display the image depending upon the example.

The captured image can be rendered by the processor 3-3808, by a graphics accelerator 3-3812, or by a combination of the two. In some embodiments, the processor can be the graphics accelerator 3-3812. The image can first be stored in memory 3-3810 or, if available, the memory can be directly associated with the graphics accelerator 3-3812. The methods described herein can be implemented by the processor 3-3808, the graphics accelerator 3-3812, or a combination of the two to create the image and related abstract. An image or abstract can be displayed on the display screen 3-3822.

FIG. 38B depicts an interconnection of components in a mobile terminal 3-38B00, in one embodiment. Examples of mobile terminals include an enclosure or housing, a display, user input structures, and input/output connectors in addition to the aforementioned interconnection of components. The enclosure may be formed from plastic, metal, composite materials, or other suitable materials, or any combination thereof. The enclosure may protect the interior components of the mobile terminal from physical damage, and may also shield the interior components from electromagnetic interference (EMI).

The display may be a liquid crystal display (LCD), a light emitting diode (LED) based display, an organic light emitting diode (OLED) based display, or some other suitable display. In accordance with certain embodiments of the present disclosure, the display may display a user interface and various other images such as logos, avatars, photos, album art, and the like. Additionally, in certain embodiments, a display may include a touch screen through which a user may interact with the user interface. The display may also include various functions and/or system indicators to provide feedback to a user such as power status, call status, memory status, or the like. These indicators may be incorporated into the user interface displayed on the display.

In certain embodiments, one or more of the user input structures can be configured to control the device such as by controlling a mode of operation, an output level, an output type, etc. For instance, the user input structures may include a button to turn the device on or off. Further, the user input structures may allow a user to interact with the user interface on the display. Embodiments of the portable mobile terminal may include any number of user input structures including buttons, switches, a control pad, a scroll wheel, or any other suitable input structures. The user input structures may work with the user interface displayed on the device to control functions of the device and/or any interfaces or devices connected to or used by the device. For example, the user input structures may allow a user to navigate a displayed user interface or to return such a displayed user interface to a default or home screen.

Certain devices may also include various input and output ports to allow connection of additional devices. For example, a port may be a headphone jack that provides for the connection of headphones. Additionally, a port may have both input and output capabilities to provide for the connection of a headset (e.g., a headphone and microphone combination). Embodiments of the present disclosure may include any number of input and/or output ports such as headphone and headset jacks, universal serial bus (USB) ports, IEEE-1394 ports, and AC and/or DC power connectors. Further, a device may use the input and output ports to connect to and send or receive data with any other device such as other portable mobile terminals, personal computers, printers, or the like. For example, in one embodiment, the device may connect to a personal computer via an IEEE-1394 connection to send and receive data files such as media files.

The depiction of mobile terminal 3-38B00 encompasses a smart phone system diagram according to an embodiment of the present disclosure. The depiction of mobile terminal 3-38B00 illustrates computer hardware, software, and firmware that can be used to implement the disclosures above. The shown system includes a processor 3-3826, which is representative of any number of physically and/or logically distinct resources capable of executing software, firmware, and hardware configured to perform identified computations. A processor communicates with a chipset 3-3828 that can control input to and output from processor. In this example, chipset 3-3828 outputs information to display screen 3-3842 and can read and write information to non-volatile storage 3-3844, which can include magnetic media and solid state media, and/or other non-transitory media, for example. Chipset 3-3828 can also read data from and write data to RAM 3-3846. A bridge 3-3832 for interfacing with a variety of user interface components can be provided for interfacing with chipset 3-3828. Such user interface components can include a keyboard 3-3834, a microphone 3-3836, touch-detection-and-processing circuitry 3-3838, a pointing device 3-3840 such as a mouse, and so on. In general, inputs to the system can come from any of a variety of machine-generated and/or human-generated sources.

Chipset 3-3828 also can interface with one or more data network interfaces 3-3830 that can have different physical interfaces. Such data network interfaces 3-3830 can include interfaces for wired and wireless local area networks, for broadband wireless networks, as well as personal area networks. Some applications of the methods for generating, displaying and using the GUI disclosed herein can include receiving data over a physical interface 3-3831 or be generated by the machine itself by a processor analyzing data stored in non-volatile storage 3-3844 and/or in memory or RAM 3-3846. Further, the machine can receive inputs from a user via devices such as a keyboard 3-3834, microphone 3-3836, touch-detection-and-processing circuitry 3-3838, and pointing device 3-3840 and execute appropriate functions such as browsing functions by interpreting these inputs using processor 3-3826.

Client devices may include at least one client application that is configured to receive and/or send data between another computing device. The client application may include a capability to provide send and/or receive content or the like. The client application may further provide information that identifies itself including a type, capability, name or the like. In one embodiment, a client device may uniquely identify itself through any of a variety of mechanisms including a phone number, mobile identification number (MIN), an electronic serial number (ESN), or other mobile device identifier. The information may also indicate a content format that the mobile device is enabled to employ. Such information may be provided in a network packet or the like, sent between other client devices, or sent between other computing devices.

Client devices may be further configured to include a client application that enables an end-user to log into an end-user account that may be managed by another computing device. Such end-user accounts, in one non-limiting example, may be configured to enable the end-user to manage one or more online activities including, for example, search activities, social networking activities, browse various web sites, communicate with other users, participate in gaming, interact with various applications, or the like. However, participation in online activities may also be performed without logging into the end-user account.

A wireless communication capability is configured to couple client devices and other components with network. Wireless network may include any of a variety of wireless sub-networks that may further overlay stand-alone and/or ad-hoc networks and the like to provide an infrastructure-oriented connection for client devices. Such sub-networks may include mesh networks, wireless LAN (WLAN) networks, cellular networks, and the like. In one embodiment, the system may include more than one wireless network.

A wireless network may further include an autonomous system of terminals, gateways, routers and the like, connected by wireless radio links and the like. These connectors may be configured to move freely and randomly and organize themselves arbitrarily such that the topology of a wireless network may change rapidly. A wireless network may further employ a plurality of access technologies including AMPS and/or second generation (2G) and/or third generation (3G) and/or fourth generation (4G) generation radio access for cellular systems, WLAN, wireless router (WR) mesh, and the like. The foregoing access technologies as well as emerging and/or future access technologies may enable wide area coverage for mobile devices such as client devices with various degrees of mobility. In one non-limiting example, wireless network may enable a radio connection through a radio network access such as a global system for mobile (GSM) communication, general packet radio services (GPRS), enhanced data GSM environment (EDGE), wideband code division multiple access (WCDMA), and the like. A wireless network may include any wireless communication mechanism by which information may travel between client devices and/or between another computing device or network.

Any of the foregoing networks can be configured to couple network devices with other computing devices and communication can include communicating between the Internet. In some situations communication is carried out using combinations of LANs, WANs, as well as direct connections such as through a universal serial bus (USB) port or other forms of computer readable media. On an interconnected set of LANs, including those based on differing architectures and protocols, a router acts as a link between LANs, enabling messages to be sent from one to another. In addition, communication links within LANs may include twisted wire pair or coaxial cable, while communication links between networks may use analog telephone lines, full or fractional dedicated digital lines including T1, T2, T3, and T4, and/or other carrier mechanisms including, for example, E-carriers, integrated services digital networks (ISDNs), digital subscriber lines (DSLs), wireless links including satellite links, or other communications links known to those skilled in the art. Moreover, communication links may further employ any of a variety of digital signaling technologies including, without limit, for example, DS-0, DS-1, DS-2, DS-3, DS-4, OC-3, OC-12, OC-48 or the like. Furthermore, remote computers and other related electronic devices could be remotely connected to either LANs or WANs via a modem and temporary telephone link. In one embodiment, a network may be configured to transport information of an Internet protocol (IP). In some cases, communication media carries computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

It should be noted that, one or more aspects of the various embodiments of the present disclosure may be included in an article of manufacture (e.g., one or more computer program products) having, for instance, computer usable media. The media has embodied therein, for instance, computer readable program code for providing and facilitating the capabilities of the various embodiments of the present disclosure. The article of manufacture can be included as a part of a computer system or sold separately.

Additionally, one or more aspects of the various embodiments of the present disclosure may be designed using computer readable program code for providing and/or facilitating the capabilities of the various embodiments or configurations of embodiments of the present disclosure.

Additionally, one or more aspects of the various embodiments of the present disclosure may use computer readable program code for providing and facilitating the capabilities of the various embodiments or configurations of embodiments of the present disclosure and that may be included as a part of a computer system and/or memory system and/or sold separately.

Additionally, at least one program storage device readable by a machine, tangibly embodying at least one program of instructions executable by the machine to perform the capabilities of the various embodiments of the present disclosure can be provided.

The diagrams depicted herein are just examples. There may be many variations to these diagrams or the steps (or operations) described therein without departing from the spirit of the various embodiments of the disclosure. For instance, the steps may be performed in a differing order, or steps may be added, deleted or modified.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein.

References in this specification and/or references in specifications incorporated by reference to “one embodiment” may mean that particular aspects, architectures, functions, features, structures, characteristics, etc. of an embodiment that may be described in connection with the embodiment may be included in at least one implementation. Thus references to “in one embodiment” may not necessarily refer to the same embodiment. The particular aspects, etc. may be included in forms other than the particular embodiment described and/or illustrated and all such forms may be encompassed within the scope and claims of the present application.

References in this specification and/or references in specifications incorporated by reference to “for example” may mean that particular aspects, architectures, functions, features, structures, characteristics, etc. described in connection with the embodiment or example may be included in at least one implementation. Thus references to an “example” may not necessarily refer to the same embodiment, example, etc. The particular aspects, etc. may be included in forms other than the particular embodiment or example described and/or illustrated and all such forms may be encompassed within the scope and claims of the present application.

This specification and/or specifications incorporated by reference may refer to a list of alternatives. For example, a first reference such as “A (e.g., B, C, D, E, etc.)” may refer to a list of alternatives to A including (but not limited to) B, C, D, E. A second reference to “A, etc.” may then be equivalent to the first reference to “A (e.g., B, C, D, E, etc.).” Thus, a reference to “A, etc.” may be interpreted to mean “A (e.g., B, C, D, E, etc.).”

It may thus be seen from the examples provided above that the improvements to devices (e.g., as shown in the contexts of the figures included in this specification, for example) may be used in various applications, contexts, environments, etc. The applications, uses, etc. of these improvements, etc. may not be limited to those described above, but may be used, for example, in combination. For example, one or more applications, etc. used in the contexts, for example, in one or more figures may be used in combination with one or more applications, etc. used in the contexts of, for example, one or more other figures and/or one or more applications, etc. described in any specifications incorporated by reference. Further, while various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
presenting a user interface on a display terminal, wherein the user interface includes one or more first fields for user entry of a first device type, and wherein the user interface includes one or more second fields for user entry of a second device type;
recognizing the first device type to associate one or more aspects of the first device type;
configuring a domain name service server using at least one aspect of the first device type;
recognizing the second device type to associate one or more aspects of the second device type; and
configuring the domain name service server using at least one aspect of the second device type, wherein the domain name service server is operable to initiate network communication between a first device instance of a device of the first device type and a second device instance of a device of the second device type.

2. The method of claim 1, further comprising indicating a location of a software development kit on the display terminal, wherein the software development kit allows customization of the network communication between two or more devices.

3. The method of claim 1, further comprising indicating a location of an install script on the display terminal wherein the install script is to be executed on at least one of the first device and the second device.

4. The method of claim 1, further comprising receiving at least a status indication from at least one of the first device and the second device.

5. The method of claim 1, further comprising initiating network communication with at least one of, a first device instance of the first device type and a second device instance of the second device type.

6. The method of claim 1, further comprising configuring at least one of, a communication link, a connections, a direct mode, and a peer-to-peer (P2P) mode.

7. The method of claim 1, further comprising initiating peer-to-peer communication between the first device instance of the device of the first device type and the second device instance of the device of the second device type.

8. The method of claim 1, further comprising initiating communication with the first device instance of the device to configure GPIO functions.

9. The method of claim 1, further comprising invoking at least one server-specific API call.

10. The method of claim 1, further comprising invoking at least one session-specific API call.

11. The method of claim 1, further comprising invoking at least one service API call.

12. A computer program product, embodied in a non-transitory computer readable medium, the computer readable medium having stored thereon a sequence of instructions which, when executed by a processor causes the processor to execute a process, the process comprising:
presenting a user interface on a display terminal, wherein the user interface includes one or more first fields for user entry of a first device type, and wherein the user interface includes one or more second fields for user entry of a second device type;
recognizing the first device type to associate one or more aspects of the first device type;
configuring a domain name service server using at least one aspect of the first device type;
recognizing the second device type to associate one or more aspects of the second device type; and
configuring the domain name service server using at least one aspect of the second device type, wherein the domain name service server is operable to initiate network communication between a first device instance of a device of the first device type and a second device instance of a device of the second device type.

13. The computer program product of claim 12, further comprising instructions for indicating a location of a software development kit on the display terminal, wherein the software development kit allows customization of the network communication between two or more devices.

14. The computer program product of claim 12, further comprising instructions for indicating a location of an install script on the display terminal wherein the install script is to be executed on at least one of the first device and the second device.

15. The computer program product of claim 12, further comprising instructions for receiving at least a status indication from at least one of the first device and the second device.

16. The computer program product of claim 12, further comprising instructions for initiating network communication with at least one of, a first device instance of the first device type and a second device instance of the second device type.

17. The computer program product of claim 12, further comprising instructions for configuring at least one of, a communication link, a connections, a direct mode, and a peer-to-peer (P2P) mode.

18. The computer program product of claim 12, further comprising instructions for initiating peer-to-peer communication between the first device instance of the device of the first device type and the second device instance of the device of the second device type.

19. The computer program product of claim 12, further comprising instructions for initiating communication with the first device instance of the device to configure GPIO functions.

20. The computer program product of claim 12, further comprising instructions for invoking at least one service API call.
